(19) United States
(12) Patent Application Publication
(10) Pub. No.: US 2002/0133446 A1
(43) Pub. Date: Sep. 19, 2002

(54) Stock exchange supporting system, method for supporting stock exchange, and storage medium storing stock exchange supporting program for implementing the same method

(76) Inventor: Soo Sung Lee, Seoul (KR)

Correspondence Address: GREENBLUM & BERNSTEIN, P.L.C., 1941 ROLAND CLARKE PLACE, RESTON, VA, 20191, US

(21) Appl. No.: 10/015,164

(22) Filed: Dec. 14, 2001

(30) Foreign Application Priority Data
Jan. 19, 2001 (KR) 2001-3287

(51) Int. Cl. G06F 17/60

(52) U.S. Cl. 705/36

(57) ABSTRACT

The present invention provides a stock exchange supporting system, method for supporting stock exchange and a storage medium storing the stock exchange supporting program for carrying out the same method. In accordance with the present invention, in case a stock transaction reservation information is registered just once on a stock market opening day using the stock exchange supporting system of the present invention, the reservation is continuously valid till all the stocks registered in the stock transaction reservation information are transacted or the stock transaction reservation is canceled. Further, by using the stock exchange supporting system in accordance with the present invention, it is possible to alternately execute buy transactions and sell transactions of stock exchange up to nₜₕ times by registering the stock transaction reservation information once.

In accordance with a first aspect of the present invention, there is provided a stock exchange supporting system comprising: a client terminal having a web browser; and a data processing unit which is connected to the client terminal and a mainframe computer of stockmarket which executes transaction of stock exchange, wherein the data processing unit includes: (a) an investment information register and management module which receives client identification information and stock transaction reservation information including at least an item to be transacted from the client terminal, registers the information separating it into individuals or groups, and provides execution results of a client's command to a client by receiving commands such as modification or retrieve of the registered stock transaction reservation information or execution of stock transaction from the client terminal, receiving stock exchange information from the mainframe computer of stock market and then executing the client's commands and (b) transaction execution module which monitors present stock prices of items registered by the investment information register and management module as a stock transaction reservation information on and after a day when the stock transaction reservation information is registered, and makes and sends a transaction execution order to the mainframe computer of the stock market.

### FIELD OF THE INVENTION

The present invention relates to stock exchange supporting system for supporting a real time transaction of stock exchange and providing real time stock price information to clients who wish to execute transaction of stock exchange through a client terminal or a paging system. The present invention further relates to a method for supporting stock exchange and a storage medium storing a computer program for implementing the same method.

The stock exchange supporting system first implements a register operation by receiving stock transaction reservation information that includes client's identification (ID), items to be transacted, investment parameters such as stock price (buy or sell bidding price), yield (profit/loss rate) from at least one client. In response to the registered stock transaction reservation information, the stock exchange supporting system continuously or regularly monitors present stock prices of the items which is registered to be transacted by the clients, directly executes transaction of stock exchange of the items when present stock prices of the items meet the registered investment parameters or investment condition, and provides the clients with results of transaction execution through client paging supporting systems at a predetermined paging time. However, instead of directly executing transaction of the stock exchange when present stock prices of the shares meet the registered investment parameters, the system can provide the clients with the real time stock price information, so that the clients can make a transaction execution order of stock exchange by themselves.

### DESCRIPTION OF THE PRIOR ART

Generally, a conventional method of stock exchange as follows: First, a client or an investor checks stock price information such as buy bidding price and sell bidding price for a item to be transacted through a terminal connected to internet, broadcasting media, electronic display board of the securities firms or a personal digital assistant (PDA) machine, and then makes a buy or a sell order for the item at market price. The client or investor also can make a buy or a sell order in advance at predetermined stock price between the daily permissible high price and the daily permissible low price.

Therefore the conventional stock exchange system requires that client has to confirm by himself whether the stock transaction order made on that day is carried out.

Further, in case the stock transaction order made on that day remains unexecuted, the client has to make a new transaction order on or after next stockmarket opening day because the unexecuted order made on that day will be invalid after the stock market is closed on that day.

Further, when a client wishes to buy stocks at the lowest price or sell stocks at the highest price on that day, the client must continuously monitors stock prices through a terminal connected to a mainframe computer of stock market or an electronic display board of a securities firm all day long. Thus, the conventional stock exchange system is not suitable to ordinary being who has own job other than stock exchange.

### SUMMARY OF THE INVENTION

It is, therefore, an object of the present invention is to provide a stock exchange supporting system, method for supporting stock exchange and a storage medium storing the stock exchange supporting program for carrying out the same method. In accordance with the present invention, in case a stock transaction reservation information is registered just once on a stock market opening day using the stock exchange supporting system of the present invention, the reservation is continuously valid till all the stocks registered in the stock transaction reservation information are transacted or the stock transaction reservation is canceled. Further, by using the stock exchange supporting system in accordance with the present invention, it is possible to alternately execute buy transactions and sell transactions of stock exchange up to nₜₕ times by registering the stock transaction reservation information once.

In accordance with a first aspect of the present invention, there is provided a stock exchange supporting system comprising: a client terminal having a web browser; and a data processing unit which is connected to the client terminal and a mainframe computer of stock market which executes transaction of stock exchange, wherein the data processing unit includes: (a) an investment information register and management module which receives client identification information and stock transaction reservation information including at least an item to be transacted from the client terminal, registers the information separating it into individuals or groups, and provides execution results of a client's command to a client by receiving commands such as modification or retrieve of the registered stock transaction reservation information or execution of stock transaction from the client terminal, receiving stock exchange information from the mainframe computer of stock market and then executing the client's commands and (b) transaction execution module which monitors present stock prices of items registered by the investment information register and management module as a stock transaction reservation information on and after a day when the stock transaction reservation information is registered, and makes and sends a transaction execution order to the mainframe computer of the stock market.

In accordance with the first aspect of the present invention, the data processing unit is a server of a securities firm or an investment consultancy firm, the server supporting stock exchange and providing stock transaction information.

In accordance with the first aspect of the present invention, the data processing unit is a client terminal which is connected to a server of a securities firm through the communication network, the server supporting stock transaction and operation of the client terminal.

In accordance with the first aspect of the present invention, the stock transaction reservation information includes: client paging information such as client terminal address, pager number, and paging time; and stock transaction information such as at least one item to be transacted as discretionary investment or informed as investment consultancy information, reserved bidding price (buy or sell bidding price range), transaction type (individual or basket), count of transaction times for each item, and at least one condition for basket transaction.

In accordance with the first aspect of the present invention, the transaction execution module comprises an individual item buy supporting module which compares present stock prices of items registered by the investment information register and management module as the stock transaction reservation information with the buy bidding price range of the items (from minimum buy bidding price to maximum buy bidding price), in which the registered buy bidding price range is the price range registered as the stock transaction reservation information, sends a buy transaction order to the mainframe computer of stock market with the registered buy bidding price range and registered buy volumes when the present stock price is in the range of the registered buy bidding price or lower than the range of the registered buy bidding price, and transfers execution results of the buy transaction to the investment information register and management module; an individual item sell supporting module which compares present stock prices of items registered by the investment information register and management module as the stock transaction reservation information with registered sell bidding price ranges of the items (from maximum sell bidding price to minimum sell bidding price), in which the registered sell bidding price range is price range registered as the stock transaction reservation information, sends a sell transaction order to the mainframe computer of stock market with the registered sell bidding price ranges and registered sell volumes when the present stock price is in the range of the registered sell bidding price or higher than the range of the registered sell bidding price, and execution results of sell transaction order to the investment information register and management module.

In accordance with the first aspect of the present invention, the transaction execution module comprises: a basket items buy supporting module which checks present stock prices of items registered by the investment information register and management module as the stock transaction reservation information, generates at least one condition to execute basket items buy transaction, sends a basket items buy transaction order to the mainframe computer of stock market with market price and registered buy volumes when the generated condition is matched with a predetermined condition registered by the investment information register and management module, and transfers execution results of basket items buy transaction order to the investment information register and management module; a basket items sell supporting module which checks present stock prices of items registered by the investment information register and management module as the stock transaction reservation information, generates at least one condition to execute basket items sell transaction, sends a basket items sell transaction order to the mainframe computer of stock market with market price of each item and registered sell volumes when the generated condition is matched with a predetermined condition registered by the investment information register and management module, and transfers execution results of basket items sell transaction order to the investment information register and management module.

In accordance with the first aspect of the present invention, the transaction execution module further checks the execution results of the buy transaction order, then makes and sends a sell transaction order for the items that have been bought in accordance with the buy transaction order to the mainframe computer of the stock market with sell bidding price and volumes as registered by the investment information register and management module, and then makes and sends a new buy transaction order with buy bidding price and volumes as registered after the sell transaction order is executed and confirmed, thereby the buy transaction orders and the sell transaction orders are alternately repeated up to n times.

In accordance with the first aspect of the present invention, the transaction execution module further checks the execution results of the buy transaction order, then makes and sends a sell transaction order for the items that have been bought in accordance with the buy transaction order to the mainframe computer of the stock market with sell bidding price and volumes as registered by the investment information register and management module, and then makes and sends a new buy transaction order with buy bidding price and volumes as registered after the sell transaction order is executed and confirmed, thereby the buy transaction orders and the sell transaction orders are alternately repeated up to n times.

In accordance with the first aspect of the present invention, the data processing unit further comprises a client paging supporting module which retrieves client paging information and transmits client paging signal to the client terminal that is registered to be informed at the predetermined paging time in case that present stock price of an item registered by the investment information and management module is matched with the reserved bidding price (buy bidding price range or sell bidding price range).

In accordance with the first aspect of the present invention, the client paging supporting module comprises: a priority determination module for determining priority of paging information by distinguishing between real time paging information and reservation paging information; and an information sending/recording and terminal management module for selecting appropriate communication protocol and establishing connection to the communication network such that the client paging information decided to be sent to the client by the priority determination module is classified into appropriate data formats so as to be automatically displayed on web pages provided by corresponding mobile communication service providers, and storing transmission-reserved information in a memory.

In accordance with the first aspect of the present invention, the client paging supporting module further comprises at least one client paging terminal connected to the information sending/recording and terminal management module through a local area network (LAN), and having a communication interface for connecting the client paging supporting module to the LAN and a telecommunication interface means (i.e. modem card) for connecting the client paging supporting module to a telecommunication network; and an internet connection program; and an automatic web page writing program, thereby once power is on, the internet connection program is loaded and an IP (internet protocol) address of a mobile communication service provider is automatically sent to a domain server, so that the client paging terminal reaches a web page provided by the mobile communication service provider and automatically writing the client paging information into the web page.

In accordance with the first aspect of the present invention, the client paging supporting module sends stock price information received from the mainframe computer of stock market to a client terminal with the client paging information.

In accordance with the first aspect of the present invention, the client paging supporting module classifies the client paging information into at least one group of information and sends the client paging information belonged to each group at regular intervals.

In accordance with the first aspect of the present invention, the investment information register and management module comprises a discretionary investment reservation information management module providing at least one web page which includes input boxes for receiving client identification information, password, client's registered number, code or title of item to be transacted, and volumes and value amount of the item to be transacted; and supporting registration reservation and reserved transaction in accordance with investment information from the user terminal through the web page; and updating the stock transaction reservation information in response to the execution results of stock transaction.

In accordance with a second aspect of the present invention, there is provided a method of supporting stock exchange using a data processing apparatus which is connected to a client terminal to receive client's ID information and stock transaction reservation information and a mainframe computer of stock market to receive real time stock transaction information through communication network respectively, comprising the steps of: (a) checking a market condition by comparing the stock transaction reservation information registered in advance with the real time stock transaction information received from the mainframe computer of stock market and determining whether the market condition is adequate to execute stock transaction of an individual item or basket items in accordance with investment type and condition predetermined by the registered stock transaction reservation information; (b) post-treating to send a transaction execution order to the mainframe computer of stock market to execute the stock transaction or to provide at least one client with present stock price information in response to the results of confirmation whether the client is registered discretionary investment or investment consultancy; and (d) after the stock market being closed on that day when the stock transaction reservation is made, checking whether stock transaction is completely executed in accordance with the registered stock transaction reservation information, if not, re-registering remained part of the stock transaction reservation information which is remained being not transacted as new stock transaction reservation information on a next stock market opening day, whereby steps (b) and (d) are repeatedly performed till all stocks registered to be transacted in accordance with the stock transaction reservation information are completely transacted.

In accordance with the second aspect of the present invention, the method of supporting stock exchange further comprises a step of (c) registering investment information, wherein the step (c) includes steps of receiving from the client terminal the stock transaction reservation information including investment type and condition, and registering the reservation information by separating it into individuals or groups, wherein the stock transaction reservation information includes client's ID information and paging information (terminal addressor pager number, paging time), at least one item to be transacted or consulted, reserved bidding price (buy bidding price range and sell bidding price range), transaction type (individual or basket), count of transactions by each item, and condition for individual item transaction or basket items transaction.

In accordance with a third aspect of the present invention, there is provided a storage medium storing a program for implementing a method of supporting stock exchange using a data processing apparatus which is connected to a client terminal to receive client's ID information and stock transaction reservation information and a mainframe computer of stock market to receive real time stock transaction information through communication network respectively, the method comprising the steps of: (a) checking a market condition by comparing the stock transaction reservation information registered in advance with the real time stock transaction information received from the mainframe computer of stock market and determining whether the market condition is adequate to execute stock transaction of an individual item or basket items in accordance with investment type and condition predetermined by the registered stock transaction reservation information; (b) post-treating to send a transaction execution order to the mainframe computer of stock market to execute the stock transaction or to provide at least one client with present stock price information in response to the results of confirmation whether the client is registered discretionary investment or investment consultancy; and (d) after the stock market being closed on that day when the stock transaction reservation is made, checking whether stock transaction is completely executed in accordance with the registered stock transaction reservation information, if not, re-registering remained part of the stock transaction reservation information which is remained being not transacted as new stock transaction reservation information on a next stock market opening day, whereby steps (b) and (d) are repeatedly performed till all stocks registered to be transacted in accordance with the stock transaction reservation information are completely transacted.

In accordance with the third aspect of the present invention, the method of supporting stock exchange further comprises a step of (c) registering investment information, wherein the step (c) includes steps of receiving from the client terminal the stock transaction reservation information including investment type and condition, and registering the reservation information by separating it into individuals or groups, wherein the stock transaction reservation information includes client's ID information and paging information (terminal address or pager number, paging time), at least one item to be transacted or consulted, reserved bidding price (buy bidding price range and sell bidding price range), transaction type (individual or basket), count of transactions by each item, and condition for individual item transaction or basket items transaction.

### BRIEF DESCRIPTION OF THE DRAWINGS

The above and other objects and features of the present invention will become apparent from the following description of preferred embodiments taken in conjunction with the accompanying drawings, in which:

FIG. 1 is an exemplary block diagram showing configurations of a stock exchange supporting system according to the present invention;

FIG. 2 is an exemplary block diagram showing detailed modules included in an investment information register and management module shown in FIG. 1;

FIGS. 3a through 3d are flowcharts showing a method of supporting stock exchange in accordance with the present invention;

FIG. 4 is an exemplary display configuration for registering discretionary investment reservation information;

FIG. 5 is an exemplary display configuration for registering the discretionary investment reservation information when a button of “register individual investment” is selected in FIG. 4;

FIG. 6 is an exemplary display configuration for registering the discretionary investment reservation information when a button of “register group investment” is selected in FIG. 4;

FIG. 7 is an exemplary display configuration for retrieving discretionary investment reservation information when a button of “retrieve individual investment” is selected in FIG. 4;

FIG. 8 is an exemplary display configuration for retrieving discretionary investment reservation information when a button of “retrieve group investment” is selected in FIG. 4;

FIG. 9 is an exemplary display configuration for displaying list of clients who belong to a group when a button of “display list of clients by a group” is selected in FIG. 4;

FIG. 10 is an exemplary display configuration for registering investment fund in accordance with the investment fund register and management module when an item button “register investment fund” is selected in FIG. 4.

FIG. 11 is an exemplary stock price graph for explaining buy and sell points of an item that has been recorded price at low and suggested by the recommended items management module;

FIGS. 12a and 12b are daily stock price charts illustrated by applying the buy and sell points depicted in graph of FIG. 11;

FIG. 13 is an exemplary display configuration for registering basket items buy transaction of appointed items suggested by the investment information register and management module of FIG. 2;

FIG. 14a is an exemplary block diagram of a client paging supporting module;

FIGS. 14b and 14c are flow charts of an automatic web page writing program that is included in the client paging supporting module;

FIG. 14d is an exemplary display configuration for registering client paging information that is provided by the client paging supporting module;

FIG. 15 is an exemplary display configuration for displaying past buy transaction data of appointed items registered in accordance with the investment information record and management module of FIG. 2;

FIG. 16 is an exemplary display configuration for confirming execution results of past buy transaction data, wherein the display configuration is provided by the investment information register and management module of FIG. 2;

FIG. 17 is an exemplary display configuration for confirming execution results of past sell transaction data, wherein the display configuration is provided by the investment information register and management module of FIG. 2; and

FIG. 18 is an exemplary display configuration for displaying past sell transaction data, wherein the display configuration is provided by the investment information register and management module of FIG. 2.

### DETAILED DESCRIPTION OF THE INVENTION

A present invention may be better understood by a description of one embodiment with reference to the attached drawings.

The present invention provides a stock exchange supporting program that is capable of directly making a stock transaction execution order when predetermined conditions are matched with the real time stock trading conditions or provides the clients with stock price information to support the stock trading.

The stock exchange supporting program is adequately operated by being loaded on a server of a securities firm or a server of an investment consultancy firm that provides useful investment information on stock transaction to clients or investors. The server of the securities firm makes and sends a stock transaction order to a mainframe computer of the stock market, so that the mainframe computer executes transaction of stock exchange.

Further, the stock exchange supporting program can be operated by being loaded on a client server or a client terminal based on a personal computer having a web browser which is able to edit or display web documents and is connected to the sever of the securities firm or the investment consultancy firm. The program loaded on the client server or the client terminal can be operated by being supported by the server of the securities firm through the communication networking system.

The server of the securities firm or investment consultancy firm, and client server or terminal in which the stock exchange supporting program is loaded is referred as a stock exchange supporting system hereinafter.

A preferred computer network system to effect the stock exchange supporting system in accordance with the present invention comprises as follows: A plurality of client terminals or servers having web browsers are connected to wired or radio communication network system, and the communication network system is connected to the stock exchange supporting system in which the stock exchange supporting program in accordance with the present invention is loaded and operated, and the stock exchange supporting system is connected to the mainframe computer of the stock market and a client paging system through the communication network system.

Further the present invention includes a storage medium which stores program source consisted of a plurality of command sets to execute the method of supporting stock exchange in accordance with the preferred embodiment of the present invention. The command sets of the program not only can be resident in one or more memories such as RAM (random access memory) in a computer system but also can be just stored in the storage medium such as a disk drive until command sets are needed.

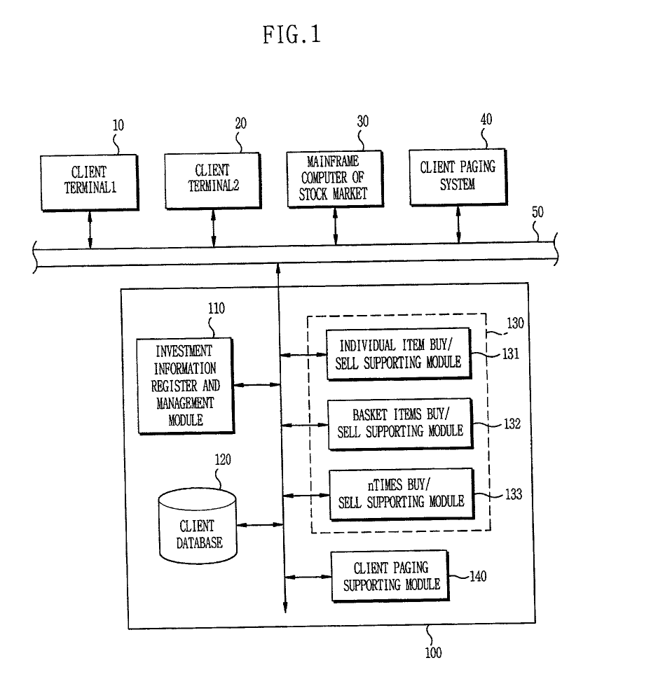

FIG. 1 is a diagram showing configuration of the preferred computer network system in which the stock exchange supporting system in accordance with the preferred embodiment of the present invention can be adequately operated.

The computer network system comprises a plurality of client terminals 10, 20, mainframe computer of stock market 30, client paging system 40 and communication network 50 which connects all of the client terminals 10, 20, the mainframe computer of the stock market 20 and the client paging system 40 to be communicated with each other. Further, stock exchange supporting server (or data processing unit) 100 is connected to the communication network 50. The stock exchange supporting system in accordance with the present invention comprises the stock exchange supporting server 100 (data processing unit) and the plurality of client terminals 10, 20.

With reference to FIG. 1, the stock exchange supporting server 100 includes investment information register and management module 110, a client database 120, a transaction execution module 130, and a client paging module 140. Each of the modules 110, 130, 140 can be realized by software as well as hardware.

The investment information register and management module 110 provides at least one web page for registering and retrieving stock transaction reservation information to a plurality of client terminals 10, 20. The module 110 receives, registers and records various stock transaction reservation information inputted from the client terminals. The client may enter the stock transaction reservation a information by key-in using the module 110. The stock transaction reservation information includes client identification (ID) information and client paging information such as terminal ID on the client's communication network, e-mail address or radio pager number, and predetermined paging time. The stock transaction reservation information further includes investment information such as codes of items to be transacted or informed, stock price (buy bidding price or sell bidding price), the type of transaction (basket or individual), count of transaction times. The module 110 can register and record the stock transaction reservation information on the client database 120 by separating it into individuals or groups.

Further, in response to a command inputted from the web page of the client terminals 10, 20, the module 110 forms at least one control signal to manage registered stock transaction reservation information or to control a transaction execution order.

The client data base 120 stores the client ID information such as client's registered number and password et al. and client paging information such as terminal ID or e-mail address, pager number, and predetermined paging time. The client database 120 further stores the stock transaction reservation information. The stored information can be deleted or updated in response to the client's demand.

The transaction execution module 130 includes an individual item buy/sell supporting module 131, a basket items buy/sell supporting module 132, an n times buy/sell supporting module 133. The transaction execution module 130 continuously or regularly monitors present stock prices of the items to be transacted, the items being registered by the investment information register and management module 110, through communication network connected to mainframe computer of the stock market 30, and then compares the present stock prices and the registered reserved buy/sell bidding prices. After comparing the prices, the transaction execution module 130 sends a transaction execution order with the registered reserved buy/sell bidding prices and reserved volumes to the mainframe computer 30, and finally updates the registered stock transaction reservation information such as reserved buy/sell volumes in response to execution results of the stock transaction.

When present stock prices of the items registered and managed by a investment information register and management module 110 are in the range of the predetermined prices i.e. reserved buy/sell bidding prices, the client paging supporting module 140 retrieves list of the clients who registered the stock transaction reservation information on that day and client paging information from the client database 120, and sends a client paging signal to the retrieved clients. At this time, the client paging support module 140 can send present stock price information of the items with the client paging information. Further, the client paging support module 140 can classify the retrieved clients into a plurality of groups and send the present stock price information to each group at predetermined intervals.

The individual item buy/sell supporting module 131 includes a individual item buy supporting module and an individual item sell supporting module.

The individual item buy supporting module compares the registered reserved buy bidding price with the present stock price, and then makes a buy transaction order to the mainframe computer 30 with the reserved buy bidding price and reserved volumes when the present stock price of the item is matched with the registered reserved buy bidding price. After the buy transaction is executed, the individual item buy supporting module transmits the transaction data to the investment information register and management module 110.

The individual item sell supporting module compares registered reserved sell bidding price with the present stock price, and then makes a sell transaction order to the mainframe computer 30 when the present stock price is higher than or in the range of the registered sell bidding prices (between maximum sell bidding price and minimum sell bidding price). After the sell transaction is executed, the individual item sell supporting module transmits the transaction data received from the mainframe computer of the stock market 30 to the investment information register and management 110.

The basket items buy/sell supporting module 132 includes a basket items buy supporting module and a basket items sell supporting module. The basket items buy supporting module monitors the present stock prices of a plurality of items which are listed in a basket and generates at least one condition to execute the basket items buy transaction. Then, the basket items buy supporting module makes and sends a transaction execution order to the mainframe computer of the stock market 30 at market prices and with registered reserved volumes when the condition generated by the basket items buy supporting module is matched with the predetermined condition registered in the stock transaction reservation information. After the basket items buy transaction is completed, the execution results of the basket items transaction is transferred to the investment information register and management module 110.

The basket items sell supporting module monitors the present stock prices of a plurality of items which are listed in a basket and generates at least one condition to execute a basket items sell transaction. Then, the basket items sell supporting module makes and sends a basket items sell transaction order to to the mainframe computer of the stock market 30 with market prices and registered volumes when the condition generated by the basket items sell supporting module is matched with the predetermined condition registered by the client. After the basket items sell transaction is completed, the execution results of the basket items sell transaction are transferred to the investment information register and management module 110.

The n times buy/sell supporting module 133 includes an n times buy supporting module and an n times sell supporting module. The n times buy supporting module makes and sends a first count of buy transaction execution order to the mainframe computer 30 when the registered reserved buy bidding prices are matched with the present stock prices, and then the makes and sends a first count of sell transaction execution order to the mainframe computer 30 when the registered reserved sell bidding prices are matched with the present stock prices. Therefore, the n times buy supporting module makes and sends alternately, consecutively and repeatedly buy transaction execution orders and sell transaction execution orders to mainframe computer 30 until nₜₕ-count of buy and sell transactions are executed.

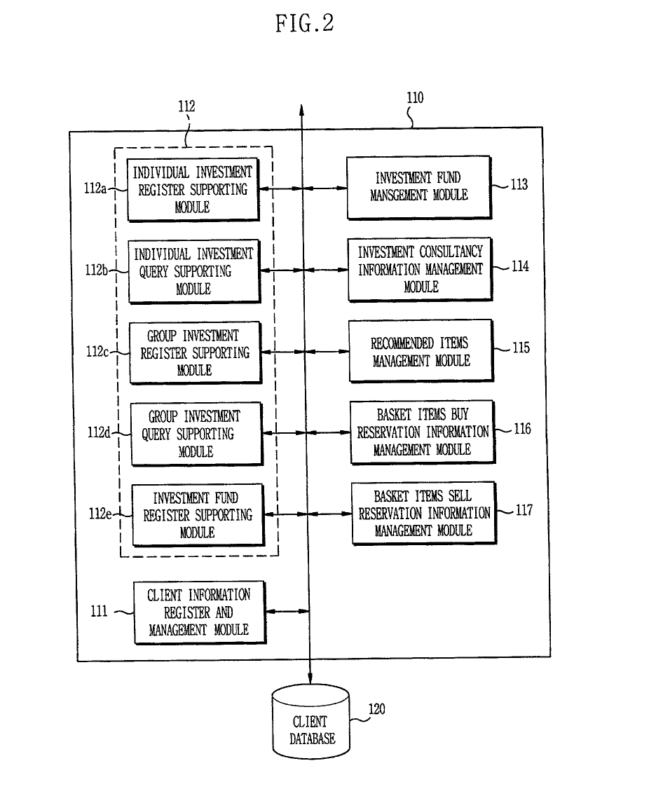

FIG. 2 is a block diagram showing configuration of detailed modules contained in the investment information register and management module 110. The investment information register and management module 110 includes a client information register and management module 111, a discretionary investment reservation information management module 112, an investment fund management module 113, an investment consultancy information management module 114, a recommended items management module 115, a basket items buy reservation management module 116 and a basket items sell reservation management module 117.

The client information register and management module 111 registers, retrieves and modifies the client information from the client database 120, and manages membership fees, commission, and receipt.

The discretionary investment reservation information management module 112 includes an individual investment register supporting module 112a, an individual investment query supporting module 112b, a group investment register supporting module 112c, a group investment query supporting module 112d and a investment fund register supporting module 112e.

The discretionary investment reservation information management module 112 provides client terminals 10, 20 (refer to FIG. 1) with at least one web page that includes a plurality of input boxes and buttons of “register”, “retrieve” and “print”. The client information (ID, password, registered number) and stock transaction reservation information (title of item, code of item, volumes, value amount) are entered into the input boxes by client's key-in through the web page. The discretionary investment reservation information management module 112 supports registration of stock transaction reservation information and transaction execution based on the reserved information, and updates and manages the stock transaction reservation information in response to the execution results of stock transaction. Further, the discretionary investment reservation information management module 112 can provide a plurality of buttons which includes “register individual investment,” “register group investment,” “retrieve individual investment,” “retrieve group investment,” “print list of items invested by an individual,” “print list of items invested by a group,” “display list of clients by a group,” “display list of all clients” to the web page, wherein each of the buttons is linked with a web page having corresponding information related to the each of buttons.

When the button “register individual investment” is selected, the individual investment register supporting module 112a provides a web page including a plurality of input boxes for receiving code of item, title of item, reserved buy bidding price (maximum buy bidding price, minimum buy bidding price), and reserved volumes to be transacted, and a plurality of display boxes for displaying buy value amount, sell value amount, cash and balance. Thus, the module 112a directly accesses the client database 120 to record the stock transaction reservation information inputted from the web page.

When the button of “retrieve individual investment” is selected, the individual investment query supporting module 112b provides a web page including an input box for receiving client registered number or client's name. If the client registered number or name is inputted through the input box, the module 112b displays the client information such as name, registered number, pager number as well as stock transaction reservation information such as code of item, title of item, volumes to be buy transacted at 1−nₜₕ count of transaction times, volumes to be sell transacted at 1−nₜₕ count of transaction times on the web page. When the button of “group investment register” is executed, the group investment register supporting module 112c provides a web page including a plurality of input boxes for receiving name of group, pager number, code of item, title of item, volumes to be buy transacted at 1−nₜₕ count of transaction times, volumes to be sell transacted in 1−nₜₕ count of transaction times, maximum buy bidding price at 1−nₜₕ count of transaction times, minimum buy bidding price at 1−nₜₕ count of transaction times, maximum sell bidding price at 1−nₜₕ count of transaction times, minimum sell bidding price at 1−nₜₕ count of transaction times, and a plurality of display boxes for displaying sum of buy volumes, sum of sell volumes, cash and balance. If the name of group is inputted in the input box, pager number, client registered number and name of the client are displayed in the web page and the module 112c accesses the client database 120 to record the stock transaction reservation information inputted from the input boxes.

When the button of “retrieve group investment” is executed, the group investment retrieve supporting module 112d provides a web page including an input box for receiving name of group and a button “retrieve” for retrieving all the items to be transacted. Thus, if name of a group is inputted into the input box, pager number of the group is displayed on the web page, and codes and titles of items registered as reservation information, reserved buy volumes at 1−nₜₕ count of transaction times, transacted buy volumes at 1−nₜₕ count of transaction times, reserved sell volumes at 1−nₜₕ count of transaction times, transacted sell volumes at 1−nₜₕ count of transaction times. The group investment retrieve supporting module 112d accesses the client database 120.

The investment fund management module 113 provides a web page including a plurality of input boxes, a plurality of display boxes, and buttons. The input boxes are employed on the web page for receiving fund name, items to be transacted through the fund, count of transaction times, and reference date to set a period. The plurality of display boxes is employed on the web page for displaying highest price, lowest price, present stock price during the period. The buttons includes “graphic information” and “yield estimation”. If the button of “graphic information” is selected, graphic information such as daily stock price chart, monthly stock price chart, and overhanging supply during the period will be displayed. Further if the button of “yield estimation” is selected, the investment fund management module 113 provides a new web page for providing yield information. The new web page displays yield which means percentage of return on investment. Further, the new web page includes an input box for receiving name or the code of item. Therefore if the title or code of the item is inputted through the input box, the new web page displays investment and transaction information such as investment amount, yield, holding status, balance.

The investment consultancy information management module 114 provides a web page displaying present buy/sell bidding price, buy/sell volumes, to give the clients consultation information and manages it. The recommended items management module 115 provides a web page to help the clients to select items to be invested. The web page has buttons and each of the buttons is linked with a corresponding web page to display corresponding information related to the each of the buttons. The item buttons includes “list of items highly undervalued,” “list of items ranked high in PER (price-earnings ratio),” “list of items having high retained earnings,” “list of items ranked high in average value of numerical order in each items of highly undervalued, high PER, and high retained earning”,” “list of items recorded consecutive daily permissible high price,” “list of items recorded high advanced rate,” “list of items recorded price at low during predetermined period,” “list of items recorded low advanced rate,” “list of items ranked high in gain over equity,” “list of items recorded price at new high,” “list of items recorded high advanced rate between lowest price and highest price,” and “reference line on the graphic chart.”

The recommended items management module 115 provides a selective web page related to the each item when a button is selected.

That is, when the button “list of items highly undervalued” is selected, a web page displaying list of highly undervalued items and average PBR (price book value ratio) of the items for recent years is provided. When the button of “list of items ranked high in price-earnings ratio (PER)” is selected, a web page displaying list of items ranked high in PER which means percentage of average earnings per share (EPS) over present stock price is provided.

When the button of “list of items having high retained earnings” is selected, a web page displaying list of items ranked high in percentage of retained earning value over total equity (present stock price×capital/face value) is provided.

When the button “list of items ranked high in average value of numerical order in each items of highly undervalued, high PER, high retained earnings” is selected, a web page displaying list of items ranked high in average value of numerical order in each items of highly undervalued, high PER, and high retained earnings is provided. The items listed by selecting the item button of “list of items ranked high in average value of numerical order in each items of highly undervalued, high PER, high retained earnings” has high safety and high return.

When the button “list of items recorded consecutive daily permissible high price” is selected, a web page displaying list of items recorded the consecutive daily permissible high price more than two times is provided.

When the button “list of items having high advanced rate” is selected, a web page displaying list of items recorded high advanced rate from the moving mean price line for predetermined period is provided.

When the button of “list of items recorded price at low” is selected, items recorded price at low for the predetermined period are retrieved and a web page displaying a daily stock price chart of the retrieved item is provided. The daily stock price chart further indicates price at low, buy points which are price levels advanced at a certain rate from the price at low, and sell points which are price levels advanced at a certain rate from each of the buy points.

When the button of “list of items recorded low advanced rate” is selected, a web page display list of items recorded lowest advanced rate for the predetermined period which is set by the client by inputting a reference date (year, month, date) is provided.

When the button of “list of items ranked high in gain over equity” is selected and semi-annual revenue or average revenue is set, a web page displaying list of items ranked high in percentage of net profit value per share over equity is provided.

When the button of “list of items recorded price at new high” is selected and a reference date (year, month, and data) is inputted, the web page displaying list of items recorded price at new high during a period from the reference date to the present is provided.

When the button of “list of items recorded high advanced rate from lowest price level to highest price level” is selected, the web page displaying list of items ranked high in advanced rate of stock price from the lowest price level is provided.

The basket items buy reservation information management module 116 provides to the client terminal a web page including item buttons of “buy basket items listed in stock exchange,” “buy basket items registered in KOSDAQ (Korea Securities Dealers Automated Quotations),” “buy basket items listed in stock exchange or registered in KOSDAQ,” “buy basket of appointed items,” “buy basket items classified by grades,” “past basket items buy transaction data of appointed items,” “execution results of the past buy transaction data of the appointed items,” and “execution results of all transaction data.” Therefore in case one of the item buttons is selected, the web page linked with the each of the item buttons is provided on the client terminal, and then titles or codes of items to be buy transacted in a basket, buy volumes and buy value amounts are inputted through input boxes on each web page by the client and the inputted data is saved and managed by the basket items buy reservation information and management module 116.

When, one of buttons “buy basket items listed in stock exchange,” “buy basket items registered in KOSDAQ” and “buy basket items listed in stock exchange or registered in KOSDAQ” is selected, a web page including a plurality of input boxes for receiving items to be buy transacted, buy value amount, client's registered number, client's name, password and count of past basket items buy transaction is presented on the client terminal.

Then, in case that the count of past basket items buy transaction is inputted into one of the input boxes, the module 116 provides a new web page displaying the past basket items buy transaction data. The past basket items buy transaction data includes transacted time (year, month, date, time) when the basket items buy transaction was executed, transacted items, buy prices and buy volumes. The new web page further provides a current stock holding status table. The current stock holding status table shows the list of items that remains in the client's account at the present, transaction date of remained items, buy value amounts at the past basket items buy transaction, present value amount.

On the other hand, in case that new buy value amount (investment amount) is inputted into one of the input boxes, the new buy value amount is equally divided by number of items listed in the basket. Each divided buy value amount per each item is further divided by the present stock price per share of each item, thereby buy volumes of each items is estimated. The estimated buy volumes are registered as stock transaction reservation information for basket items buy transaction.

When, the button “buy basket of appointed items” is selected, a web page including input boxes for receiving count of present basket items buy transaction, buy value amount, client's registered number, client's name, password, and count of past basket items buy transaction is provided.

Then, in case that the count of past basket items buy transaction is inputted into the input box, the module 116 provides past basket items buy transaction data. The past basket items buy transaction data includes transacted time (year, month, date, time) when the past basket items buy transaction was executed, list of items, buy prices and buy volumes. The web page further provides a current stock holding status table. The current stock holding status table shows the list of items that remains in the client's account at the present, transaction date of remained items., buy value amounts at the count of past basket items buy transaction, present value amounts estimated by present stock prices.

On the other hand, in case that buy value amount is inputted into the input box, the inputted buy value amount is equally divided by number of items listed in a basket, so that buy value amount per each item can be calculated. Each buy value amount per each item is further divided by the present stock price of each item, thereby volumes of each item for basket items buy transaction are estimated. The estimated volumes are registered as stock transaction reservation information for buy basket of appointed items transaction.

When, the button “buy basket items classified by grades” is selected, a web page including input boxes for receiving buy value amounts and grade on each share and a button for selecting market type (stock exchange/KOSDAQ/stock exchange or KOSDAQ) is provided by the basket items buy reservation information and management module 116. Therefore, after buy value amount and grade on each shares are inputted into the input boxes, the module 116 divides the buy value amount by number of grades and records the divided buy value amount as reservation information for buy basket items classified by grades.

When, the button “past basket items buy transaction data” is selected, a web page including input boxes for receiving client's registered number, client's name, password, count of past basket items buy transaction is provided to the client terminal by the basket items buy reservation information and management module 116. In case that the count of past basket items buy transaction is inputted into the corresponding input box, a new web page displaying past basket items buy transaction data at the count of transaction times is presented on the client terminal. The past basket items buy transaction data includes the following: codes, titles of items, stock holding status, volumes, buy bidding price per share, present stock price per share, yield, buy value amount, present value amount, profit/loss value amount. The new web page further provides average yield of the items in the basket, sum of buy value amount of the items, sum of profit/loss value amount of the items, sum of present value amount of the items.

The basket items buy reservation information and management module 116 further provides the new web page with input boxes for receiving total buy value amount (investment amount), yield average and/or sum of profit/loss value amount that is used as a reference to generate a condition for executing basket items buy transaction. The condition for executing basket items buy transaction is as follows:

In case that total buy value amount is inputted into one of the input boxes, the condition for executing basket items buy transaction will be generated when the sum of present value amount of items listed in the basket of past basket items transaction data is less than the inputted total buy value amount.

Further, in case that yield average is inputted into the one to the input boxes, the condition for executing basket items buy transaction will be generated when yield average of the past basket items buy transaction is about same to the newly inputted yield average.

Further, in case that sum of profit/loss value amount is inputted into the one to the input boxes, the condition for executing basket items buy transaction will be generated when the sum of profit/loss value amount of the past basket items buy transaction is about same to the newly inputted profit/loss value amount.

When, the button “execution results of past basket items buy transaction data of appointed items” is selected, a web page including input boxes for receiving client's registered number, client's name, password, count of past basket items buy transaction of appointed items is provided to the client terminal by the basket items buy reservation information and management module 116. In case that the count of past basket items buy transaction is inputted into the corresponding input box, a new web page displaying execution results of past basket items buy transaction data is presented on the client terminal. The past basket items buy transaction data includes the following: code of item, title of item, holding status, buy volumes, buy price per share, present stock price per share, yield, buy value amount by each share, present value amount estimated by the present stock price, profit or loss value amount by each item. The new web page further provides average yield, sum of buy value amount of the items listed in the past basket items buy transaction data, sum of profit/loss value amount of the items listed in the past basket items buy transaction data, sum of present value amount of the items listed in the past basket items buy transaction data.

The basket items reservation information and management module 116 further provides the new web page with input boxes for receiving total buy value amount (investment amount), yield average and/or sum of profit/loss value amount that is used as a reference to generate a condition for executing basket items buy transaction. The condition for executing basket items buy transaction is as follows:

In case that total buy value amount is inputted into one of the input boxes, the condition for executing basket items buy transaction will be generated when the sum of present value amount of items listed in the basket of past basket items transaction data is less than the inputted total buy value amount.

Further, in case that yield average is inputted into the one to the input boxes, the condition for executing basket items buy transaction will be generated when yield average of the past basket items buy transaction data is about same to the newly inputted yield average.

Further, in case that sum of profit/loss value amount is inputted into the one to the input boxes, the condition for executing basket items buy transaction will be generated when the sum of profit/loss value amount of the past basket items buy transaction is about same to the newly inputted profit/loss value amount.

When, the button “execution results of all transaction data” is selected, a web page including input boxes for receiving client's registered number, client's name, password and a selection button for selecting basket type (items listed in stock exchange, items registered in KOSDAQ, items listed or registered in stock exchange or KOSDAQ, appointed items, items classified by grades) is provided to the client terminal by the basket items buy reservation information and management module 116. In case that the count of past basket items buy transaction is inputted into the corresponding input box, a new web page displaying past basket items buy transaction data table is presented on the client terminal. The past basket items buy transaction data table includes the following: codes of items, titles of items, holding status, volumes of each item, buy price of each item, present stock price of each item, yield, buy value amount of each item, and profit/loss value amount of each item. The new web page further provides average yield, sum of buy value amount of items listed in the data table, sum of profit/loss value amount of items listed in the data table, sum of present value amount of items listed in the data table.

The basket items sell reservation information management module 117 provides to the client terminal a web page including item buttons of “sell basket items listed in stock exchange,” “sell basket items registered in KOSDAQ,” “sell buy basket items listed in stock exchange or registered in KOSDAQ,” “sell basket of appointed items,” “sell basket items classified by grades,” “past basket items sell transaction data of appointed items,” “execution results of past basket items sell transaction,” “execution results of all sell transactions”. If one of the item buttons is selected, a corresponding web page linked with the each of the item buttons is provided on the client terminal. The each web page includes input boxes for receiving titles or codes of each item to be transacted, sell volumes and sell value amount. Therefore, the basket items sell reservation information management module 117 registers and manages the sell reservation information by receiving the title or code of each item, volumes and value amount through the input boxes.

When, one of the buttons “sell basket items listed in stock exchange”, “sell basket items registered in KOSDAQ” and “sell basket items listed in stock exchange or registered in KOSDAQ” is selected, the web page including input boxes for receiving codes of items to be sell transacted in a basket, sell value amount, client's registered number, client's name, password and count of past basket items sell transaction is provided on the client terminal.

Then, in case that the count of past basket items sell transaction is inputted into one of the input boxes, the module 117 provides a new web page displaying the past basket items sell transaction data at the count. The past basket items sell transaction data includes transacted time (year, month, date, time), items listed in a basket, sell prices and sell volumes of each item. The new web page further provides a present stock holding status table including sell value amount, and present value amount.

On the other hand, in case that sell value amount to be transacted is inputted into the input box, if sum of present value amount of the items listed in the basket is greater than the inputted sell value amount, present stock prices of the items listed in the basket are registered as reservation information for basket items sell transaction.

When, the button “sell basket of appointed items” is selected, a web page including input boxes for receiving count of present basket items sell transaction, value amount, client's registered number, client's name, password, count times of past basket items sell transaction is presented on the client terminal.

Then, in case that the count of past basket items sell transaction is inputted into one of the input boxes, the module 117 provides a new web page displaying the past basket items sell transaction data. The past basket items sell transaction data includes transacted time (year, month, date, time), list of items, sell bidding price and sell volumes of each item. The new web page further provides a stock holding status table including sell value amount on the past basket items sell transactions and present value amount.

On the other hand, in case that sell value amount to be sell transacted is inputted into one of the input boxes, the inputted sell value amount is equally divided by number of items listed in the basket, thereby sell value amount per each item can is estimated.

When, the button “sell basket items classified by grades” is selected, a web page including input boxes for receiving investment amount, grade on each share listed in a basket, and buttons for selecting market type (stock exchange/KOSDAQ/stock exchange or KOSDAQ) and for executing sell transaction order is provided to the client terminal by the basket items sell reservation information management module 117. Therefore, after the investment amount and grade on each share are inputted into the input boxes, the module 117 divides the investment amount in accordance with the grade of each item and records the divided amount as reservation information for executing basket items sell transaction.

When, the button of “past basket items sell transaction data” is selected, a web page including input boxes for receiving client's registered number, client's name, password, count of past basket items sell transaction is provided to the client terminal by the basket items sell reservation information management module 117. In case that the count of times of past basket items sell transaction is inputted into the corresponding input box, a new web page displaying past basket items sell transaction data table is presented on the client terminal. The past basket items sell transaction data table includes codes of items, titles of items, , sell volumes, sell price of each item, present stock price of each item, yield of each item, sell value amount of each item, profit/loss value amount of each item, present value amount of each item. The new web page further provides average yield of all items in the data table, , sum of sell value amount of all items in the data table, sum of profit/loss value amount of items in the data table, sum of present value amount of items in the data table. The basket items sell reservation information management module 117 further provides the new web page with input boxes for receiving total sell value amount, yield average and/or sum of profit/loss to generate a condition for executing basket items sell transaction. The condition for executing basket of share sell transaction is as follows:

In case that total sell value amount for basket items sell transaction is inputted into one of the input boxes, the condition for executing basket items sell transaction will be generated when the sum of present sell value amount in the data table is greater than the total value amount.

Further, in case that yield average is inputted into the one to the input boxes, the condition for executing basket items sell transaction will be generated when yield average in the data table is about same to the inputted yield average.

Further, in case that profit/loss value amount is inputted into the one to the input boxes, the condition for executing basket items sell transaction will be generated when the sum of profit/loss value amount in the data table is about same to the inputted profit/loss value amount.

When, the button “execution results of past basket items transaction of appointed items” is selected, a web page including input boxes for receiving client's registered number, client's name, password, count of times of past basket items sell transaction is provided to the client terminal by the basket items sell reservation information management module 117. In case that the count of times of past basket items sell transaction is inputted into the corresponding input box, a new web page displaying past basket items sell transaction execution data table is presented on the client terminal. The past basket items sell transaction execution data table includes: code of items, title of items, holding status, volumes of each item, sell price of each item, present stock price of each item, yield of each item, sell value amount of each item, profit/loss value amount of each item, present value amount of each item. The new web page further provides average yield of all items, sum of sell value amount of all items, sum of profit/loss value amount of all items, sum of present value amount of all items.

The basket items sell reservation information management module 117 further provides the new web page with input boxes for receiving total sell value amount for basket items sell transaction, yield average and/or sum of profit/loss value amount to generate a condition for executing basket items sell transaction. Therefore, the module 117 generates and registers a condition for executing basket items sell transaction in case of the following:

1) In case that total sell value amount is inputted into one of the input boxes, and the sum of sell value amount in the data table is greater than the inputted total sell value amount.

2) In case that yield average is inputted into the one to the input boxes, and yield average in the data table is about the same to the inputted yield average.

3) In case that profit/loss value amount is inputted into the one to the input boxes and, the sum of profit/loss value amount in the data table is about the same to the inputted profit/loss value amount.

When, the button “execution results of past basket items sell transaction” is selected, a web page including input boxes for receiving client's registered number, client's name, password and selection buttons to select basket type (items listed in stock exchange, items registered in KOSDAQ, listed or registered in stock exchange or in KOSDAQ, appointed items, items classified by grades) is provided to the client terminal by the basket items sell reservation information management module 117. In case that the count of times of past basket items sell transaction is inputted into the corresponding input box, a new web page displaying past basket items sell transaction data table is presented on the client terminal. The past basket items sell transaction data table includes: codes of items, titles of items, stock holding status, volumes of each item, sell price of each item, , yield of each item, sell value amount of each item, present value amount of each item, profit or loss value amount of each item. The new web page further provides average yield of all items in the data table, sum of sell value amount of all items in the data table, sum of profit/loss value amount of all items in the data table, sum of present value amount of all items in the data table.

A method for supporting stock exchange using the stock exchange supporting system in accordance with the present invention will be detailed below.

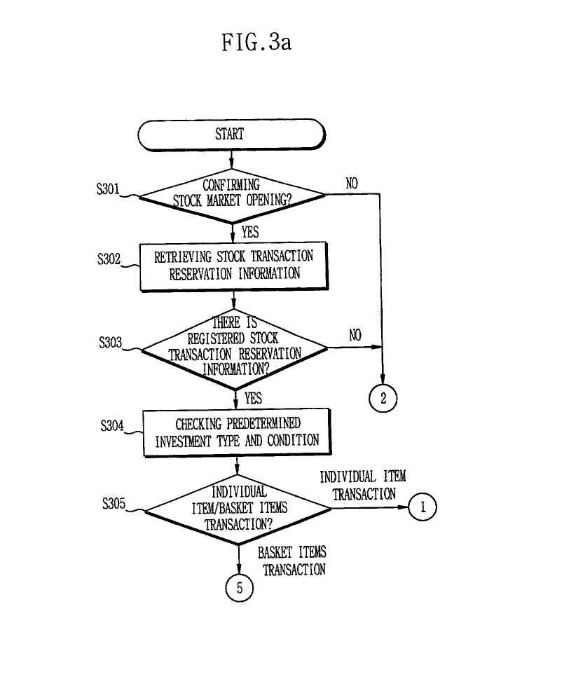

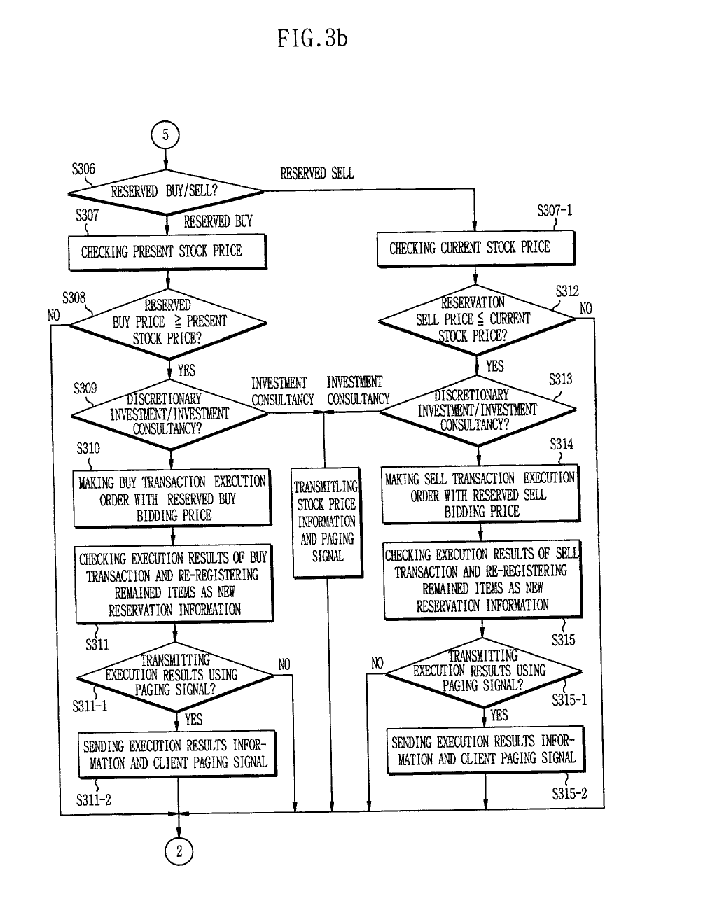

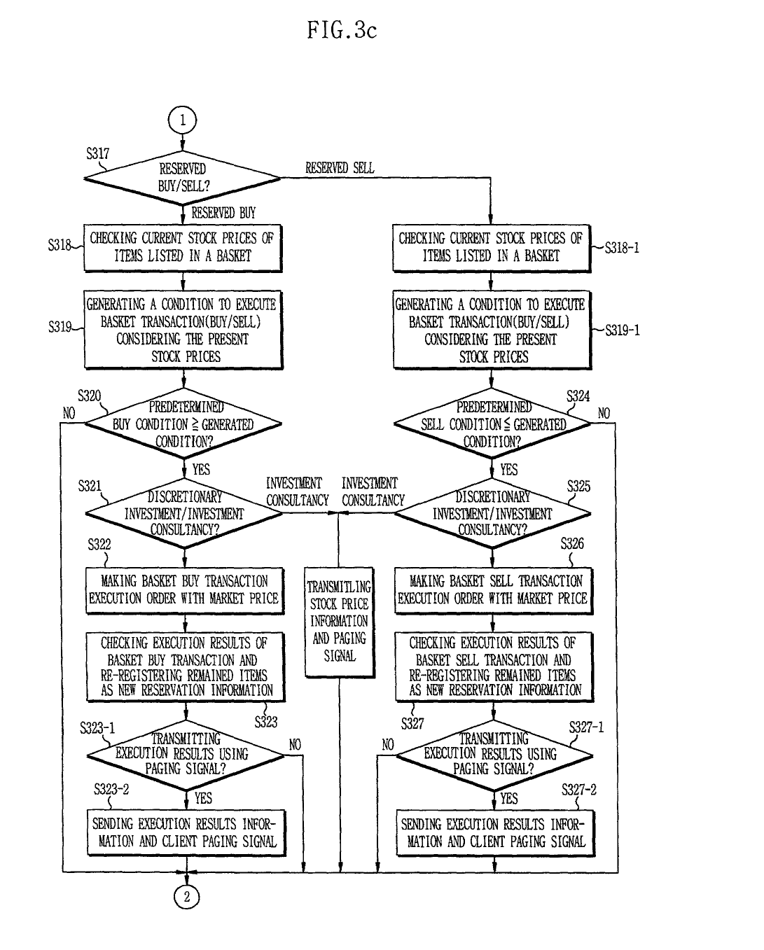

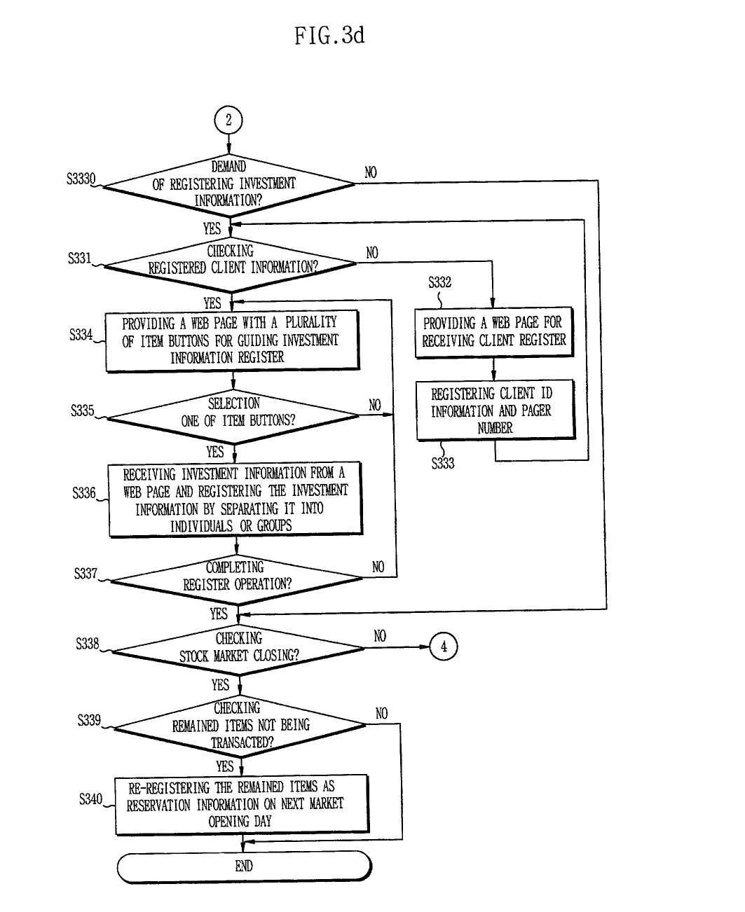

FIGS. 3a through 3d are flow charts showing a method for supporting stock exchange using the stock exchange supporting system in accordance with the preferable embodiment of the present invention as described above. The method for supporting stock exchange comprises the steps of (a) checking market condition and (b) post-treating for sending a transaction order to a mainframe computer of stock exchange to execute the transaction or for providing at least one client with real time stock price information. The method in accordance with the present invention further comprises the steps of (c) registering investment information and (d) re-registering stock transaction reservation information after stock market is closed. The step (a) of checking market condition includes the sub-steps of checking opening of the stock market, retrieving stock transaction reservation information, retrieving investment type and condition for individual item transaction or basket items transaction, monitoring the present stock prices at regular intervals, and determining whether or not the present stock prices are matched with the investment type and condition predetermined in the stock transaction reservation information.

The step (b) of post-treating includes the sub-steps of retrieving the client who is registered the stock transaction reservation information including the investment type and condition for stock exchange from the client registered information if the present stock prices are matched with the investment type and condition predetermined in the stock transaction reservation information, confirming whether the client supporting type is discretionary investment or investment consultancy, and sending a transaction order to a mainframe computer of stock exchange to execute the transaction or providing at least one client with present stock price information through the client terminal in response to the client supporting type.

The step (c) of registering investment information includes the sub-steps of receiving stock transaction reservation information such as the client's ID and paging information (address on the communication or pager number, paging time) from the clients, at least one item to be transacted or consulted, stock bidding price to be transacted (buy bidding price or sell bidding price), transaction type (individual item or basket items), count of transaction times of each item, condition for executing individual item transaction or basket items transaction, and registering the stock transaction reservation information by it into individuals or groups.

The step (d) of re-registering the stock transaction reservation information will be detailed below. After being closed of the stock market on that day when a stock transaction reservation is made, the stock transaction reservation information on that day should be checked. Thus, if a part of the stocks which is reserved to be transacted remained not being transacted, the remained part of the stocks are re-registered as stock transaction reservation information on next market opening day. Thus, the remained part of the stocks will be transacted on or after the next market opening day by performing the steps (a)-(b) and (d) repeatedly.

The step of (a) checking market condition will be further detailed below.

The step (a) includes the sub-steps of (a10-1) checking a stock market opening s301, retrieving the stock transaction reservation information s302, s303 to confirm whether the stock transaction reservation information is registered on that day and determining the transaction type s304, (individual buy or sell) of stock transaction reservation information. In case the transaction type is individual buy, (a11) present stock prices of items registered in the stock transaction reservation information is compared with the range of reserved buy bidding prices, and a condition to execute individual item buy transaction is set when the range of reserved buy bidding price (from maximum buy bidding price to minimum buy bidding price) is the same as or higher than the present share prices. In case of transaction type of individual sell (a12), present stock prices of items registered in the stock transaction reservation information is compared with the range of reserved sell bidding prices, and a condition to execute individual item sell transaction is set when the range of reserved sell bidding price (from minimum sell bidding price to maximum sell bidding price) is the same as or lower than the stock prices.

The step of (a) checking market condition further includes the sub-steps of (a10-2) checking a stock market opening s301, retrieving the stock transaction reservation information s302 to confirm whether the stock transaction reservation information is registered on that day s303 and determining the transaction type (basket buy or sell) of stock transaction reservation information s304, s305, (a13) in case the transaction type is basket buy s317, generating at least one market condition to execute the basket items buy transaction s319 by checking present stock prices of items registered in the stock transaction reservation information s318, comparing the generated market condition with the investment condition which is registered in the stock transaction reservation information s320, and setting the generated market condition to the investment condition to execute basket items buy transaction when the generated market condition is matched with the registered investment condition, and (a14) in case the transaction type is basket sell s3l7, generating at least one market condition to execute the basket items sell transaction s319-1 by checking present stock prices of items registered in the stock transaction reservation information s318-1, comparing the generated market condition with the investment condition which is registered in the stock transaction reservation information s324, and setting the generated market condition to the investment condition to execute basket items sell transaction when the generated market condition is matched with the registered investment condition.

The step (b) includes (b1) automatic transaction execution step s311-2, s313-s315-2, s321-s323-2, s325 which checks whether client supporting type is discretionary investment or investment consultancy, and in case of discretionary investment, automatically sends transaction execution order with the registered investment condition to the mainframe computer of stock market 30, and (b2) stock price information providing step s316, s328 which checks whether client supporting type is discretionary investment or investment consultancy, and in case of investment consultancy, sends a client paging signal to at least one client and provides the clients with the stock price information of items that is is registered in the stock transaction reservation information.

The step of (b) post-treating further includes a step of (b3) sending radio paging information to at least one client terminal at predetermined paging time by retrieving the client paging information in case the client supporting type is investment consultancy. Further, in the step of (b3) sending radio paging information, the stock price information can be sent to the clients with the client paging information. Still further, the client paging information can be can be classified into groups and sent to each of the groups at at intervals. The step of (b3) sending radio paging information includes a step of (b31) connecting a web page which is provided by the mobile communication service provider s401-s403; a step of (b32) initializing input boxes installed in the web page and standing by the client paging information s404, s405; a step of (b33) automatically writing the client paging information into the web page at the standing by status s406-s421 and performing paging operation; and a step of (b34) confirming completion of paging operation s422, s423, initializing the input boxes installed in the web page and sending confirmation signal of paging completion.

The step of (b33) automatically writing the client paging information includes a step of (b331) inputting client pager number in an input box for receiving the client pager number by placing a cursor; a step of (b332) inputting telephone number to be reached into an input box for receiving the telephone number; a step of (b333) determining paging mode between numeric/character mode and voice mode by placing a cursor in a message box for receiving message; a step of (b334) marking paging mode selection box with numeric/character mode, inputting message (code of item, title of item, present stock price, buy or sell recommendation, buy bidding price or sell bidding price, reserved volumes or holding volumes) with numeric or character into the message box, performing paging operation with inputted messages, and repeating the steps from b331 to b334 in case all messages can not be inputted into the message box; a step of marking paging mode selection box with voice, inputting message (code of item, title of item, present stock price, buy or sell recommendation, buy bidding price or sell bidding price, reserved voulmes or holding volumes) with voice into the message box, performing paging operation with inputted messages, and repeating the steps b331-b333 and b335 in case all messages can not be inputted into the message box.

The step of (b3) further can send stock price information retrieved from the mainframe computer of the stock market to the client terminal with the client paging information.

The step of (b3) can classify the client paging information into groups and send the client paging information to each group at intervals.

The (b1) automatic transaction execution step includes a step of (b10-1) confirming whether the client supporting type is discretionary investment or investment consultancy s309, s313. In case of discretionary investment, the (b1) automatic transaction execution step further performs a step of (b11) making and sending a buy transaction execution order to a mainframe computer of stock exchange 30 with respect to the items registered to be buy transacted with reserved buy volumes and present stock prices and updating the stock transaction reservation information by checking execution results of the buy transaction s310, s311, or a step of (b12) making and sending a sell transaction execution order to a mainframe computer of stock exchange 30 with respect to the items registered to be sell transacted with reserved sell volumes and present stock prices a and updating the stock transaction reservation information by checking execution results of the sell transaction s314, s315.

The (b1) automatic transaction execution step includes a step of (b10-3) confirming whether the client supporting type is discretionary investment or investment consultancy s321, s325. In case of discretionary investment, the (b1) automatic transaction execution step further performs a step of (b13) making and sending a basket items buy transaction execution order to a mainframe computer of stock exchange 30 with respect to the items registered to be buy basket transacted with reserved buy volumes and present stock prices and updating the stock transaction reservation information by checking execution results of the basket items buy transaction s322, s323, or a step of (b14) making and sending a basket items sell transaction execution order to a mainframe computer of stock exchange 30 with respect to the items registered to be sell basket transacted with reserved sell volumes and present stock prices and updating the stock transaction reservation information by checking execution results of the basket items sell transaction s326, s327.

The (b1) automatic transaction execution step further includes a step of (b15) executing individual item sell transaction or basket items sell transaction with respect to the items that have been bought through the step (b11) or (b13) with reserved sell bidding price registered in the stock transaction reservation information after the step (b11) or the (b13) is performed.

The (b1) automatic transaction execution step further includes a step of (b16) executing individual item buy transaction or basket items buy transaction with respect to the items that have been sold through the step (b12) or (b14) with reservation buy bidding price and volumes registered in the stock transaction reservation information after the step (b12) or (b14) is performed.

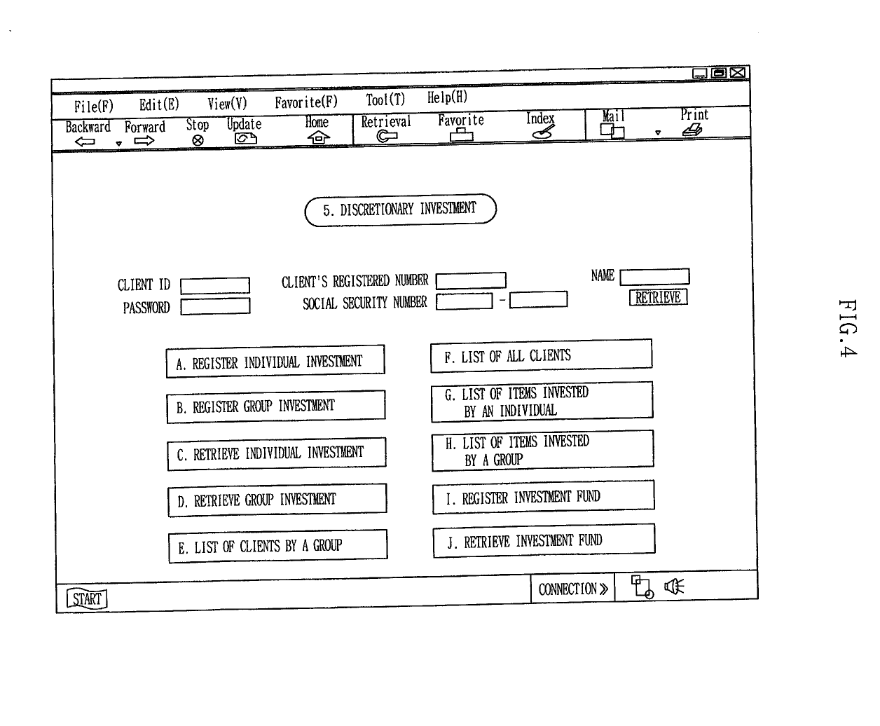

The step of (c) registering investment information includes a step of (c1) registering discretionary investment reservation information. The step of (c1) provides at least one web page which includes input boxes for receiving client identification information, password, client's registered number, code or title of item to be transacted, and volumes and value amount to be transacted. The step of (c1) supports registering, retrieving or printing list of the items to be transacted and list of clients. The step (c1) further supports registration of stock transaction reservation information and reservation transaction execution, and updates the stock transaction reservation information in response to the execution results of reserved transaction. FIG. 4 is the web page used during the step of (c1) for registering discretionary investment reservation information. The web page of FIG. 4 includes a plurality of buttons each of which is linked with a web page having information related to the each of buttons, wherein the buttons include “register an individual investment,” “register a group investment,” “retrieve an individual investment,” “retrieve a group investment,” “display list of clients by a group,” “print list of items invested by an individual,” “print list of items invested by a group,” “display list of all clients,” “register investment fund,” and “retrieve investment fund.”

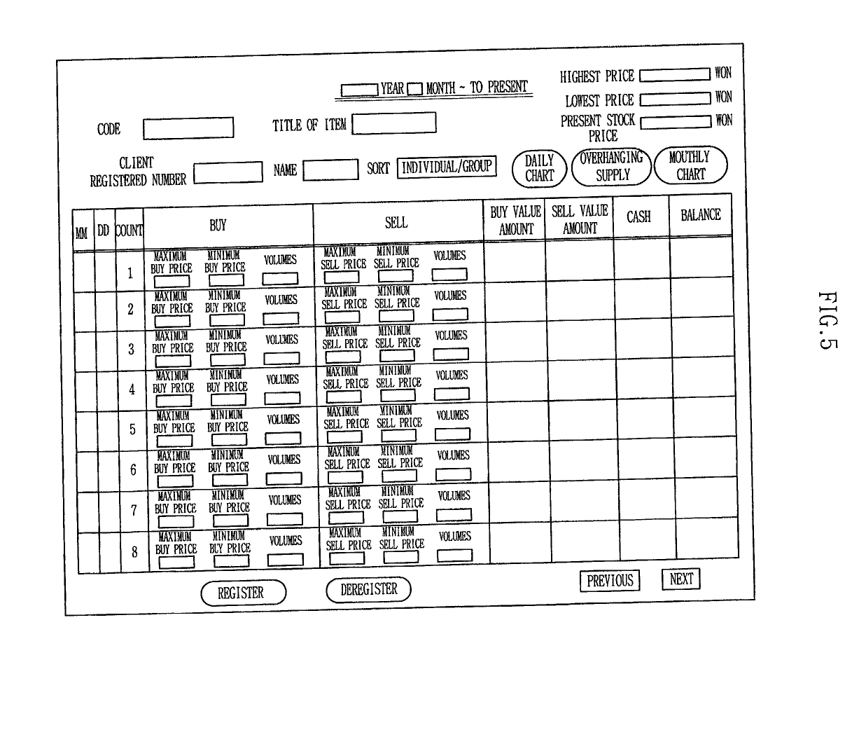

The step of (c1) registering a discretionary investment reservation information includes a step of (c11) supporting register individual investment, wherein when the button of “register individual investment” is selected, the step of (c11) provides a web page shown in FIG. 5 having a plurality of input boxes for receiving code and time of item, maximum reserved buy bidding price at 1−nₜₕ count of buy transaction, minimum reserved buy bidding price at 1−nₜₕ count of buy transaction, reserved buy volumes, maximum reserved sell bidding price at 1−nₜₕ count of sell transaction, minimum reserved sell bidding price at 1−nₜₕ count of sell transaction, and reserved sell volumes and display boxes for displaying buy value amount, sell value amount, cash, and balance.

The step (c11) further provides the web page with a button of graphic information linked with a web page showing overhanging supply or daily/monthly stock price changes, an input box for receiving a reference date to set a period and display boxes for displaying highest price, lowest price and present stock price during the period.

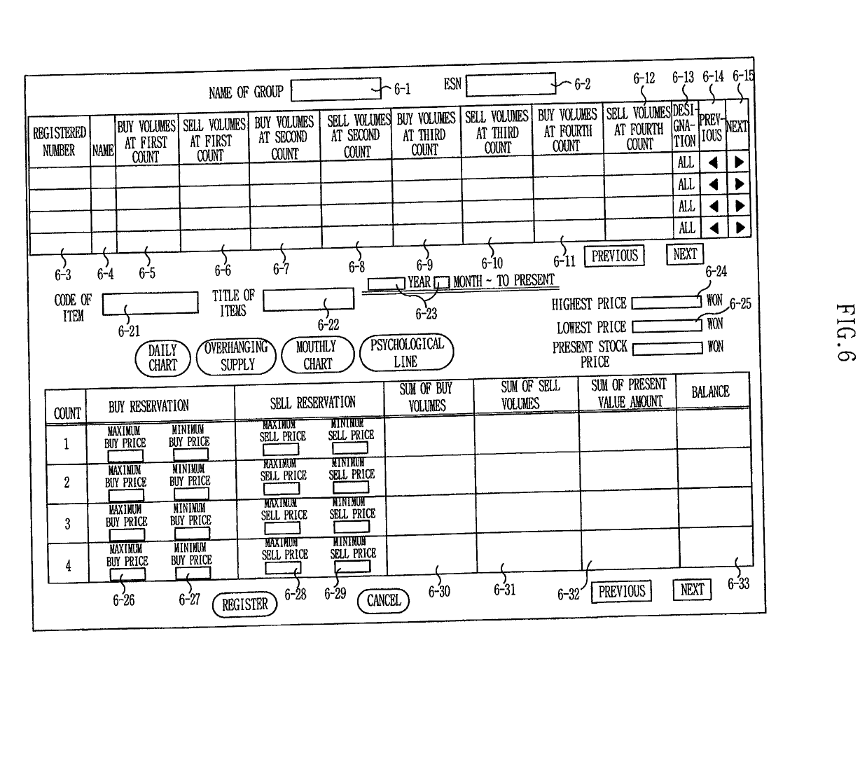

The step (c1) further includes a step of (c12) supporting register group investment, wherein when the button of “register group investment” is selected, the step (c12) provides a web page shown in FIG. 6 having a plurality of input boxes for receiving group name, ESN (electronic serial number) of pager, code and title of item, maximum reserved buy bidding price at 1−nₜₕ count of buy transaction, minimum reserved buy bidding price at 1−nₜₕ count of buy transaction, reserved buy volumes, maximum reserved sell bidding price at 1−nₜₕ count of sell transaction, minimum reserved sell bidding price at 1−nₜₕ count of sell transaction, and reserved sell volumes and display boxes for displaying sum of buy value amount, sum sell value amount, current cash, balance. Further, in FIG. 6, if the group name is inputted into the corresponding input box, the web page further displays ESN, client's registered number, list of clients belong to the group.

The step of (c12) supporting the group investment register further provides the web page with a plurality of display boxes for displaying sum of reserved buy volumes at first order of buy transaction, sum of reserved sell volumes at first order of sell transaction, sum of investment amount of which clients reserved to buy shares at the first order of buy transaction invested, and present cash amount which is estimated by subtracting the present cash amount from the sum of investment amount.

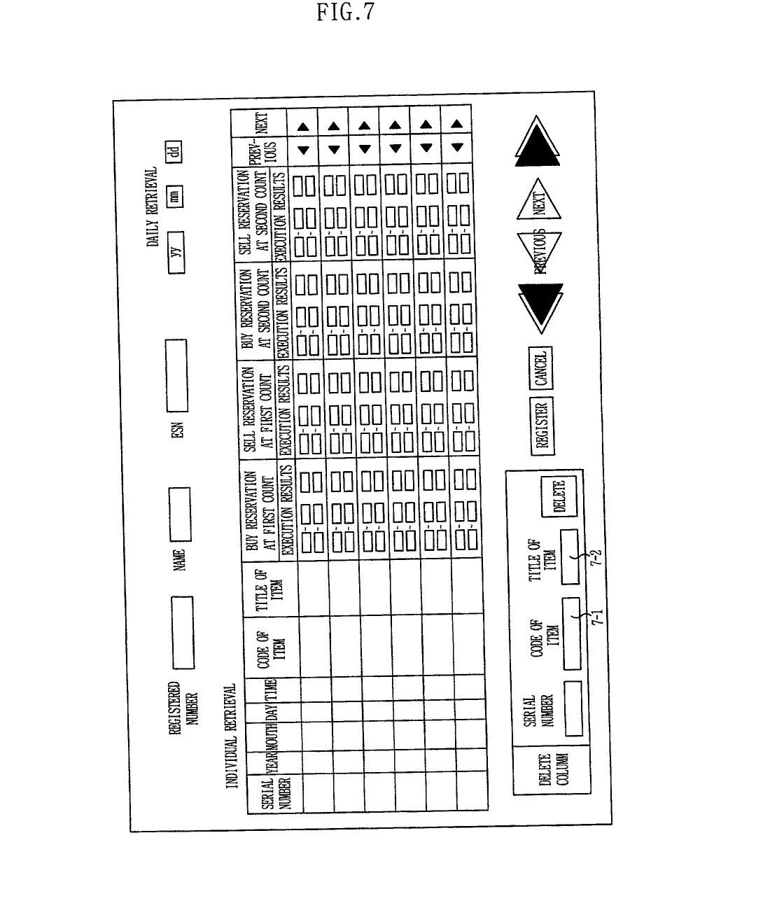

The step (c1) includes a step of (c13) supporting an individual investment retrieve, wherein when the button of “retrieve individual investment” is selected, the step (c13) provides a web page shown in FIG. 7 having a plurality of input boxes for receiving client's registered number or client's name, and display boxes for displaying client's name, client's registered number, pager number, code and title of item on which transaction reservation is made by client and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell bidding price at 1−nₜₕ count of sell transaction, minimum reserved sell bidding price at 1−nₜₕ count of sell transaction, and reserved sell volumes, and execution results of 1−nₜₕ count of sell transaction.

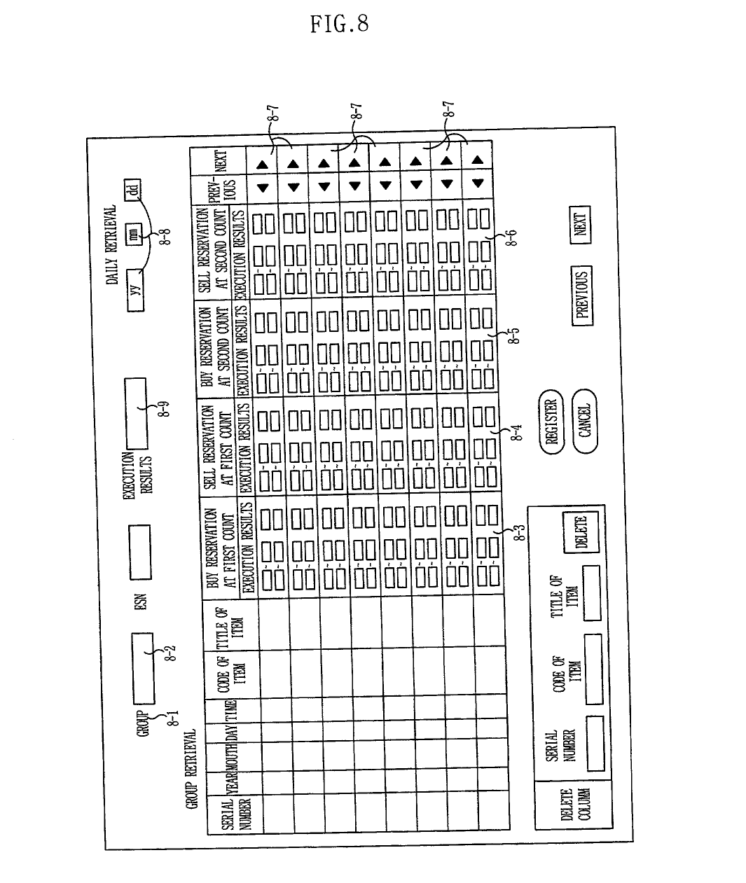

The step of (c1) registering discretionary investment reservation information includes a step of (c14) supporting retrieve group investment, wherein when the button of “retrieve group investment” is selected, the step (c14) provides a web page shown in FIG. 8 having an input box for receiving a group name and a plurality of display boxes for displaying ESN of pager, code and title of item on which transaction reservation is made and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell bidding price at 1−nₜₕ count of sell transaction, minimum reserved sell bidding price at 1−nₜₕ count of sell transaction, and reserved sell volumes, and execution results of 1−nₜₕ count of sell transaction.

The step of (c1) registering discretionary investment reservation information supports displaying and printing list of clients by groups or list of all clients.

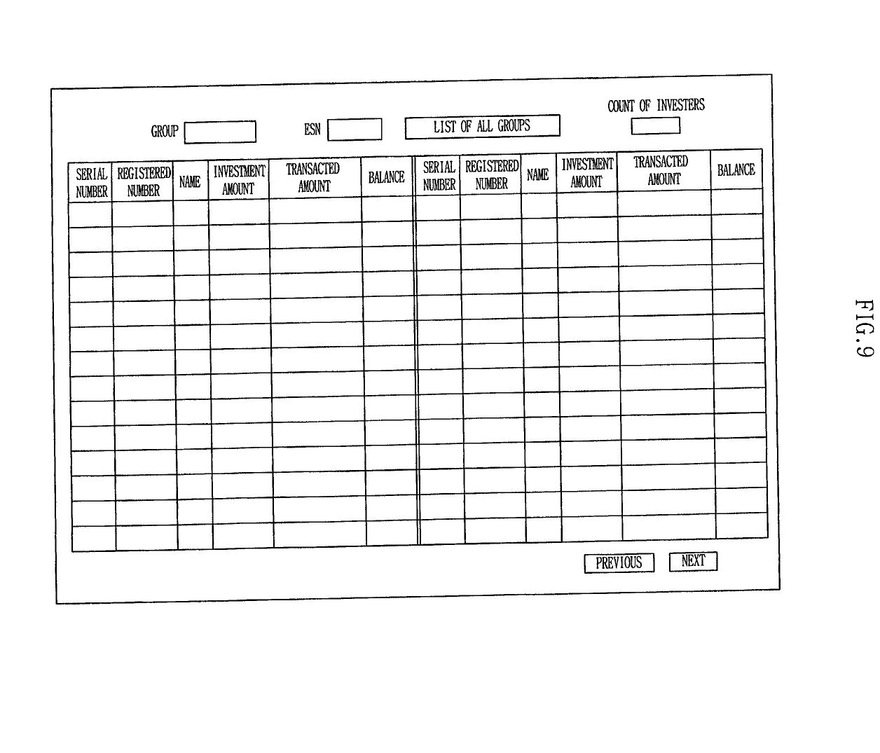

FIG. 5 shows a web page which is provided when the button “register individual investment” is selected. The button “register individual investment” is installed in the web page of FIG. 4 for registering discretionary investment reservation information. FIG. 6 shows a web page which is provided when the button of “register a group investment” is selected. FIG. 7 shows a web page which is provided when the button “retrieve an individual investment” is selected. FIG. 8 shows a web page which is provided when the button “retrieve a group investment” is selected. FIG. 9 shows a web page which is provided when the button “print list of clients by groups” is selected.

The web page of FIG. 5 comprises an input box for receiving reference date which is needed to set a period from past to present during the step of registering individual investment information, display boxes for displaying highest price during the period, lowest price during the period, present stock price, and a graphic information button which is linked with a web page showing daily/monthly stock price changes or overhanging supply during the period.

The web page of FIG. 6 includes a plurality of display boxes for displaying sum of buy volumes of items to be buy transacted at first count of buy transaction during the step of registering a group investment, sum of sell volumes of items which are reserved to be sell transacted, sum of investment amount invested by the clients who made buy transaction reservation at the first count of the buy transaction, and sum of present cash which is estimated by subtracting the sum of buy amount at the first count of buy transaction from the sum of investment amount.

The step of (c) registering investment information includes a step of (c2) registering investment fund information, a step of (c3) registering investment consultancy information, a step of (c4) registering recommended items management information and a step of (c5) registering basket items buy/sell reservation information.

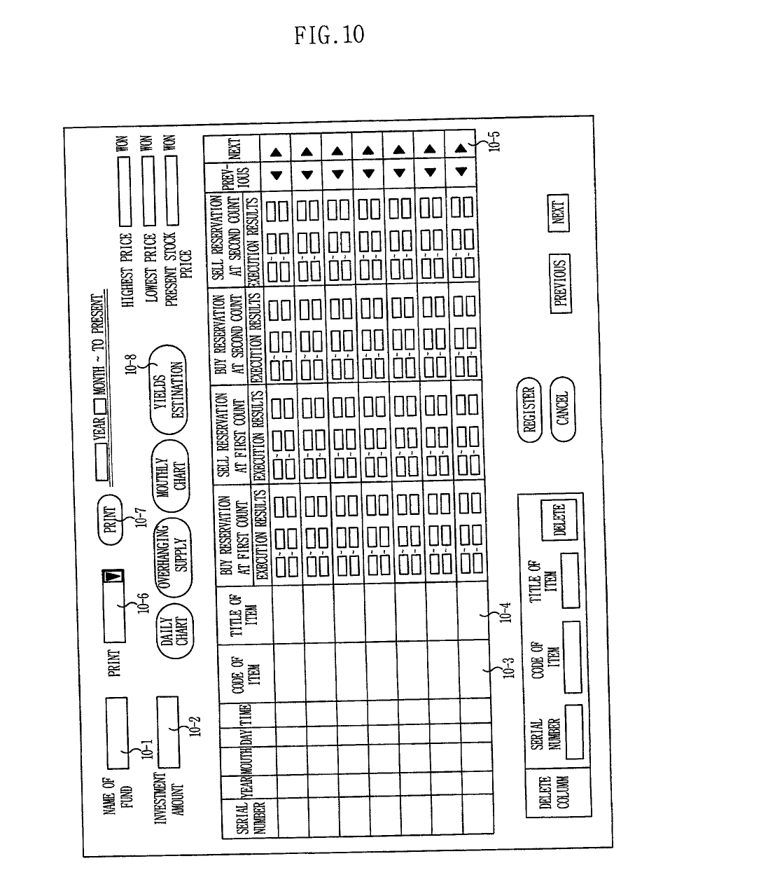

The step of (c2) provides a web page shown in FIG. 10 and manages discretionary investment information in response to information inputted through the web page including a plurality of input boxes, a plurality of display boxes, and a plurality of buttons, wherein the input boxes are installed on the web page for receiving fund name, items to be transacted through the fund, count of transaction, and reference date to set a period of transaction, the plurality of display boxes is installed on the web page for displaying highest price, lowest price, present stock price during the period, and the plurality of buttons includes graphic information and yield estimation, in which the button of graphic information is linked with a web page showing graphic information of daily/monthly stock price changes and overhanging supply during the period and the button of yield estimation is linked with a web page showing yield information.

The step of (c3) registering investment consultancy information provides a web page having stock price information such as buy or sell recommendation, buy bidding price or sell bidding price and buy volumes and sell volumes and registers the stock price information shown on the web page as the investment consultancy information.

The step of (c4) registering recommended items management information provides a web page including a plurality of item buttons, each of which is linked with a web page containing corresponding information relating to each item to guide the clients with items which are worth investing.

The step of (c5) registering basket items buy/sell reservation information registers and manages items to be basket transacted by receiving code or title of the item, volumes and value amount.

FIG. 10 shows a web page for registering investment fund. The web pages for registering investment consultancy information or recommended items information are similar to the web page of FIG. 10.

The step (c2) includes a step of (c21) providing yield information such as percentage of return on investment amount when the button of “yield estimation” is selected, and a step of (c22) providing detailed investment and transaction information such as investment amount of each item, yield of each item, stock holding status, balance.

The web page provided by the step of registering recommended items management information includes a plurality of item buttons, each of which is linked with a corresponding web page to display corresponding information related to the each item, wherein the item buttons includes “list of items highly undervalued,” “list of items ranked high in PER,” “list of items having high retained earnings,” “list of items ranked high in average value of numerical order in each items of highly undervalued, high PER, high retained earning,” “jnlist of items recorded consecutive daily permissible high price,” “list of items having high advanced rate,” “list of items recorded price at low during a predetermined period”, “list of items recorded low advanced rate,” “list of items having high gain over equity,” “list of items recorded price at new high,” and “list of items recorded high advanced rate between lowest price and highest price.”

The step of (c4) registering recommended items management information provides a web page displaying list of items highly undervalued by estimating PBR (price book value ratio) which means ratio of stock price over book value when the item button of “list of items highly undervalued” is selected.

The step of (c4) registering recommended items management information provides a web page displaying list of items ranked high in PER (price earnings ratio) by estimating percentage of average EPS (earning per share) for recent several years over present stock price when the item button of “list of items ranked high in PER” is selected.

The step of (c4) registering recommended items management information provides a web page displaying list of items ranked high in percentage of retained earnings over total equity (present stock price×capital/par value) when the item button of “list of itemed ranked high in retained earnings” is selected.

The step of (c4) registering recommended items management information provides a web page displaying list of items ranked high in average value of numerical order number in each items of highly undervalued, high PER and high retained earnings when the item button of “list of items ranked high in average value of order number in each items of highly undervalued, high PER, high retained earnings” is selected.

The step of (c4) registering recommended items management information provides a web page displaying list of items recorded the consecutive daily permissible high price more than two times when the item button “list of items recorded consecutive daily permissible high price” is selected.

The step of (c4) registering recommended items management information provides a web page displaying list of items recorded high advanced rate from the moving mean price line during predetermined period when the item button “list of items having high advanced rate” is selected.

The step of (c4) registering recommended items management information retrieves items recorded price at low for the predetermined period, provides buy information (buy point) of nₜₕ count wherein the buy point is price level advanced at a certain rate from the price at low, and then provides sell information (sell point) of nₜₕ order wherein the sell point is price level advanced at a certain rate from the buy point when the item button “list of items recorded price at low” is selected.

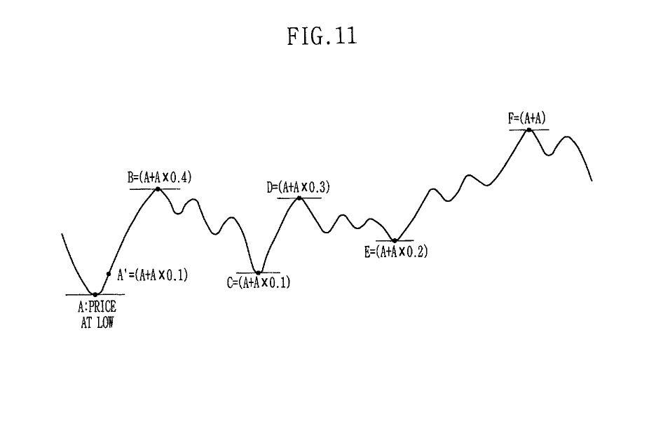

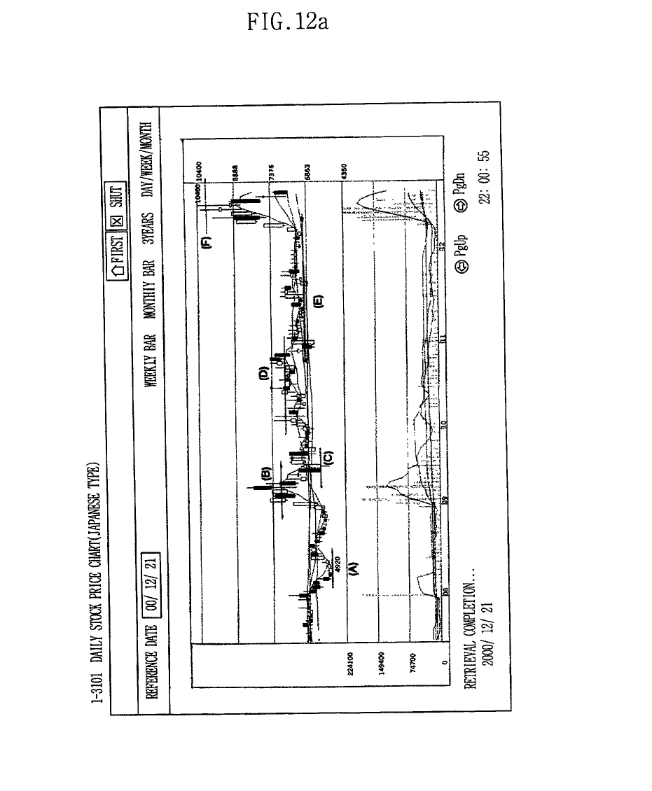

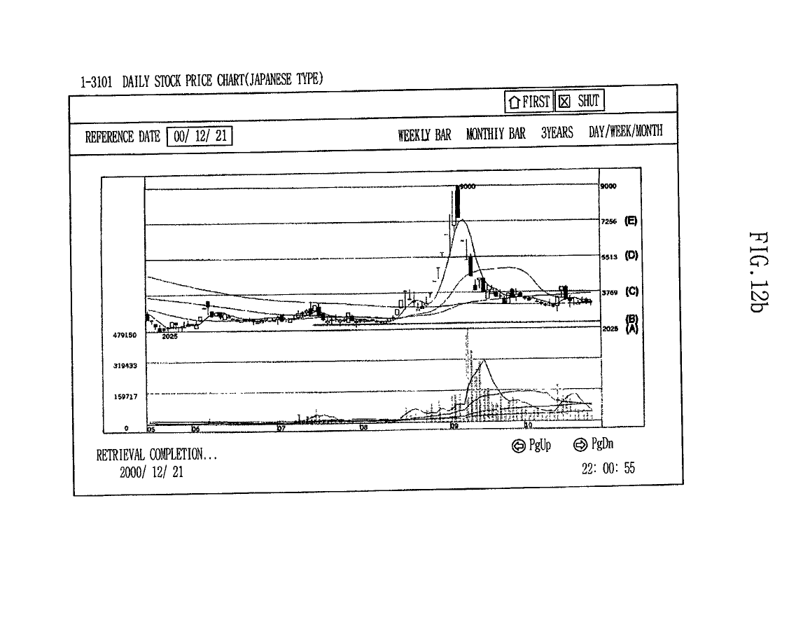

FIG. 11 shows a graph to illustrate buy points and sell points. The buy points (“C”, “E”) are price levels advanced at a certain rate for example 10% or 20% from price at low (“A” in FIG. 11). Each of the sell points (“B”, “D”) is price level advanced at a certain rate for example 20%, 30% from “C” and “E”, respectively. The first sell point “B” is price level advanced at 30% from the first buy point “C”. The second sell point “D” is price level advanced at 20% from “C”. The third sell point “F” is price level advance at 80% from “E”. FIG. 12 is a daily stock price chart showing buy points and sell points.

FIG. 12a is a daily stock price chart of an item containing buy information and sell information as shown in FIG. 11. In case of the item having a chart such as FIG. 11, A is price at low and A′ is first count of buy point advanced at a rate of 10% from A. Further B is first count of sell point advanced at a rate of 40% from A. C is second count of buy point advanced at a rate of 10% from A. D is second count of sell point advanced at a rate of 30% from B. E is third count of buy point advanced at a rate of 20% from A. F is third count of sell point advanced at a rate of 100% from A.

The step of registering recommended items management information provides a web page displaying list of items recorded lowest advanced rate from lowest price during predetermined period which is set by the client by inputting a reference date (year, month, date) when the item button “list of items recorded low advanced rate” is selected.

The step of (c4) registering recommended items management information provides a web page displaying list of items ranked high in percentage of net profit value per share over equity when the item button “list of items having high gain over equity” is selected and semi-annual revenue or average revenue on a year is set.

The step of (c4) registering recommended items management information provides a web page displaying list of items recorded price at new high during a period from a reference date to the present when the item button “list of items recorded price at new high” is selected and the reference date (year, month, and day) is inputted by the client.

The step of (c4) registering recommended items management information provides a web page displaying list of items ranked high in advanced rate of stock price from the lowest price level when the item button “list of items recorded high advanced rate from lowest price level to highest price level” is selected.

The step of (c5) registering basket items buy/sell reservation information provides a web page including a plurality of item buttons, each of which is linked with a corresponding web page to display corresponding information related to the each item, wherein the item buttons includes “buy or sell basket items listed in stock exchange,” “buy or sell basket items registered in KOSDAQ (Korea Securities Dealers Automated Quotations),” “buy or sell basket items listed in stock exchange or registered in KOSDAQ,” “buy or sell basket of appointed items,” “buy or sell basket items classified by grades,” “past buy or sell basket items transaction data of appointed items,” “execution results of past buy or sell basket items transaction data of appointed items,” and “execution results of all buy or sell transactions”.

The step of (c5) registering basket items buy/sell reservation information includes a step of (c511) providing a web page including a plurality of input boxes for receiving appointed items to be basket transacted, buy value amount, client's registered number, client's name, and password, and a step of (c512) estimating buy reserved value amount per each item by equally dividing the buy value amount by number of the appointed items, further estimating reserved buy volumes per each item by dividing the buy value amount per each item by present stock price per share of the each item and registering the buy reserved value amount per each item and the reserved buy volumes as reservation information when one of the item buttons of “buy basket items listed in stock exchange,” “buy basket items registered in KOSDAQ,” “buy basket items listed in stock exchange or registered in KOSDAQ” is selected.

The step of (c5) registering basket items buy/sell reservation information includes a step of (c513) providing a web page including a plurality of input boxes for receiving appointed items to be basket transacted, sell value amount, client's registered number, client's name, and password when one of the item buttons of “sell basket items listed in stock exchange,” “sell basket items registered in KOSDAQ,” “sell basket items listed in stock exchange or registered in KOSDAQ” is selected, and a step of (c514) registering reserved sell bidding price of each item with the present stock price in case sum of present value amount of appointed items is greater than total sell value amount which is inputted into the input box provided in the web page. The web page further includes input boxes for receiving count of times of past basket transactions and stock holding status table including transaction time (year, month, day, time) of the past basket transaction at the count which is inputted into the input box for receiving count of past basket transaction, list of items transacted at the count of past basket transaction, transacted price of each item, transacted volumes of each item, transacted value amount, present value amount.

The step of (c5) registering basket items buy/sell reservation information includes a step of (c515) providing a web page including a plurality of input boxes for receiving count of buy transaction, buy value amount, client's registered number, client's name, and password after the item buttons of “buy basket of appointed items” is selected, and a step of (c516) estimating buy reserved value amount per each item by equally dividing the buy value amount by number of the appointed items, and further estimating reserved buy volumes per each item by dividing the buy value amount per each item by present stock price of the each item and registering the buy reserved value amount per each item and the reserved buy volumes as reservation information.

The step of (c5) registering basket items buy/sell reservation information includes a step of (c517) providing a web page including a plurality of input boxes for receiving count of sell transaction, sell value amount, client's registered number, client's name, and password after the item buttons of “sell basket of appointed items” is selected, and a step of (c518) setting the present value amount of the appointed items as sell value amount of each item or making a list of items to be sell basket transacted when sell value amount is inputted into the input boxes of the web page and sum of present value amount of appointed items is greater than the sell value amount.

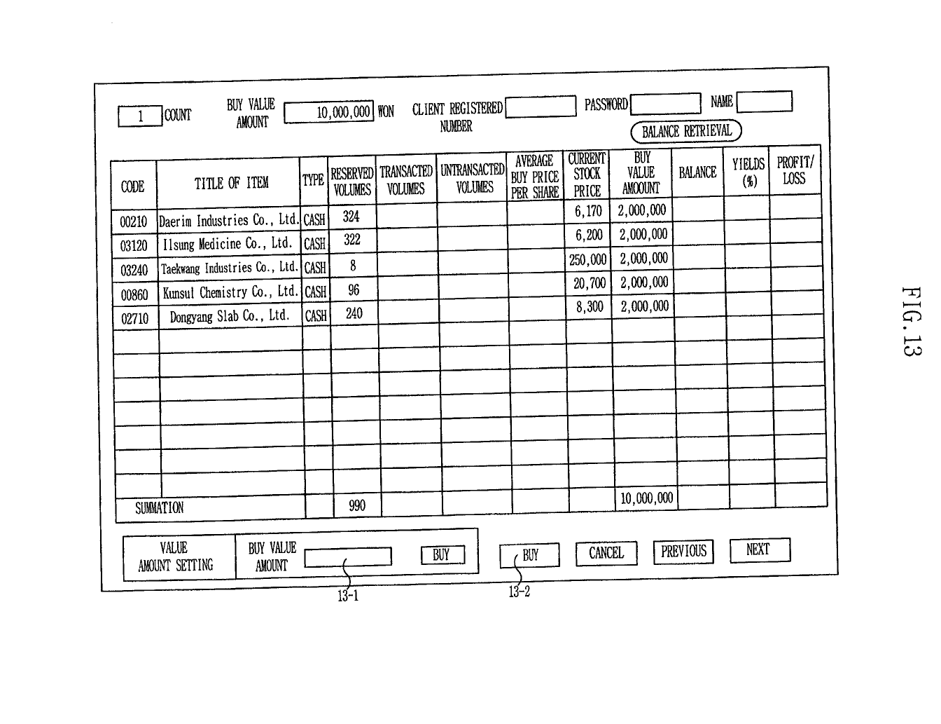

The step of (c5) registering basket items buy/sell reservation information includes a step of (c519) providing a web page including input boxes for receiving investment amount and grade on each share, a button for selecting market type (stock exchange/KOSDAQ/stock exchange or KOSDAQ), and a button for selecting transaction type of buy or sell when the item button “buy/sell basket items classified by grades” is selected, and a step of (c520) dividing investment amount in response to a grade inputted into the input box and registering the divided investment amount of each item as reservation information for buy or sell basket items classified by grades after the investment amount and grade on each items are inputted into the input boxes. FIG. 13 is the web page for registering basket items buy reservation information. In FIG. 13, 10,000,000 won is inputted into the input box for receiving buy value amount and 5 items are listed in the basket, so that divided buy value amount per each item is amount of 2,000,000 won. The amount of 2,000,000 won is further divided by present stock price of each item, so that buy volumes to be transacted are estimated.

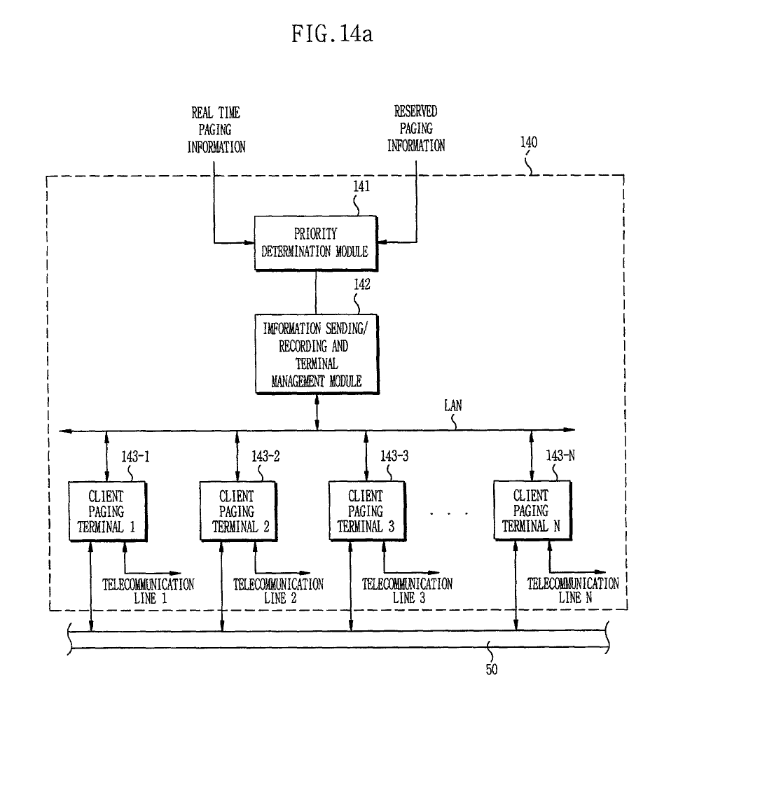

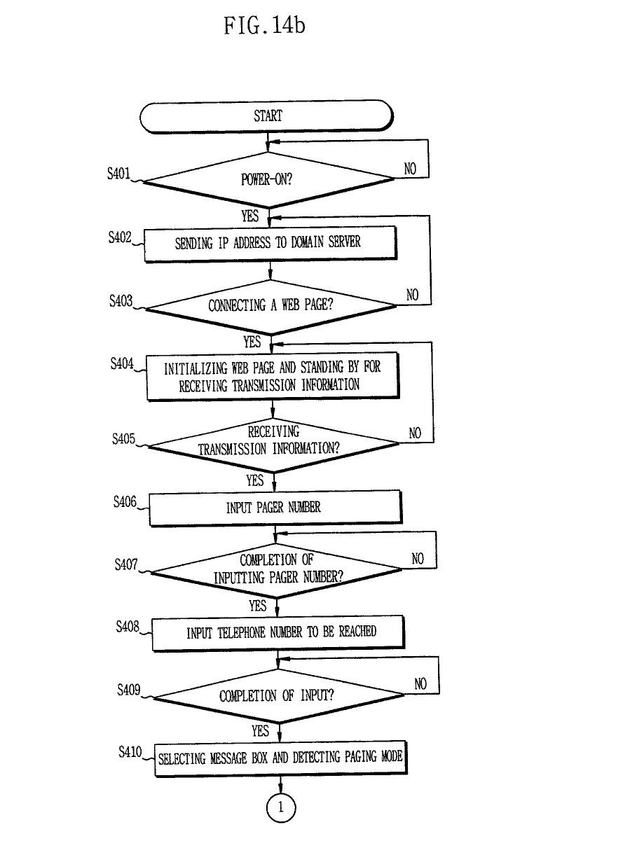

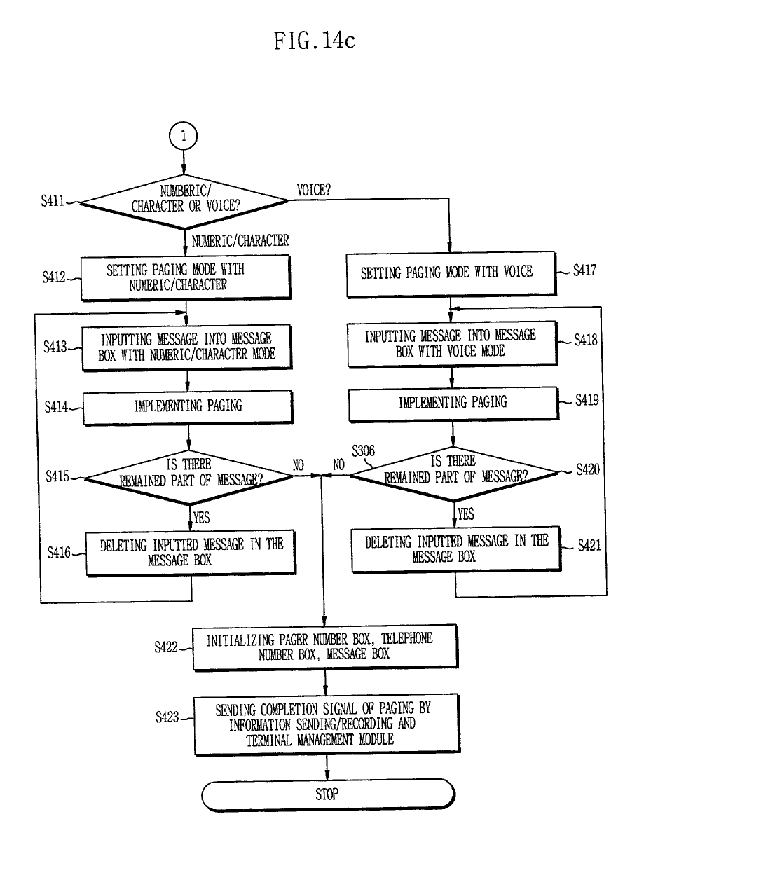

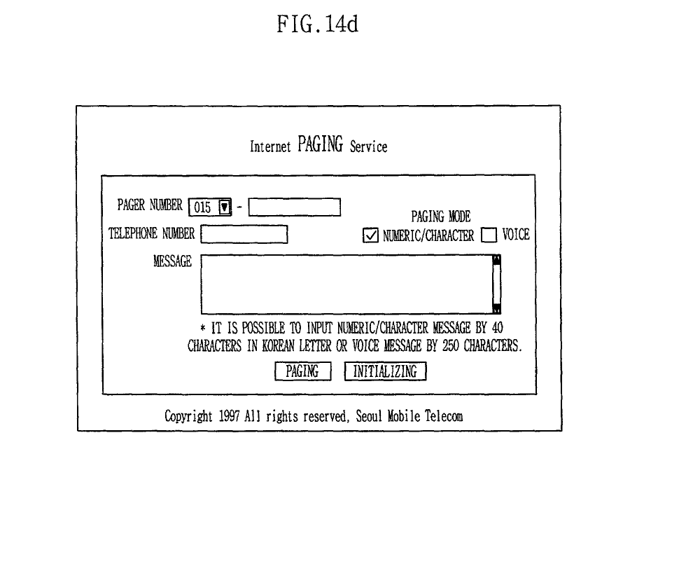

FIG. 14d is a web page for registering client paging information. The web page includes client paging information such as client ID, password, client's registered number, code or title of item to be transacted, reserved voulmes, reserved value amount and a plurality of input boxes for receiving client's pager number, telephone number to be reached (or client's terminal ID or e-mail address), and message. Predetermined paging time can be included.

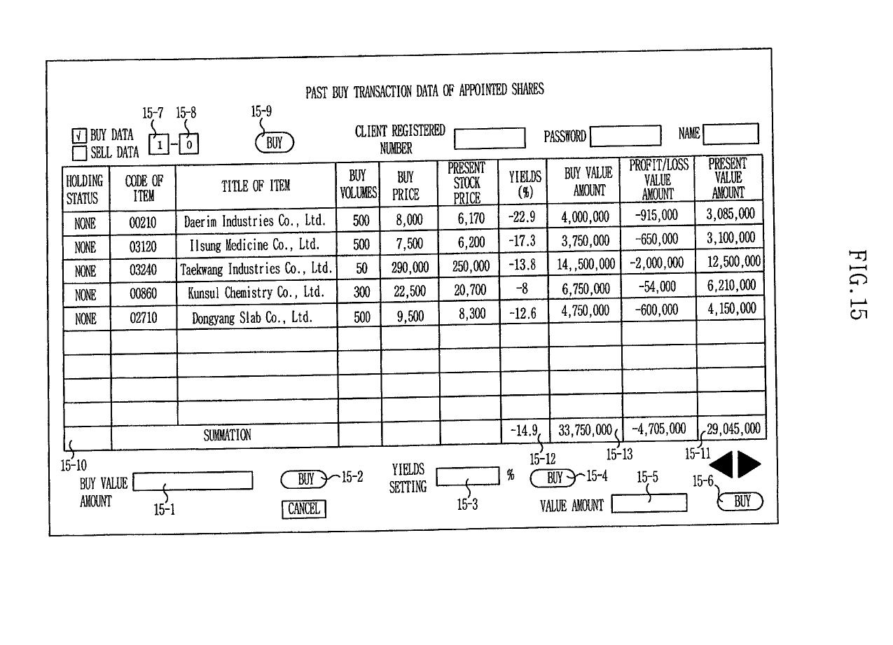

The step of (c5) registering basket items buy/sell reservation information includes a step of (c521) providing a web page of FIG. 15 including input boxes for receiving client's registered number, client's name, password, count of past basket items buy transaction when the item button “past basket items buy transaction data” is selected, and a step of (c522) providing a past basket items buy transaction data table including code, title of item, holding status, volumes, buy bidding price per share of each item, present stock price per share of each item, yield of each item, buy value amount of each item, present value amount of each item, profit or loss value amount of each item, average yield of items listed in the data table, sum of buy value amount of items listed in the data table, sum of profit/loss value amount of items listed in the data table, and sum of present value amount of items listed in the data table, in case count of the past buy transaction is inputted into the input box on the provided web page. The web page further includes input boxes for receiving sum of total buy value amount (investment amount), yield average and/or sum of profit/loss value amount each of which is used as a reference value to generate a condition for executing buy basket items transaction, wherein the step of (c5) registering basket items buy/sell reservation information further includes a step of (C523) selectively registering a condition for executing basket items buy transaction in response to values of total buy value amount, yield average and sum of profit/loss amount which is inputted into the input boxes.

The step of (523) registering a condition for executing basket items buy transaction sets a status which sum of present value amount of items in the data table is less than the total value amount inputted into the input box of the web page to the condition for executing basket items buy transaction.

The step of (523) registering a condition for executing basket items buy transaction sets a status which the yield average of items listed in the data table, the yield average being estimated based on present stock prices, is about the same as the yield average inputted into the input box of the web page to the condition for executing basket items buy transaction.

The step of (523) registering a condition for executing basket items buy transaction sets a status which the sum of profit/loss value amount presented in the data table, the sume of profit/loss value amount being estimated based on present stock prices, is about the same as the sum of profit/loss value amount inputted into the input box of the web page to the condition for executing basket items buy transaction.

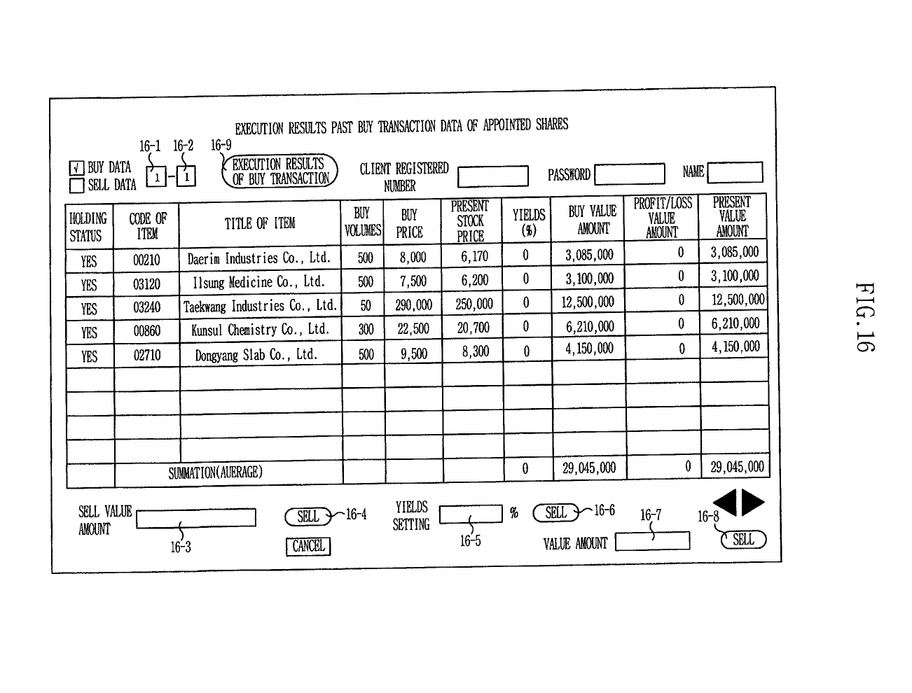

The step of (c5) registering basket items buy/sell reservation information includes a step of (c525) providing a web page including input boxes for receiving client's registered number, client's name, password, count of past basket items sell transaction when the item button “past basket items sell transaction data” is selected, and a step of (c526) providing a past basket items sell transaction data table including codes, titles of items, holding status, volumes, sell bidding price per share of each share, present stock price per share of each item, yield over the present stock price of each item, sell value amount of each item, profit/loss value amount being estimated based on present stock price of each item, average yield being estimated based on present stock price of each item, sum of sell value amount of items in the past basket items sell transaction data talbe, sum of profit/loss value amount of items listed in the past basket items sell transaction data table, and sum of present value amount of items listed in the past basket items sell transaction data table. The web page (shown FIG. 16) further provides a plurality of input boxes for receiving total buy value amount, yield average, and profit/loss value amount which is used as a reference value to generate a condition for executing basket items buy transaction of appointed items, the step of (c5) registering basket items buy/sell reservation information further includes a step of (C527) selectively registering a condition for executing basket items buy transaction in response to values of total buy value amount, yield average and profit/loss value amount inputted into the boxes.

The step of (527) selectively registering a condition for executing basket items buy transaction sets a status which sum of present value amount of items listed in the past basket items sell transaction data table is less than the total buy value amount inputted into the input box of the web page to the condition for executing basket items buy transaction.

The step of (527) registering a condition for executing basket items buy transaction sets a status which the yield average in the past basket items buy transaction data table is about the same as the yield average inputted into the input box of the web page to the condition for executing basket items buy transaction.

The step of (527) registering a condition for executing basket items buy transaction sets a status which the sum of profit/loss value amount in the past basket items buy transaction data table is about the same as the sum of profit/loss value amount inputted into the input box of the web page to the condition for executing basket items buy transaction.

The operation and effect of the present invention will be described below in detail.

The stock exchange supporting system in accordance with the present invention can be loaded into a server of securities firm or investment consultancy firm. Hereinafter the stock exchange supporting system loaded into the server of investment consultancy firm is exemplified.

First, a client registers stock transaction reservation information such as code of an item to be transacted and buy or sell bidding price using the stock exchange supporting system loaded into the server of the investment consultancy firm.

The stock exchange supporting system continuously monitors present stock price of stock market on and/or after that day when the client makes reservation. Thus, when the reserved buy bidding price is higher than the present stock price or the reserved sell bidding price is lower than the present stock price, the system checks the client supporting type (discretionary investment or consultancy information). In case of discretionary investment, the system makes and sends a transaction execution order to the mainframe computer of stock market by way of the server of securities firm. On the other hand, in case of consultancy information, the system provides stock price information including the code and title of item, buy/sell bidding prices and volumes (from first bidding prices to nₜₕ bidding price), present stock price to the client through a client's terminal (including e-mail) or pager at the predetermined paging time so as to have the client make a transaction execution order by himself or herself based on the provided stock price information.

Further, in case that the investment consultancy firm finds recommendable items to be invested, the investment consultancy firm can provide the stock price information with respect to the items to the client using the stock exchange supporting system in accordance with the present invention. By the way, the stock price information or investment information can be provided clients through a pager having the same electronic serial number (ESN) at the same time. Therefore, the investment consultancy can provide stock investment information to as many as the clients or investors at the same time.

However, in case of providing the same investment information to all clients at the same time, there can be sharp changes of stock price of the item that is recommended by the investment consultancy firm. Accordingly, the investment consultancy firm which is willing to provide investment information or stock price information to investors or clients can classify the clients or investors into several groups, and provide the investment information with different recommended items to each group at regular intervals by assigning different ESN of pager to each group.

Further, the stock exchange supporting system in accordance with the present invention can automatically execute buy transaction and sell transaction alternately in turn up to n times. Accordingly, it is very useful for the investors or clients to manage the holding stocks.

To realize the functions described above, the system has investment information register and management module 110, client data base 120, transaction execution module 130 and client paging supporting module 140. The investment information register and management module 110 and the client data base 120 saves or records, retrieves, updates and manages the client information. The transaction execution module 130 automatically makes a transaction execution order when the investment information is registered and the registered buy/sell bidding price is matched with the present stock price after continuously monitoring the present stock price on or after that day when the investment information is registered. That is, the transaction execution module 130 is operated without depending on the time limit such as before closing stock market on the day. The client paging supporting module 140 provides the results of the transaction execution to the client through the e-mail, pager or mobile phone.

The investment information register and management module 110 will be detailed below.

First, the investment information register and management module 110 comprises client information register and management module 111, discretionary investment reservation information management module 112, investment fund management module 113, investment consultancy information management module 114, recommended items management module 115, basket items buy reservation information management module 116 and basket items sell reservation information management module 117.

The client information register and management module 111 registers and manages client personal information by confirming, deleting and modifying the client personal information including client ID, password, social security number, name, address, client's registered number, phone number, client supporting type (discretionary investment or investment consultancy information), electronic serial number (ESN) of pager, mobile identification number (MIN) of pager, membership fees, consulting charges. Further the client information register and management module 111 supports the client to retrieves the client personal information, the client supporting type, list of items and value amount that has been invested by the client.

Further the client information register and management module 111 issues Giro which is needed to collect from the client and supports automatic transfer for collection as well as issues and sends receipt of automatic transfer or Giro to the client. The module 111 further has a function to modify and delete the client who terminated contracts for providing a service such as discretionary investment or investment consultancy information from the client database 120.

The discretionary investment reservation information management module 112 is operated when a button of discretionary investment is selected from a home page (not shown) of the stock exchange supporting system in accordance with the present invention. If the button of the discretionary investment is selected, a web page shown in FIG. 4 is displayed on a client terminal. As shown in FIG. 4, the web page includes a plurality of input boxes for receiving client ID, client's registered number, name, password, social security number. The web page further includes buttons of “register individual investment,” “register group investment,” “retrieve individual investment,” “retrieve group investment,” “display list of clients by a group,” “display list of all clients,” “print list of items invested by an individual,” “print list of items invested by a group,” “register investment fund,” “retrieve investment fund.”

In case of being entered client personal information through the input boxes in FIG. 4 and selected the button “register individual investment”, the discretionary investment reservation information management module 112 provides a new web page shown in FIG. 5. As shown in FIG. 5, the new web page includes a plurality of input boxes for receiving code of item, title of item, client's registered number, client's name. The new web page further includes input boxes for receiving reserved buy bidding prices (maximum price and minimum price) and reserved buy volumes, reserved sell bidding prices (maximum sell bidding price and minimum sell bidding price) and sell volumes at each count of transaction time from first to nₜₕ order. The exemplary web page shown in FIG. 5 shows stock transaction reservation information data from first count to eighth count of transactions.

The new web page further includes display boxes for displaying buy value amount, sell value amount, present value amount, and cash. The new web page further includes input boxes for receiving reference date to set a period for retrieving highest price and lowest price and display boxes for displaying the highest price, the lowest price and present stock price. Further, item buttons of “daily stock price chart”, “monthly stock price chart” and “overhanging supply chart” are employed in the new web page.

After all input boxes are completely filled with corresponding data and a button of “register” is selected, the stock transaction reservation information can be registered. If modifying of the inputted reservation information is needed, the reservation information can be modified by just clicking the corresponding input box to be modified, re-entering new figures and selecting the button of “register”. If the button of “register” is selected, confirmation buttons of “agree” and “cancel” are presented. If the confirmation button of “agree” is selected, the modified reservation information is registered. If not, the modified reservation information is not registered and previous reservation information still remains as an effective data.

On the other hand, a button of “register cancel” which is sown on the bottom line of the web page of in FIG. 5 is selected, registered items will be deleted from the reservation information.

In case of being selected a button of “next” shown in last line of the web page of FIG. 5, input boxes for receiving reservation information of ninth count-sixteenth count of transaction and display boxes are presented.

In case of being entered client personal information through the input boxes in FIG. 4 and selected the button “register group investment”, the discretionary investment reservation information management module 112 provides a new web page of FIG. 6. As shown in FIG. 6, the new web page includes input boxes 6-1 for receiving name of group. If group name is entered into the input box 6-1, ESN, list of clients (names of clients) belong to the group and client's registered numbers are displayed on display boxes 6-2, 6-3, 6-4 respectively.

After entering the group name, buy volumes at each count of buy transaction from first count to fourth count, sell volumes at each count of sell transaction should be entered into input boxes 6-5-6-12. In case that buy volumes and sell volumes at each count of transactions is the same, after buy volume at first count of transaction is entered in the input box 6-5 and a button of “ALL” 6-13 is selected, all of the input boxes 6-6-6-12 for receiving data of buy volumes and sell volumes will be filled with the same figure inputted into the input boxes 6-5. Therefore, there is no need to repeatedly enter same figures in each input boxes 6-6-6-12. If more transactions after fourth count is needed, there will be provided with more input boxes for receiving buy volumes and sell volumes at nₜₕ count of transaction after fourth count of transaction by selecting a button of “Next” 6-15.

After entering the buy volumes and sell volumes at each count of transactions, code of an item to be transacted will be entered into the input box 6-21 titled “code”. In case of entering the code, title of the item corresponding to the code is displayed in a display box 6-22. After that, maximum and minimum buy bidding prices and maximum and minimum sell bidding prices are entered into input boxes 6-26-6-29, respectively for each count of transactions. However, in case that balance of a specified client is shorter than the value amount needed for executing buy transaction, the specified client's reservation information will not be registered. Further, in case that a certain client has volume amount of shares smaller than sell volume amount, the client's reservation information also will not be registered. Further, sum of buy volumes reserved by the clients belong to the group and sum of sell volumes reserved by the clients belong to the group is displayed in display boxes 6-30, 6-31, respectively. Sum of value amount to be invested by the clients who made stock transaction reservation is displayed in display boxes 6-32 and percent of cash—(sum of value amount to be invested−sum of transacted value amount) over the sum of value amount to be invested—is displayed in display box 6-33.

The input box 6-23 is installed in the web page of FIG. 6 for receiving a reference date to set a period for displaying highest price and lowest price during the period on each of display boxes 6-24, 6-25, respectively. Further, the period is needed for providing graphic information. The graphic information are provided when each of button “daily stock price chart,” “overhanging supply,” “monthly stock price chart,” and “psychological line” that are employed in the center portion of the web page of FIG. 6 is selected.

In case of being entered client personal information through the input boxes in FIG. 4 and selected the button “retrieve individual investment”, the discretionary investment reservation information management module 112 provides a new web page of FIG. 7. In case of being selected the button “retrieve group investment”, the discretionary investment reservation information management module 112 provides a new web page of FIG. 8. In the web page of FIG. 8, if the button of “retrieve execution results of all transaction” is selected, all executed transaction data will be retrieved. Further, in case that the button of “display list of clients by a group” is selected, a new web page of FIG. 9 is provided.

Further, if the button of “print list of items invested by individual” is selected, the discretionary investment reservation information management module 112 prints a table showing list of reservation information of each individual, list of transacted items, investment amount, cash, transaction history, reserved transaction date of each item, transacted date of each item, yield of each item.

Further, if the button of “print list of items invested by a group” is selected, the discretionary investment reservation information management module 112 prints a table showing list of all items registered and transacted in order of transacted date.

Further, if the button of “display list of all clients” is selected, the discretionary investment reservation information management module 112 supports the clients to selectively print or display list of all clients, list of all groups, list of clients by each group.

The investment fund management module 113 is operated by an investment trust company directly to invest on stocks.

The investment fund management module 113 is operated when a button of “investment fund management” is selected from the home page (not shown) of the stock exchange supporting system in accordance with the present invention. If the button of the “investment fund management” is selected, a web page shown in FIG. 10 is displayed on a client terminal connected with the stock exchange supporting system. The web page of FIG. 10 receives name of fund from input box 10-1 and displays total investment amount of the fund on the display box 10-2. Therefore, buy reservation with value amount greater than the total investment amount will be protected. Then, code of an item to be invested by the fund is inputted into an input box 10-3 and title of the corresponding code is display in the display box 10-4. Next, reserved buy bidding price (maximum price, minimum price) and reserved buy volumes at first count of buy transaction, reserved sell bidding price (maximum price, minimum price) and reserved sell volumes at first count of sell transaction, reserved buy bidding price (maximum price, minimum price) and reserved buy volumes at second count of buy transaction, reserved sell bidding price (maximum price, minimum price) and volumes at second count of sell transaction will be inputted into corresponding input boxes. By selecting a button of “next” 10-5, buy reservation transaction data from third count to nₜₕ count and sell reserved transaction data from third count to nₜₕ count can be inputted. Further the web page of FIG. 10 includes a printing list bar 10-6 to selectively print client's list invested on the fund, daily transacted items through the fund, or list of items at each count of transaction time. By clicking a print button 10-7 after selecting the printing list bar 10-6, the clients invested on the fund can print what they need. Further, if the button of “yield estimation” 10-8 is selected, a web page including display boxes for displaying yield information (i.e. percent of profit value over investment amount) and input boxes for receiving code or title of item is shown. In case that the code or title of the item is inputted, investment amount, yield, share holding status, and present value amount will be provided.

The discretionary investment reservation information management module 112 is operated by the investment consultancy firm or securities firm only in case that the client leave stock transaction to the discretion of them.

Investment consultancy firm or securities firm can operate the investment consultancy information management module to provide clients with the consultancy information such as buy or sell recommendation, buy bidding price, sell bidding price or execute stock exchange transaction for the clients. The investment consultancy firm or securities firm can manage the consultancy information by way of following two kinds of method.

First, client directly selects and registers list of items that the client wishes to invest on or to be informed of present market price into the stock exchange supporting system loaded in the server of investment consultancy firm or securities firm. Thus, the client will be informed of present market prices with respect to the registered items through the client terminal such as e-mail or pager by the stock exchange supporting system, and makes an order to execute the transaction of the items.

Second, the investment consultancy firm selects recommendable items and registers those into the stock exchange supporting system and clients will be informed of what the investment consultancy firm is willing to provide the clients through pagers having the same ESN.

According to the first method, the reservation information will be registered using the web page of FIG. 7. After being registered the reservation information, present stock prices of the registered items are lower than minimum reserved buy bidding price of the first count of transaction, detailed information such as code and title of item, real time transaction price, buy recommend, minimum buy bidding price, maximum buy bidding price will be provided to the clients. The client informed of the detailed information can make a transaction execution order through the securities firm in which the client has an account, or the investment consultancy firm can execute the order for the clients.

The second method is applied to the investment consultancy firm which is protected from performing direct transact execution. The client has to open an account on securities firm to execute stock transaction and the investment consultancy firm can receive the client's account data from securities firm and manage it. The client informed of the consultancy information from the investment consultancy firm can directly make an order through the securities firm in which the account is opened by telephone, internet or terminal connected to a computer of the securities firm.

In case that a client made reservation of sell transaction with respect to the items that have been bought by the first count of reserved buy transaction, after the first count of reserved buy transaction is executed in accordance with the two kinds of method described above, the clients who made reservation for sell transaction will be informed of real time stock price information when the present stock price is higher than maximum reserved sell bidding price. If the client wishes to execute the sell transaction after receiving the stock price information, the stock exchange supporting system executes the sell transaction by making sell order to the stock market. In case the sell transaction is not executed due to stock market closing or sharp fall of stock price even if the client made stock transaction order, the sell reservation at the first count of transaction will be effected on and after next stock market opening day. That is, the sell reservation information will be continuously effected until the all stocks registered to be sell transacted are sold.

The investment information register and management module 110 includes a sub-module for managing the records of investment information provided to the clients and records of invest information used for the investment consultancy firm. For example, the records includes date and time when the investment information was provided to clients, title of item on which consultancy information is provided to the clients, contents of information provided to the clients, present yield, items on which the firm invested.

The recommended items management module 115 is operated when a button of “recommended items” is selected from the home page (not shown) of the stock exchange supporting system in accordance with the present invention. Then, the system provides a web page including item buttons of “list of items highly undervalued,” “list of items ranked high in PER,” “list of items having high retained earnings,” “list of items ranked high in average value of numerical order in each items of highly undervalued, high PER, high retained earnings,” “list of items recorded consecutive daily permissible high price,” “list of items having high advanced rate,” “list of items recorded lowest price,” “list of items recorded low advanced rate,” “list of items ranked high in gain over equity,” “list of items recorded price at new high,” “list of items recorded high advanced rate between lowest price and highest price,” “reference line on the graphic charts.” Accordingly, a button from above is selected, corresponding web page linked with each of the item button is provided.

In case of selecting the button of “list of items highly undervalued”, the recommended items management module 115 displays list of items ranked high in highly undervalued by estimating average PBR (price book value ratio) for several years.

In case of selecting the item button of “list of items ranked high in PER”, the recommended items management module 115 estimates percent of net earnings per share (EPS) average for recent several years (for example, 3 years) over present stock price, and displays the items having high percent of net earnings per share over present stock price.

In case of selecting the item button of “list of items having high retained earnings”, the recommended items management module 115 estimates percent of retained earnings over total asset value (i.e. present stock price×capital/book value) displays the list of items having high percent of retained earnings over total asset value. The retained earnings over total asset value indicates stability of the company.

In case of selecting the button of “list of items ranked high in average value of numerical order in each items of highly undervalued, high PER, high retained earnings”, the recommended items management module 115 estimates average value of numerical ranking order in each items of highly undervalued, high PER and high retained earnings and displays the list of items having the high average value.

In case of selecting the button of “list of items recorded consecutive daily permissible high price”, the recommended items management module 115 displays the list of items recorded daily permissible high price consecutively two or three times. In case of items having good news or recorded sharp falling price for short term usually falls down after recording two or three times of daily permissible high price. Accordingly, the clients who hold that kind of items can sell the items on proper time by retrieving the list of items recorded consecutive daily permissible high price.

In case of selecting the button of “list of items having high advanced rate”, the recommended items management module 115 displays the list of items highly advanced from the 5-day moving mean price line. Accordingly, the clients can decide the sell point of the items recorded the high advanced rate if the clients hold the same items.

In case of selecting the button of “list of items recorded price at low”, the recommended items management module 115 displays the list of items recorded price at low during the predetermined period and has a rule presented FIG. 11. FIG. 11 provides information of sell points and buy points of an item. FIG. 12a is a daily stock price chart of an item containing the rule of FIG. 11. In case of the item having a chart such as FIG. 11, A is price at low and A′ is first count of a buy point wherein the buy point is a price level advanced at a rate of 10% from A. Further B is first count of a sell point wherein the sell point is a price level advanced at a rate of 40% from A. C is second count of a buy point wherein the buy point is a price level advanced at a rate of 10% from A. D is second count of sell point wherein the sell point is a price level advanced at a rate of 30% from B. E is third count of buy point wherein the buy point E is a price level advanced at a rate of 20% from A. F is third count of sell point wherein the sell point F is a price level advanced at a rate of 100% from A. Accordingly, if an item having a chart such as FIG. 11 is found, the recommended items management module 115 provides the information (code of item, title of item, advanced rate from price at low (i.e. A), buy point or sell point, buy or sell recommendation, present stock price) with respect to the item at every buy or sell point of B, C, D, E, F to consultant in investment consultancy firm through the client terminal or pager.

In case of selecting the button of “list of items recorded low advanced rate”, the recommended items management module 115 receives a reference date and displays list of items recorded low advanced rate from lowest price during period from the reference date to the present. The list of items recorded low advanced rate can be provided by each stock market such as stock exchange and KOSADQ.

In case of selecting the button of “list of items ranked high in gain over equity”, the recommended items management module 115 provides a web page having input box for receiving reference year and item buttons of semi-annual revenue, annual revenue, average. If the reference year is inputted into the input box and one of the item buttons is selected, the module 115 estimates gain over equity and displays list of items having high gain over equity. In case of selecting the button of “list of items recorded price at new high”, the recommended items management module 115 provides a list of items recorded price at new high during predetermined period. Therefore, the clients can consider sell transaction of items belong to the item list.

In case of selecting the button of “list of items recorded high advanced rate between highest price and lowest price”, the recommended items management module 115 displays the list of items recorded high advanced rate from the lowest price to select the items to be sold.

In case of selecting the button of “reference line on graphic chart”, the recommended items management module 115 provides a web page (not shown) including input boxes for receiving code and title of an item, reference date, reference points (A, B, C, D, E) to edit the daily chart such as FIG. 12b. If all input boxes are filled with corresponding values, the module 115 provides a daily chart such as FIG. 12 with reference lines A, B, C, D, and E during between the reference date and present. Therefore, when price of the appointed item comes to each reference line, the module 115 provides stock price information (code and time of the item, present stock price, stock price at reference line) to the consultant in the investment consultancy firm through a pager. For example, an item recorded price A and present stock price of the item is falling down below the reference line B, the module 115 provide the stock price information to the consultant to buy the items. On the other hand, when present stock price of the item becomes higher than reference line E, the module 115 also provides the stock price information to the consultant to sell the items.

The basket items buy reservation information module 116 and the basket items sell reservation information module 117 provides a web page including the following item buttons to support basket items transaction: “buy basket items listed stock exchange,” “sell basket items listed stock exchange,” “buy basket items registered in KOSDAQ”, “sell basket items registered in KOSDAQ,” “buy basket items listed or registered in all stock markets,” “sell basket items listed or registered in all stock markets,” “buy basket of appointed items,” “sell basket of appointed items,” “buy basket items classified by grades,” “sell basket items classified by grades,” “past buy transaction data of basket of appointed items,” “past sell transaction of basket of appointed items,” “execution results of pas buy transaction data of appointed items,” “execution results of past sell transaction data of appointed items,” “execution results of all buy transactions,” “execution results of all sell transactions.”

The basket items buy reservation information module 116 and the basket items sell reservation module 117 is useful to buy or sell a plurality of shares in seconds especially when the sharp changes of the stock market is prospected because of happening an impactive event or fundamental changes in circumstances in stock market.

In case of selecting the item button of “buy basket items listed in stock exchange”, the basket items reservation buy information management module 116 provides a web page (not shown) including input boxes for receiving count of buy transaction, buy value amount, client's registered number, name of the client, password. If the buy value amount is inputted into the corresponding input box and a button of “buy” is selected, basket items buy transaction is executed. At this time, buy value amount of each item is determined by dividing total buy value amount by number of items listed in stock exchange. Further, volumes of each item is determined by dividing buy value amount of each item by present stock price of the each item. The basket items buy transaction in accordance with the basket items buy reservation information management module 116 is carried out in a real time. Further in case that the list of items to be basket transacted, volumes, buy value amount are set and present value amount is smaller than the buy value amount, the basket items buy reservation information management module 116 can automatically execute the basket items buy transaction. At this time, during executing basket items buy transaction, if present stock price is raised, the basket items buy reservation information management module 116 can automatically carry out the basket items buy transaction by adjusting buy volumes to be less than reserved buy volumes with respect to a part of shares listed in the basket. In case that the basket items buy transaction is automatically carried out, the basket items buy reservation information management module 116 provides the execution results of the transaction to the clients.

Therefore, the basket items buy reservation information management module 116 supports both of automatic and manual transactions.

In case of selecting the button of “sell basket items listed in stock exchange”, the basket items sell reservation information management module 117 provides a web page (not shown) including input boxes for receiving count of sell transaction, sell value amount, client's registered number, name of the client, password. If the sell value amount is inputted into the corresponding input box and a button of “sell” is selected, basket items sell transaction is executed. At this time, in case basket items sell transaction is performed by method of setting sell value amount, problems are followed. That is, if the sell value amount is inputted into the input box and a button of “sell” is selected, the items being traded at present price higher than estimated price being estimated by the basket items sell reservation information management module 117 are sell transacted but a part of items having present price lower than the estimated price can not be sold when present market price is sharply changed. Accordingly, sell transaction of part of items listed in the same basket will be delayed by the present stock prices of remained items are raised.

Accordingly, the basket items sell reservation information management module 117 provides other process for basket items sell transaction other than process of setting sell value amount. That is, in case of not being inputted sell value amount and selected a button of “sell”, all shares listed in the basket will be automatically sold out at market price regardless of present stock price.

Further, in case of inputting the count of past buy transaction into the input box, the basket items sell reservation information management module 117 provides a table including transaction time (yy,mm,dd,time), list of items, buy bidding price of each item, volumes of each items.

In case of selecting a button of “stock holding status”, the module 117 provides a table including list of holding items, count of buy transaction of each item, buy value amount of each item, present value amount of each item, and transaction time of each item, so that the clients can decide items to be sold. That is, if sell value amount is inputted and “sell” button is selected, all items listed in the basket are sold when the inputted sell value amount become greater than present value amount. Also, if sell value amount is not inputted and “sell” confirmation button is selected, all shares listed in the basket sold out at present market price.

In case of selecting the button of “buy basket items registered in KOSDAQ”, an operation process of the buy basket items registered in KOSDAQ is the same as the operation process of “buy basket items listed in stock exchange”. In case of selecting the button “sell basket items registered in KOSDAQ”, the operation of the sell basket items registered in KOSDAQ is the same as the operation process of “sell basket items listed in stock exchange”. Accordingly, the detailed operation of buy or sell basket items registered in KOSDAQ will not be explained.

Next, operation process of “buy basket items listed in stock exchange or registered in KOSDAQ” and “sell basket items listed in stock exchange or registered in KOSDAQ” is the same as the operation process of the “buy basket items listed in stock exchange” and “sell basket items listed in stock exchange”, respectively. Accordingly, the detailed operation will not be duplicated.

Next, in case of selecting the button “buy basket of appointed items”, the basket items buy reservation information management module 116 provides a web page shown in FIG. 13. In FIG. 13, after inputting investment value amount into input box 13-1 and selecting “buy” confirmation button 13-2, the appointed items in a basket as shown in FIG. 13 will be bought by executing basket items buy transaction with uniform value amount.

Next, in case of selecting the button “sell basket of appointed items”, the basket items sell reservation information management module 117 provides a web page (not shown). The format of the web page which is provided by the basket items sell reservation information management module 117 is the same with the FIG. 13 but title of input box “buy value amount” and title of a button of “buy” confirmation is changed to “sell value amount” and “sell”, respectively.

In case of inputting count of basket items sell transaction and sell value amount in the corresponding input boxes respectively and selecting the button of “sell” confirmation, the appointed items at the nₜₕ count of basket items sell transaction will be sold by way of the operation process of setting sell value amount. On the other hand, in case that sell value amount is not inputted and the button of “sell” confirmation is selected, all appointed items in the basket is automatically sold out at market price regardless of present stock price of each item.

In case of selecting the item button of “buy basket items classified by grades” or “sell basket items classified by grades”, the basket items buy reservation information management module 116 and the basket items sell reservation information management module 117 allocates different investment amount to each item by its grades. For example, in case of classifying all items listed in stock exchange or registered in KOSDAQ into four (4) grades such as A, B, C, D, the modules 116 and 117 can allocate 50% of investment amount to items on grade A, 30% of investment amount to items on grade B, 20% of investment amount to items on grade C. By allocating the investment amount at different rate based on grades, investment risk and yield will be traded off. Further, operation process of buy and sell transaction is the same with the other operation process explained above. Accordingly, the operation processes of buy and basket items sell transaction of items classified by grades will not be detailed.

In case of selecting the button of “past buy transaction data of appointed items”, the basket items buy reservation information management module 116 provides a web page shown in FIG. 15. The module 116 provides three types of operation process of basket items buy transaction in case of selecting the item of “past buy transaction data of basket of appointed items”. The first type of operation process is running when investment amount is inputted into an input box 15-1 and a button “buy” 15-2 is selected. The second type of operation process is running when target yield is inputted into input box 15-3 and a button “buy” 15-4 is selected. The third type of operation process is running when target profit/loss value amount is inputted into input box 15-5 and a button “buy” 15-6 is selected.

In case of first type of operation process, if investment amount is inputted into the input box 15-1, the module 116 compares the investment amount with sum of present value amount of appointed items. Thus, if the investment amount is equal to or greater than the sum of present value amount, the basket items buy transaction of appointed items is automatically executed at market prices. At this time, after being executed basket items buy transaction, sum of real buy value amount can be different from the investment amount because there is time difference between transaction execution order time and execution time. After being provided the web page shown FIG. 15, if item box of “buy data” is checked, count of past basket items buy transaction is inputted into the input boxes 15-7, and a button “buy” 15-9 is selected, past basket items buy transaction data is displayed.

As for the count of past basket items buy transaction in FIG. 15, for example, the count of past basket items buy transaction is presented as a format of k−m (k=1, m=0). In FIG. 15, sotck holding status column 15-10 indicates “none” because the data shown in FIG. 15 is past basket items buy transaction data and all shares listed in FIG. 15 was sold out. FIG. 15 is only used for making a reservation of basket items buy transaction by referring to past basket items buy transaction. For example, by inputting investment amount into the input box 15-1 with figures (for example \29,045,000 in FIG. 5) which is same to sum of present value amount 15-11 of items listed in the past basket items transaction data of 1-0 count, new count of basket items buy transaction will be executed in accordance with the first type of operation process. In case of inputting investment amount different from the figures of the sum of present value amount, the basket items buy transaction is executed only when the inputted investment amount is greater than the figures of sum of present value amount. As for second type of operation process of basket items buy transaction, if a figure of past yield 15-12 (−14.9% in FIG. 5) is inputted into the input box 15-3 and the button 15-4 is selected, the new basket items buy transaction is automatically executed at market price, so that the new basket items buy transaction will be resulted in FIG. 16. As for third type of operation process of basket items buy transaction, if a FIG. 15-13 (\−4,705,000 in FIG. 15) sum of profit/loss value amount is inputted into the input box 15-5 and the button “buy” 15-6 is selected, the new basket items buy transaction will be automatically executed.

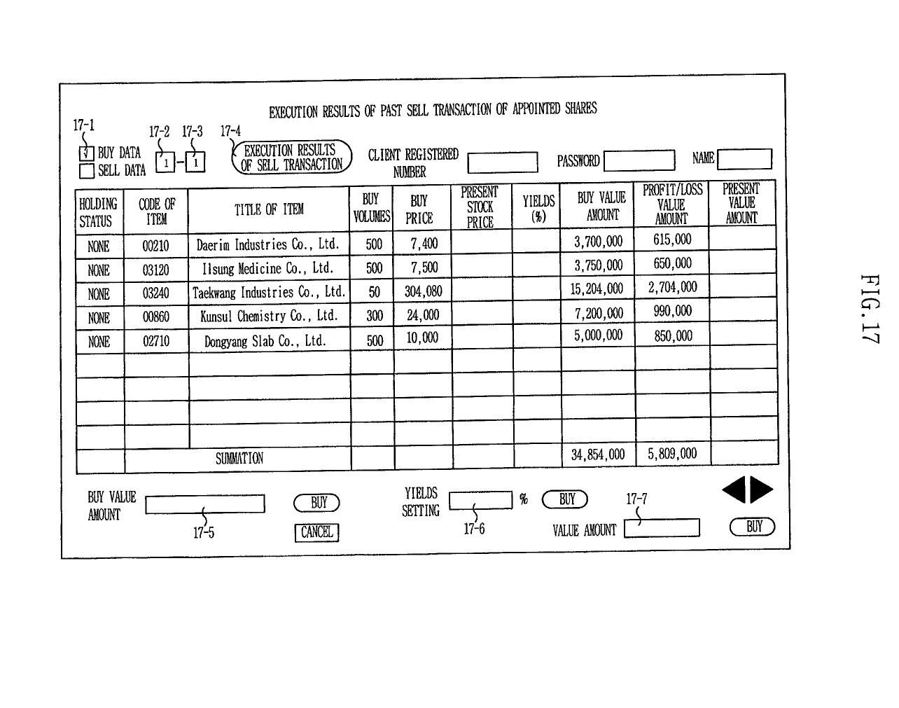

In case of selecting the item button of “execution results of past basket items buy transaction data of appointed items”, the module 116 provides a web page as shown in FIG. 16. If the count {k−(m+1)} (k=1, m=0) of basket items buy transaction is inputted into input boxes 16-1, 16-2, and a button “buy execution results” 16-9 is selected, the execution results of the basket items buy transaction at 1−1 order can be confirmed. The figures shown in FIG. 16 are exemplified, so that the figures of FIG. 16 are the same with the figures shown in FIG. 15. However, in real transaction, the figures shown in FIG. 15 which is the web page for making a reservation of basket items buy transaction will be slightly different from figures shown in FIG. 16 which shows the execution results of the basket items buy transaction due to the time difference between the reservation and execution of the transaction. FIG. 15 is a reserved data of past buy basket items transaction at 1−0 count and FIG. 16 is an execution result data of past buy basket items transaction at 1−1 count in accordance with the reserved data of FIG. 15. Further the web page of FIG. 16 shows the execution results of past basket items buy transaction as well as is used for making a reservation of basket items sell transaction at new count. That is, in case of inputting target sell value amount into input box 16-3 and selecting a button “sell” 16-4, inputting target yield into the input box 16-5 and selecting a button “sell” 16-6, or inputting target profit/loss value amount into input box 16-7 and selecting a button “sell” 16-8, all items listed in FIG. 16 can be sold in accordance with the operation process of basket items sell transaction. FIG. 17 shows the execution results of basket items sell transaction that is reserved by using FIG. 16 wherein the reserved transaction is made by setting target yield at 20% in FIG. 16.

In case of selecting the item button of “execution results of past basket items sell transaction data of appointed items”, the web page of FIG. 17 is provided.

In FIG. 17, in case count of past basket items sell transaction is inputted into input boxes 17-2, 17-3, and a button “sell execution results” 17-4 is selected, the execution results of basket items sell transaction will be confirmed.

Further, also new count (for example, {K−<m+2>}) of basket items buy transaction can be made by inputting investment amount into an input box 17-5, target yield into an input box 17-6, or target profit/loss value amount into an input box 17-7 in the web page of FIG. 17. The execution results of the basket items buy transaction at count {K−<m+2>} can be confirmed by using the web page of FIG. 16 by inputting the count {K−<m+2>} into the input boxes 16-1, 16-2 and selecting the button “buy execution results” 16-9.

As described above, by using the web pages of FIG. 16 and FIG. 17, reservation of basket items buy transactions and basket items sell transactions can be alternately made and the execution results can be confirmed continuously.

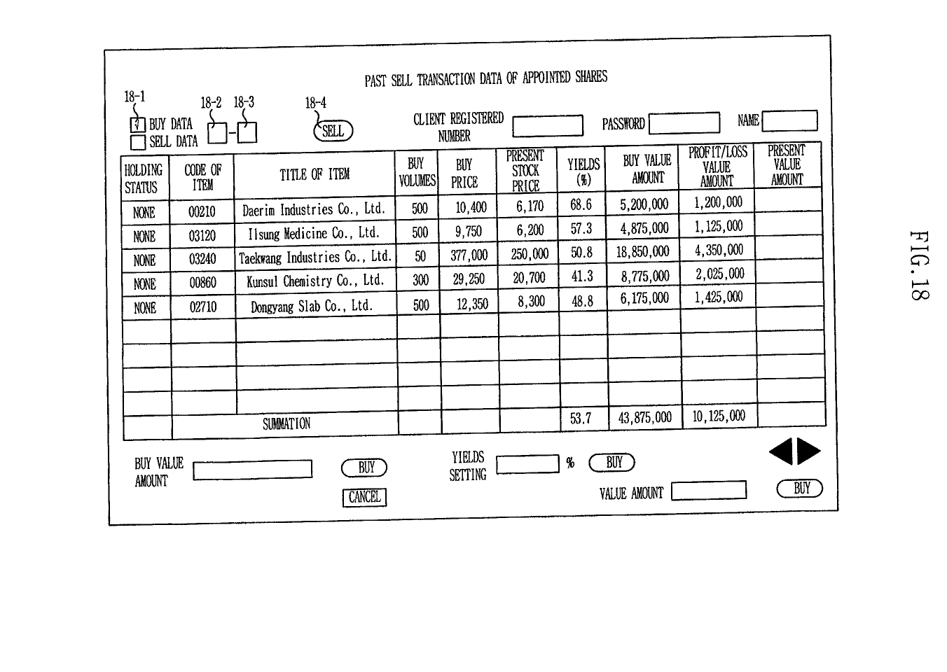

In case of selecting the item button “past basket items sell transaction data of appointed items”, the module 117 provides a web page as shown in FIG. 18. In FIG. 18, in case of selecting the item button “sell data” 18-1, inputting a certain count (k−m) of past basket items sell transaction into input boxes 18-2, 18-3, and selecting a button “sell” 18-4, reservation data of basket items sell transaction at count (k−m) is displayed. The FIG. 18 is resulted from the basket items sell transaction which is made by using FIG. 13 by setting total sell value amount or artificially executing basket items sell transaction without setting total sell value amount. Accordingly, the past basket items sell transaction data can be a reference to make a reservation of basket items buy transaction at new count. Further, in case of making a reservation of basket items buy transaction at new count using FIG. 18, the execution results of the basket items buy transaction at the new count will be confirmed by selecting the item button of “execution results of past basket items buy transaction data of appointed items”, inputting the count k−m of basket items buy transaction into the input boxes in FIG. 16 and selecting the button “buy execution results” 16-9 in FIG. 16. After confirming the execution results of basket items buy transaction at k−m count, in the same web page of FIG. 16, basket items sell transaction reservation at new count {k−(m+1)} can be made by inputting sell value amount, target yield or profit/loss value amount into the corresponding input boxes 16-3, 16-5, 16-7 in FIG. 16. Further, the execution results of basket items sell transaction at count {k−(m+1)} will be confirmed in FIG. 17 by inputting count number {k−(m+2)} into the input boxes 17-2, 17-3 and selecting the button “sell execution results” 17-4. That is, by using the past basket buy/sell transaction data, new basket buy/sell transaction of appointed items which are the same with the items appointed in the past count of basket buy/sell transaction will be made repeatedly.

Next, in case of selecting “execution results of all buy transaction”, a web page including item buttons of “execution results of all shares listed in stock exchange,” “execution results of all shares registered in KOSDAQ,” “execution results of all shares listed or registered in all stockmarket,” “execution results of appointed items,” and “execution results of shares classified by grades” is provided. The clients can confirm the execution results of all type of basket items buy transaction by selecting one of the item buttons above. In case of selecting one item button, a new web page including an input box for receiving count of transaction will be provided. By inputting the count into the input box, the clients can confirm the execution results of basket items buy transaction of a specified count.

Finally, in case of selecting the item button of “execution results of all sell transaction”, a web page including item buttons of “execution results of all shares listed in stock exchange,” “execution results of all shares registered in KOSDAQ,” “execution results of all shares listed or registered in all stock market,” “execution results of appointed items,” and “execution results of shares classified by grades” is provided. The client scan confirm the execution results of all types of basket items sell transactions by selecting one of the item buttons above. In case of selecting one item button, a new web page including an input box for receiving count of transaction will be provided. By inputting the count into the input box, the clients can confirm the execution results of basket items sell transaction of a specified order.

Next, the operation of the stock exchange supporting system is loaded and operated in the client terminal which is connected to the server of securities firm or investment consultancy firm through the communication network system will be explained. As for software configuration, the stock exchange supporting system is comprised of the client terminal contains an investment information register and management module, transaction execution module and client paging supporting module. As for physical configuration, the stock exchange supporting system is comprised of display unit, data processing unit and interface unit which includes communication network connecting the data processing unit to the server of securities firm or investment consultancy firm.

The stock exchange supporting system provides a web page for receiving client's ID and password to the display unit. After receiving the client's ID and password, the system further provides a web page including item buttons of “buy reservation,” “sell reservation,” “buy/sell register confirmation,” “execution results confirmation,” “retrieving balance,” “providing investment information,” “investment yields,” “basket sell,” “basket buy,” “other information” to the display unit. The other information includes daily stock price chart, present stock price, overhanging supply graph, monthly stock price chart, and psychological line graph.

The operation of the stock exchange supporting system loaded in the client terminal as follows: In case of selecting the item button of “buy reservation” or “sell reservation”, the investment information register and management module 110 provides a web page as shown in FIG. 7. The module 110 receives the reservation information including code of item to be transacted, title of item, minimum buy bidding price at first count of buy transaction, maximum buy bidding price at first count of buy transaction, buy volumes, minimum sell bidding price at first count of sell transaction, maximum sell bidding price at first count of sell transaction, and sell volumes through the web page of FIG. 7, and registers the reservation information.

Further the transaction execution module continuously monitors present stock prices of the items to be transacted and makes a stock transaction execution order to the mainframe computer of stock market.

Further, if reservation information of second count of buy transaction is received, the module 110 registers the reservation information. However, the transaction execution module automatically executes the buy transaction of second count only when the first count of sell transaction is completed. Further, the sell transaction of the second count also can be executed when the second count of buy transaction is completed.

The third or nₜₕ count of buy/sell transactions can be consecutively executed by registering the reservation information after selecting a button “next” in FIG. 7. However, just one time of buy/sell transaction is required, it can be accomplished by registering reservation information of buy/sell transaction of the first count and selecting a button “register”. Further, if registered item is need to be deleted from the reservation information, it is possible to delete the item by selecting a button “delete” after inputting code and title of the item into the input boxes 7-1, 7-2.

In case of selecting the item button of “buy/sell register confirmation”, the investment information register and management module 110 provides a web page shown in FIG. 7. When the item button of “buy/sell register confirmation” is selected, the registered items to be transacted is displayed in order of registered time and also the execution results of the transaction are displayed in a format of FIG. 7. Other operation is the same with the operation of buy reservation and sell reservation.

In case of selecting the item button of “execution results confirmation”, the investment information register and management module 110 provides a web page similar to FIG. 8. The web page is little different from FIG. 8, for example, the caption “group” and the input box 18-2 are changed to “client's registered number” and the input box for receiving the client's registered number, respectively. The web page further provides an input box (not shown) for receiving client's name. The execution results of the transactions are displayed in display boxes 8-3 through 8-6. The FIG. 8 shows the execution results of first and second count of buy/sell transactions. By selecting icons of column “next”, from third count to nₜₕ count of buy/sell transactions execution results can be confirmed. If reference date is inputted into input boxes 8-8, the module displays daily transaction execution results from the reference date to the present. If a button “retrieve all transaction execution results” 8-9 is selected, all registered reservation information and the execution results are displayed in order of registered time. Further, a new button of “execution completed” (not shown) can be added to the web page. Thus, in case of selecting the button “execution completed”, only data which transaction was executed will be retrieved in chronological order.

In case of selecting the item button of “retrieve balance”, the investment information register and management module 110 provides a table indicating data of stock holding status and investment amount et al.

In case of selecting the item button of “provide investment information”, the client paging supporting module retrieves the buy/sell reservation information from FIG. 7 and provides the investment information such as code, title of item, minimum and maximum reserved price, present stock price, reserved volumes through the client's pager at predetermined paging time, when the buy/sell reservation information is registered and present stock prices meet with the reserved condition of buy/sell transaction, so that the client can receive the stock price information even if the client is off the stock market. Further if the web page for registering and retrieving the reservation information of buy/sell transaction includes selection buttons of “provide investment information” and “transaction execution at the reservation price”, and client selected the selection button of “transaction execution at the reservation price”, the client paging supporting module automatically executes the reserved buy/sell transaction and provide the execution results of transaction to the client.

In case of selecting the item button of “investment yields”, the investment information register and management module 110 provides a web page displaying a table showing investment amount, buy amount of each item, sell amount of each item, yield of each item, and balance. In case of selecting the item button of “basket buy”, the investment information register and management module 110 provides a web page shown in FIG. 13. If code, title of item, buy volumes, and investment amount which is higher than the present value amount is inputted into the input boxes and button of “buy” is selected, the transaction execution module automatically executes the buy transaction of items.

The transaction execution module has two types of operation process. As for the first type, the transaction execution module includes an execution control process which is protecting buy transaction from being executed when the investment amount is less than 110% of sum of present value amount of items to be transacted.

On the other hand as for the second type, the execution control module further has a function to buy lastly listed item at buy value amount less than that of the other listed items in case that the investment amount is insufficient. That is, even if the investment amount is less than 110% of present value amount, the buy transaction can be automatically executed by selecting the button “buy” because there can be a stock price fluctuation during executing the buy transaction after being determined execution of buy transaction. That means the allowable fluctuation range must be less than 10% even if there is price fluctuation.

In case of selecting the item button of “basket sell”, the investment information register and management module 110 provides a web page similar to FIG. 13 to the client terminal. The web page for supporting basket sell is slightly different from FIG. 13. The FIG. 13 includes input boxes 13-1 for receiving investment amount and a button “buy” but the web page for supporting basket sell includes input boxes for receiving sell value amount and a button “sell” instead of investment amount and the button “buy”, respectively. Other configuration of web page for supporting basket sell is the same with the FIG. 3 except above. Therefore, the investment information register and management module 110 checks whether code of item, title of item, sell volumes, total sell value amount are inputted in corresponding input boxes and the button “sell” is selected. Thus, in case of being inputted the appropriate information and selected the button “sell”, the transaction execution module executes the basket items sell transaction when sum of the present value amount is higher than the total sell value amount. If, the sum of the present value amount is less than the total sell value amount, the transaction execution continuously is waiting for executing basket items sell transaction continuously monitoring the sum of present value amount until the sum of the present value amount become higher than the total sell value amount. However, if the button “sell” is selected without being inputted the total sell value amount, the transaction execution module automatically executes the basket items sell transaction at present market price regardless of the stock price. That is, the basket sell operation has also two types of operation process. First is a total sell value amount setting process and second is an artificial process.

In case of selecting the item button of “other information”, daily stock price charts, present stock price, overhanging supply graphs, monthly stock price charts, psychological line graph, or other investment information is selectively provided to the clients.

Next, the client paging supporting system will be detailed below.

FIG. 14a is a block diagram showing configuration of client paging supporting module 140. The client paging supporting module 140 comprises a priority determination module 141, information sending/recording and terminal management module 142 and client paging terminals 143-1 through 143-N which is connected to the information sending/recording and terminal management module 142 through Local Area Network (LAN).

The priority determination module 141 receives real time paging information or reserved paging information from the discretionary investment reservation information management module 112 and makes a priority distinguishing them.

The information sending/recording and terminal management module 142 1) receives paging information to be sent to the client terminal from the priority determination module 141, 2) sectionalizes the paging information to be automatically inputted into a web page (for example, FIG. 14) provided by a mobile communication service provider, 3) tries to authentication of communication protocol to send the sectionalized information to communication network, and 4) forms an online network (i.e. LAN) by loading communication protocol for controlling and managing a plurality of terminals. The FIG. 14 shows exemplary web page provided by the mobile communication service provider for receiving paging information. In accordance with the FIG. 14, the paging information should be sectionalized to pager number, telephone number to where the clients can be reached, mode selector between numeric/letter and voice, and message to be sent to the clients.

It is desirable for the information sending/recording and management module 142 to have communication interface means such as LAN modem card to be connected to the LAN.

The client paging terminal 143 through 143-N has a LAN communication interface means to be connected to the LAN, a telecommunication interface means to be connected to the telecommunication network, an internet connection program to be connected to the internet, an automatic web page writing program for writing paging information into a web page. As the power is on, the client paging terminal 143 is loading the internet connection program and sending an IP (internet protocol) address of a mobile communication service provider to a domain server, so that the client terminal is connected to the web page into which the paging information can be automatically inputted by the automatic web page writing program.

FIGS. 14b and 14c are flowcharts sequentially showing operation process of the automatic web page writing program. The client paging method comprises the steps of connecting the web page of the mobile communication service provider (S401-S403), initializing and waiting (S404-S405), automatically writing the paging information (S406-S421) and confirming transmitting completion (S422, S423).

The step of connecting the web page of the mobile communication service provider will be detailed below.

First, as the power is on, the internet connection program is driven in the client terminal, and the internet connection program sends an IP address information of a mobile communication service provider to the domain server to connect the web page provided by the mobile communication service provider, so that the client terminal is finally connected to the web page.

During the step of initializing and waiting, each input boxes on the web page for receiving the paging information is initialized and waits for transmitting information.

The step of automatically writing paging information receives information from the information sending/recording and terminal management module at the waiting status, and automatically writing corresponding information into each of the input boxes on the web page provided by the mobile communication service provider, and checks whether the information is completely inputted, and completes the paging operation.

The step of confirming transmitting completion checks whether the paging operation is completed and initializes the input boxes on the web page, and send the completion signal to the information sending/recording and terminal management module.

The step of automatically writing paging information (S406-S421) is a step of inputting information received from the information sending/recording and terminal management module at the waiting status and comprises the sub-steps of inputting client's pager number in a input box for receiving pager number (S406, S407), inputting telephone number to which can be reached the clients (S408-S409), checking and determining paging mode whether it is numeric/letter or voice (S410, S411), setting the paging mode (S412, S417), inputting corresponding message (numeric/letter, voice) into message input box (S413, S418), executing paging (S414, S419), determining whether there is left more message to be sent (S415) (S420) and deleting the message which is previously sent from the message input box (S416) (S421) and repeating the sup-steps of S412-S416, S417-421. In case of no more message is left in sub-step S415, S420, then all input boxes for receiving pager number, telephone number, message is cleared S422, and sending completion signal is sent to the information sending/recording and terminal management module S423.

In sub-step S412, S417 of setting the paging mode, in case that the paging mode is numeric/letter, numeric/letter is inputted into the message input box by 40 characters (in case of Korean character) in sub-step 413. In case that paging mode is voice, voice message is inputted into the message box by 250 characters in sub-step S418. The message includes code of item, title of item, present stock price, buy or sell recommendation, buy bidding price or sell bidding price, volumes to be transacted.

FIG. 14d is a web page for supporting messaging service, the web page provided by internet paging system (or server) which is operated by the corporate company of the mobile communication service provider. The client paging terminal having internet connection program is connected to the web page. That is, the stock exchange supporting system operated in a server of investment consultancy firm is connected to the internet paging system provided by the corporate company of the mobile communication service provider through the on-line network. Therefore, the terminal of the stock exchange supporting system receives the client paging information through the web page in accordance with the flow charts of FIG. 14b and FIG. 14c. The pager number of the client is inputted into the input box for receiving client pager number and telephone number of the investment information provider or investment consultancy company is inputted into the input box for receiving telephone number. The message including code of item, title of item, present stock price, buy/sell recommendation, buy bidding price or sell bidding price and volumes is inputted into the input box for receiving message. If the button “paging” is selected on the web page, the inputted information is sent to the client's pager by way of mobile communication service provider.

In conclusion, the present invention is useful for the people who is busy in doing work, on a business trip or on a travel, so that they can not check or monitor the stock market because the registered reservation information is still available until the transaction as reserved is completed regardless of the stock market closing of the day when the reservation was made. The present invention can be applicable to fields of the following.

1. Personal appointing and scheduling system.

2. Alarming system for alarming due date of car inspection and insurance expiration.

3. Alarming system for alarming appointment with the doctor in hospital

4. Notification system for notifying working on the city water, electric, or cable TV.

5. Information providing system for providing weather forecast such as typhoon to a shipman or a camper.

6. Notification system for notifying the executive expiration.

7. Transmission system for informing the due date of tax payment to a taxpayer before the due data or for sending a reminder after the due date.

8. Notification system for notifying trial date to a lawyer and parties on the merits.

9. Notification system for notifying an auction announcement to parties on the merits and participants.

10. Transmission system for transmitting urgent information on real estate.

11. Notification system for notifying working on transmission lines of network to the users of the network.

12. Messaging system for informing the out of order of the safe or safety apparatus.

13. Transmission system for informing schedule for general meeting of stockholders, the board meeting or staff meeting.

14. Transmission system for providing sales information to whom seeks to good bargains.

15. Information providing system for informing delivery date and time of registered mail.

16. Transmission system for informing enemy's status or instructions.

17. Transmission system for informing an emergency or a status of wartime to soldiers on leave.

18. Information providing system for informing expiration of domain.

The present invention is applicable to various fields of alarming, notifying, informing or transmitting system not limited to the above.

What is claimed is:

1. A stock exchange supporting system comprising:
a client terminal having a web browser; and
a data processing unit which is connected to the client terminal and a mainframe computer of stockmarket which executes transaction of stock exchange,
wherein the data processing unit includes:
(a) an investment information register and management module which receives client identification information and stock transaction reservation information including at least an item to be transacted from the client terminal, registers the information separating it into individuals or groups, and provides execution results of a client's command to a client by receiving commands such as modification or retrieve of the registered stock transaction reservation information or execution of stock transaction from the client terminal, receiving stock exchange information from the mainframe computer of stock market and then executing the client's commands and
(b) transaction execution module which monitors present stock prices of items registered by the investment information register and management module as a stock transaction reservation information on and after a day when the stock transaction reservation information is registered, and makes and sends a transaction execution order to the mainframe computer of the stock market.

2. The stock exchange supporting system of claim 1, wherein the data processing unit is a server of a securities firm or an investment consultancy firm, the server supporting stock exchange and providing stock transaction information.

3. The stock exchange supporting system of claim 1, wherein the data processing unit is a client terminal which is connected to a server of a securities firm through the communication network, the server supporting stock transaction and operation of the client terminal.

4. The stock exchange supporting system of claim 2, wherein the stock transaction reservation information includes:
client paging information such as client terminal address, pager number, and paging time; and
stock transaction information such as at least one item to be transacted as discretionary investment or informed as investment consultancy information, reserved bidding price (buy or sell bidding price range), transaction type (individual or basket), count of transaction times for each item, and at least one condition for basket transaction.

5. The stock exchange supporting system of claim 2, wherein the transaction execution module comprises an individual item buy supporting module which compares present stock prices of items registered by the investment information register and management module as the stock transaction reservation information with the buy bidding price range of the items (from minimum buy bidding price to maximum buy bidding price), in which the registered buy bidding price range is the price range registered as the stock transaction reservation information, sends a buy transaction order to the mainframe computer of stock market with the registered buy bidding price range and registered buy volumes when the present stock price is in the range of the registered buy bidding price or lower than the range of the registered buy bidding price, and transfers execution results of the buy transaction to the investment information register and management module;
an individual item sell supporting module which compares present stock prices of items registered by the investment information register and management module as the stock transaction reservation information with registered sell bidding price ranges of the items (from maximum sell bidding price to minimum sell bidding price), in which the registered sell bidding price range is price range registered as the stock transaction reservation information, sends a sell transaction order to the mainframe computer of stock market with the registered sell bidding price ranges and registered sell volumes when the present stock price is in the range of the registered sell bidding price or higher than the range of the registered sell bidding price, and execution results of sell transaction order to the investment information register and management module.

6. The stock exchange supporting system of claim 2, wherein the transaction execution module comprises:
a basket items buy supporting module which checks present stock prices of items registered by the investment information register and management module as the stock transaction reservation information, generates at least one condition to execute basket items buy transaction, sends a basket items buy transaction order to the mainframe computer of stock market with market price and registered buy volumes when the generated condition is matched with a predetermined condition registered by the investment information register and management module, and transfers execution results of basket items buy transaction order to the investment information register and management module;
a basket items sell supporting module which checks present stock prices of items registered by the investment information register and management module as the stock transaction reservation information, generates at least one condition to execute basket items sell transaction, sends a basket items sell transaction order to the mainframe computer of stock market with market price of each item and registered sell volumes when the generated condition is matched with a predetermined condition registered by the investment information register and management module, and transfers execution results of basket items sell transaction order to the investment information register and management module.

7. The stock exchange supporting system of claim 5, wherein the transaction execution module further checks the execution results of the buy transaction order, then makes and sends a sell transaction order for the items that have been bought in accordance with the buy transaction order to the mainframe computer of the stock market with sell bidding price and volumes as registered by the investment information register and management module, and then makes and sends a new buy transaction order with buy bidding price and volumes as registered after the sell transaction order is executed and confirmed, thereby the buy transaction orders and the sell transaction orders are alternately repeated up to n times.

8. The stock exchange supporting system of claim 6, the transaction execution module further checks the execution results of the buy transaction order, then makes and sends a sell transaction order for the items that have been bought in accordance with the buy transaction order to the mainframe computer of the stock market with sell bidding price and volumes as registered by the investment information register and management module, and then makes and sends a new buy transaction order with buy bidding price and volumes as registered after the sell transaction order is executed and confirmed, thereby the buy transaction orders and the sell transaction orders are alternately repeated up to n times.

9. The stock exchange supporting system of claim 4, wherein the data processing unit further comprises a client paging supporting module which retrieves client paging information and transmits client paging signal to the client terminal that is registered to be informed at the predetermined paging time in case that present stock price of an item registered by the investment information and management module is matched with the reserved bidding price (buy bidding price range or sell bidding price range).

10. The stock exchange supporting system of claim 9, wherein the client paging supporting module comprises:
a priority determination module for determining priority of paging information by distinguishing between real time paging information and reservation paging information; and
an information sending/recording and terminal management module for selecting appropriate communication protocol and establishing connection to the communication network such that the client paging information decided to be sent to the client by the priority determination module is classified into appropriate data formats so as to be automatically displayed on web pages provided by corresponding mobile communication service providers, and storing transmission-reserved information in a memory.

11. The stock exchange supporting system of claim 10, wherein the client paging supporting module further comprises at least one client paging terminal connected to the information sending/recording and terminal management module through a local area network (LAN), and having a communication interface for connecting the client paging supporting module to the LAN and a telecommunication interface means (i.e. modem card) for connecting the client paging supporting module to a telecommunication network, and
an internet connection program and an automatic web page writing program, thereby once power is on, the internet connection program is loaded and an IP (internet protocol) address of a mobile communication service provider is automatically sent to a domain server, so that the client paging terminal reaches a web page provided by the mobile communication service provider and automatically writing the client paging information into the web page.

12. The stock exchange supporting system of claim 9, wherein the client paging supporting module sends stock price information received from the mainframe computer of stock market to a client terminal with the client paging information.

13. The stock exchange supporting system of claim 9, wherein the client paging supporting module classifies the client paging information into at least one group of information and sends the client paging information belonged to each group at regular intervals.

14. The stock exchange supporting system of claim 12, wherein the client paging supporting module classifies the client paging information into a plurality of groups and sends the client paging information belonged to each group at regular intervals.

15. The stock exchange supporting system of claim 3, wherein the investment information register and management module comprises a discretionary investment reservation information management module providing at least one web page which includes input boxes for receiving client identification information, password, client's registered number, code or title of item to be transacted, and volumes and value amount of the item to be transacted; and supporting registration reservation and reserved transaction in accordance with investment information from the user terminal through the web page; and updating the stock transaction reservation information in response to the execution results of stock transaction.

16. The stock exchange supporting system of claim 15, wherein the discretionary investment reservation information management module provides a plurality of launch buttons each of which is linked with a web page having information corresponding to each of launch buttons, wherein each launch button has a command instructing a specific action such as register individual investment, register group investment, retrieve registered individual investment items, retrieve registered group investment items, print list of items invested by an individual, print list of items invested by a group, display list of clients by a group, display list of all clients, register investment fund, and retrieve investment fund.

17. The stock exchange supporting system of claim 16, wherein the discretionary investment reservation information module includes individual investment register supporting module providing a web page having a plurality of input boxes for receiving code and title of item, maximum reserved buy bidding price at 1−nₜₕ count of buy transaction, minimum reserved buy bidding price at 1−nₜₕ count of buy transaction, reserved buy volumes, maximum reserved sell bidding price at 1−nₜₕ count of sell transaction, minimum reserved sell price at 1−nₜₕ count of sell transaction, and reserved sell volumes and display boxes for displaying buy value amount, sell value amount, current cash, balance.

18. The stock exchange supporting system of claim 17, wherein the individual investment register supporting module further provides the web page with a launch button of graphic information linked with a web page showing overhanging supply or daily/monthly stock price changes, an input boxes for receiving reference dates to set corresponding period, and display frames for displaying highest, lowest, and present stock prices during the period.

19. The stock exchange supporting system of claim 16, wherein the discretionary investment reservation information module includes a group investment register supporting module and operates the group investment register supporting module when the launch button of register group investment is selected, the group investment register supporting module providing a web page having a plurality of input boxes for receiving group name, ESN (electronic serial number) of pager, code number and title of item, maximum reserved buy bidding price at 1−nₜₕ count of buy transaction, minimum reservation buy bidding price at 1−nₜₕ count of buy transaction, reserved buy volumes, maximum reserved sell bidding price at 1−nₜₕ count of sell transaction, minimum reservation sell bidding price at 1−nₜₕ count of sell transaction, and reserved sell volumes; and display boxes for displaying sum of buy value amount, sum of sell value amount, current cash, balance, wherein if the group name is inputted into the corresponding input box the web page further displays ESN, client's registered number, list of clients belong to the group.

20. The stock exchange supporting system of claim 19, the group investment register supporting module further provides the web page with a plurality of display boxes for displaying sum of reserved buy volumes at first count of buy transaction, sum of reserved sell volumes at first count of sell transaction, sum of investment amount of which clients reserved to buy shares at the first count of buy transaction, and present cash amount.

21. The stock exchange supporting system of claim 16, wherein the discretionary investment reservation information management module includes an individual investment query supporting module and drives the individual investment query supporting module when the launch button of retrieve individual investment is selected, in which the individual investment query supporting module provides a web page having a plurality of input boxes for receiving client's registered number or client's name, and display boxes for displaying client's name, client's registered number, pager number, code and title of item on which transaction reservation is made by client and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell price at 1−nₜₕ count of sell transaction, minimum reserved sell bidding price at 1−nₜₕ count of sell transaction, and reserved sell volumes, and execution results of 1−nₜₕ count of sell transaction.

22. The stock exchange supporting system of claim 16, wherein the discretionary investment reservation information management module includes a group investment query supporting module and operates the group investment query supporting module when the launch button of retrieve group investment is selected, the group investment query supporting module providing a web page having an input box for receiving a group name and a plurality of display boxes for displaying ESN of pager, code and name of item on which transaction reservation is made and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell bidding price at 1−nₜₕ count of sell transaction, minimum reserved sell bidding price at 1−nth count of sell transaction, and reserved sell volumes, and execution results of 1−nₜₕ count of sell transaction.

23. The stock exchange supporting system of claim 15, wherein the investment information register and management module comprises an investment fund management module, an investment consultancy information management module, a recommended items management module, and basket items buy/sell reservation information management module,
wherein the investment fund management module provides a web page and manages discretionary investment in response to information inputted through the web page, the web page having a plurality of input boxes, a plurality of display boxes, and a plurality of launch buttons, the input boxes receiving fund name, items to be transacted through the fund, count of transaction, and reference date to set the period of transaction, the display boxes displaying highest, lowest, and present prices during the period, and the launch buttons including graphic information and yield estimation, of which the launch button of graphic information is linked with a web page showing graphic information of daily/monthly stock price changes and overhanging supply during the period and the launch button of yield estimation is linked with a web page showing yield information during the period;
the investment consultancy information management module provides a web page having stock price information such as buy or sell recommendation, buy bidding price or sell bidding price and buy volumes and sell volumes and manages the stock price information shown on the web page;
the recommended items management module provides a web page including a plurality of item buttons, each of which is linked with a web page contains corresponding information related to each item so as to guide the clients with items which are worth investing; and
the basket items buy/sell reservation information management module registers and manages items to be basket-transacted by receiving code or title of the items, volumes and value amount.

24. The stock exchange supporting system of claim 23, the investment fund management module provides the yield information such as percentage of return on gross investment when the launch button of yield estimation is selected, wherein in case the title or code of the item is inputted into the input box included in the web page linked with the launch button of yield estimation, yield information of each item such as investment amount on the item, yield on the item, share holding status, balance is presented on the web page.

25. The stock exchange supporting system of claim 23, wherein the recommended items management module provides a web page including a plurality of buttons, each of which is linked with a corresponding web page to display corresponding information such as list of items highly undervalued, list of items ranked high in PER (price earnings ratio), list of items having high retained earnings, list of items ranked high in average value of numerical order in each items of undervalued/PER/retained earnings, list of items recorded consecutive daily permissible high price, list of items having highly advanced rate in short term, list of items recorded price at low during a predetermined period, list of items recorded low advanced rate, list of items having high gain over equity, list of items recorded price at new high, and list of items recorded highly advanced rate between lowest price and highest price.

26. The stock exchange supporting system of claim 25, wherein the recommended items management module provides a web page displaying list of items highly undervalued and average PBR (price book value ratio) by estimating ratio of share price over book value average for recent years when the high undervalued items button is selected.

27. The stock exchange supporting system of claim 25, wherein the recommended items management module provides a web page displaying list of items ranked high in PER by estimating percentage of EPS (earnings per share) average for recent years over present stock price when the button of list of items ranked high in PER is selected.

28. The stock exchange supporting system of claim 25, wherein the recommended items management module provides a web page displaying list of items ranked high in percentage of retained earning value over total equity (present stock price×capital/face value) when the button of retained earnings is selected.

29. The stock exchange supporting system of claim 25, wherein the recommended items management module provides a web page displaying list of items ranked high in average value of numerical order in each items of undervalued, PER and retained earnings when the button of undervalued/PER/retained earnings is selected

30. The stock exchange supporting system of claim 25, wherein the recommended items management module provides a web page displaying list of items recorded the consecutive daily permissible high price more than two times when the button of list of items recorded consecutive daily permissible high price is selected.

31. The stock exchange supporting system of claim 25, wherein the recommended items management module provides a web page displaying list of items recorded high advanced rate from the moving mean price line during a predetermined period when the button of list of items having high advanced rate in short term is selected.

32. The stock exchange supporting system of claim 25, wherein the recommended items management module retrieves items recorded price at low during the predetermined period, provides buy information (buy point) of nₜₕ count, the buy point being price level advanced at a certain rate from the price at low, and then provides sell information (sell point) of nₜₕ count in which the sell point is price level advanced at a certain rate from the buy point, when the button of list of items recorded price at low is selected.

33. The stock exchange supporting system of claim 25, wherein the recommended items management module provides a web page displaying list of items recorded lowest advanced rate from price at low during a predetermined period which is set by the client inputting a reference date (year, month, date) when the button of list of items recorded low advanced rate is selected.

34. The stock exchange supporting system of claim 25, wherein the recommended items management module provides a web page displaying list of items ranked high in percentage of net profit value per share over equity when the button of list of items having high gain over equity is selected and semi-annual revenue or average revenue per year is set.

35. The stock exchange supporting system of claim 25, wherein the recommended items management module provides a web page displaying list of items recorded price at new high from a reference date to the present when the button of list of items recorded price at new high is selected and the reference date (year, month, and data) is inputted by the client.

36. The stock exchange supporting system of claim 25, wherein the recommended items management module provides a web page displaying list of items ranked high in advanced rate of share price from the lowest price level when the button of list of items recorded high advanced rate from lowest price level to highest price level is selected.

37. The stock exchange supporting system of claim 23, wherein the basket items buy/sell reservation information management module provides a web page including a plurality of item buttons, each of which is linked with a corresponding web page displaying corresponding information related to the each item, wherein the buttons includes “buy or sell basket items listed in stock exchange,” “buy or sell basket items registered in KOSDAQ (Korea Securities Dealers Automated Quotations),” “buy or sell basket items listed in stock exchange or registered in KOSDAQ,” “buy or sell basket of appointed items,” “buy or sell basket items classified by grades,” “past basket buy or sell transaction data of appointed items,” “execution results of past basket buy or sell transaction data of appointed items,” and “execution results of all buy or sell transactions.”

38. The stock exchange supporting system of claim 37, wherein the basket items buy/sell reservation information management module provides a web page including a plurality of input boxes for receiving appointed items to be basket-transacted, buy value amount, client's registered number, client's name, and password, and estimates reserved buy value amount for each item by dividing the buy value amount by number of the appointed items and reserved buy volumes for each item by equally dividing the reserved buy value amount for each item by present stock price of each item.

39. The stock exchange supporting system of claim 37, wherein the basket items buy/sell reservation information management module provides a web page including a plurality of input boxes for receiving appointed items to be basket-transacted, sell value amount, client's registered number, client's name, and password when one of the item buttons of “sell basket items listed in stock exchange,” “sell basket items registered in KOSDAQ,” “sell basket items listed in stock exchange or registered in KOSDAQ” is selected, and registers reserved sell bidding price of each item with the present stock price in case sum of present value amount of appointed items is higher than total sell value amount which is inputted into the input box provided in the web page.

40. The stock exchange supporting system of claim 39, wherein the basket items buy/sell reservation information management module further provides the web page with input boxes for receiving count of past basket transaction such that in case the count of past basket transaction is inputted in the corresponding box, the basket items buy/sell reservation information management module displays, on the web page, transaction time (year, month, day, time) of the past basket transaction at the count, list of items transacted at the past basket transaction of the count, buy price of each item, buy volumes of each item, and stock holding status.

41. The stock exchange supporting system of claim 37, wherein the basket items buy/sell reservation information management module provides a web page including a plurality of input boxes for receiving appointed items to be basket-transacted, buy value amount, client's registered number, client's name, and password when the button of “buy basket of appointed items” is selected such that the basket items buy/sell reservation information management module estimates reserved buy value amount per each item by equally dividing buy value amount by number of the appointed items, further estimates reserved buy volumes per each item by dividing the buy value amount per each item by present stock price per share of each item and registers the reserved buy value amount per each item and the reserved buy volumes as reservation information.

42. The stock exchange supporting system of claim 37, wherein the basket items buy/sell reservation information management module provides a web page including a plurality of input boxes for receiving count of basket sell transaction, sell value amount, client's registered number, client's name, and password when the item button of “sell basket of appointed items” is selected, such that in case sell value amount is inputted into an input box to generate a condition for executing basket sell transaction and sum of present value amount of the appointed items is higher than the sell value amount, the basket items buy/sell reservation information management module regards the present value amount of each of the appointed items as sell value amount of each item or setting sell value amount of each item using the present stock price of the each item and makes a list of items to be sell basket transacted.

43. The stock exchange supporting system of claim 37, wherein the basket items buy/sell reservation information management module provides a web page including input boxes for receiving investment amount and grade on each item, a launch button for selecting market type (stock exchange/KOSDAQ/stock exchange or KOSDAQ), and a launch button for selecting buy or sell when the item button “buy/sell basket items classified by grades” is selected, whereby after the investment amount and grade on each item are inputted into the input boxes, the basket items buy/sell reservation information management module divides the investment amount in response to the grades inputted into the input boxes and registers the divided investment amount of each item as reservation information for buy or sell basket items classified by grades.

44. The stock exchange supporting system of claim 37, wherein the basket items buy/sell reservation information management module provides a web page including input boxes for receiving client's registered number, client's name, password, count of past basket buy transaction when the item button “past basket buy transaction data” is selected, such that in case the count of past basket buy transaction is inputted into the input window, a new web page displaying past basket buy transaction data is presented on the client terminal, the past basket buy transaction data including the following information: codes of items, titles of items, holding status, volumes of each item, buy price per share of each item, present stock price per share of each item, yield of each item, buy value amount of each item, present value amount of each item estimated by the present stock price, profit or loss value amount of each item, average yield, sum of buy value amount on the past basket buy transaction, sum of profit/loss value amount, and sum of present value amount.

45. The stock exchange supporting system of claim 44, wherein the basket items buy/sell reservation information management module provides the web page with input boxes for receiving sum of buy value amount (investment amount), yield average and/or sum of profit/loss value amount each of which is used as a reference value to generate a condition for executing basket items buy transaction.

46. The stock exchange supporting system of claim 45, wherein the basket items buy/sell reservation information management module generates and registers a condition for executing basket buy transaction when the sum of buy value amount is inputted into one of the input boxes and the sum of present value amount of items listed in the basket of past basket transaction data is lower than the inputted sum of buy value amount.

47. The stock exchange supporting system of claim 45, wherein the basket items buy/sell reservation information management module generates and registers a condition for executing basket buy transaction when the yield average is inputted into one of the input boxes and the yield average of the past basket buy transaction is about same to the newly inputted yield average.

48. The stock exchange supporting system of claim 45, wherein the basket items buy/sell reservation information management module generates and registers a condition for executing basket buy transaction when the sum of profit/loss value amount is inputted into one of the input boxes and the sum of profit/loss value amount of the past basket buy transaction is about same to the newly inputted profit/loss value amount.

49. The stock exchange supporting system of claim 37, wherein the basket items buy/sell reservation information management module provides a web page including input boxes for receiving client's registered number, client's name, password, count of past basket sell transaction when the item button “past basket sell transaction data” is selected, wherein in case the count of past basket sell transaction is inputted into the input box, a new web page displaying past basket sell transaction data table is presented on the client terminal, wherein the past basket sell transaction data table includes the following information: code of each item, title of each item, holding status, volumes of each item, sell price per share of each item, present stock price per share of each item, yield over the present stock price of each item, sell value amount of each item, present value amount of each item, profit/loss value amount of each item over the present value amount, average yield, sum of sell value amount, sum of profit/loss value amount, and sum of present value amount.

50. The stock exchange supporting system of claim 49, wherein the basket items buy/sell reservation information management module provides the web page with further input boxes for receiving sum of buy value amount (investment amount), yield average and/or sum of profit/loss value amount each of which is used as a reference value to generate a condition for executing basket items buy transaction.

51. The stock exchange supporting system of claim 50, wherein the basket items buy/sell reservation information management module generates and registers a condition for executing basket buy transaction when the sum of buy value amount is inputted into one of the input boxes and the sum of present value amount included in the past basket buy transaction data table is lower than the inputted sum of buy value amount.

52. The stock exchange supporting system of claim 50, wherein the basket items buy/sell reservation information management module generates and registers a condition for executing basket buy transaction when yield average is inputted into one of the input boxes and the yield average in the past basket buy transaction data table is about same to the newly inputted yield average.

53. The stock exchange supporting system of claim 45, wherein the basket items buy/sell reservation information management module generates and registers a condition for executing basket buy transaction when sum of profit/loss value amount is inputted into one of the input boxes and the sum of profit/loss value amount in the past basket buy transaction data table is about same to the newly inputted sum of profit/loss value amount.

54. The stock exchange supporting system of claim 9, wherein the investment information register and management module comprises a discretionary investment reservation information management module providing at least one web page which includes input boxes for receiving client identification information, password, client's registered number, code or title of item to be transacted, and volumes and value amount to be transacted; and supporting registration reservation and reserved transaction in accordance with investment information from the client terminal through the web page; and updating the stock transaction reservation information in response to the execution results of stock transaction.

55. The stock exchange supporting system of claim 54, wherein the discretionary investment reservation information management module provides a plurality of launch buttons each of which is linked with a web page having information corresponding to each of launch buttons, wherein each launch button has a command instructing a specific action such as register individual investment, register group investment, retrieve individual investment, retrieve group investment, print list of items invested by an individual, print list of items invested by a group, display list of clients by a group, display list of all clients, register investment fund, and retrieve investment fund.

56. The stock exchange supporting system of claim 55, wherein the discretionary investment reservation information module includes individual investment register supporting module and operates the individual investment register supporting module when the launch button of register individual investment is selected, the individual investment register supporting module providing a web page having a plurality of input boxes for receiving code and title of item, maximum reserved buy bidding price at 1−nₜₕ count of buy transaction, minimum reserved buy bidding price at 1−nₜₕ count of buy transaction, reserved buy volumes, maximum reserved sell biding price at 1−nₜₕ count of sell transaction, minimum reserved sell bidding price at 1−nₜₕ count of sell transaction, and reserved sell volumes and display boxes for displaying buy value amount, sell value amount, present cash, and balance.

57. The stock exchange supporting system of claim 56, wherein the individual investment register supporting module further provides the web page with a launch button of graphic information linked with a web page showing overhanging supply or daily/monthly item price changes, an input boxes for receiving reference dates to set corresponding period, and display frames for displaying highest, lowest, and present stock prices during the period.

58. The stock exchange supporting system of claim 55, wherein the discretionary investment reservation information module includes a group investment register supporting module and operates the group investment register supporting module when the launch button of register group investment is selected, the group investment register supporting module providing a web page having a plurality of input boxes for receiving group name, ESN (electronic serial number) of pager, code number and title of item, maximum reserved buy bidding price at 1−nₜₕ count of buy transaction, minimum reserved buy bidding price at 1−nₜₕ count of buy transaction, reserved buy volumes, maximum reserved sell bidding price at 1−nₜₕ count of sell transaction, minimum reserved sell price at 1−nₜₕ count of sell transaction, and reserved sell volumes; and display boxes for displaying sum of buy volumes, sum of sell volumes, investment amount, balance, wherein if the group name is inputted into the corresponding input box the web page further displays ESN, client's registered number, list of clients belong to the group.

59. The stock exchange supporting system of claim 58, the group investment register supporting module further provides the web page with a plurality of display boxes for displaying sum of reserved buy volumes at first count of buy transaction, sum of reserved sell volumes at first count of sell transaction, sum of investment amount of which clients reserved to buy items at the first count of buy transaction, and present cash amount.

60. The stock exchange supporting system of claim 55, wherein the discretionary investment reservation information management module includes an individual investment query supporting module and drives the individual investment query supporting module when the launch button of retrieve individual investment is selected, in which the individual investment query supporting module provides a web page having a plurality of input boxes for receiving client's registered number or client's name, and display boxes for displaying client's name, client's registered number, pager number, code and title of item on which transaction reservation is made by client and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell bidding price at 1−nth count of sell transaction, minimum reserved sell bidding price at 1−nth count of sell transaction, and reserved sell volumes, and execution results of 1−nₜₕ count of sell transaction.

61. The stock exchange supporting system of claim 55, wherein the discretionary investment reservation information management module includes a group investment query supporting module and operates the group investment query supporting module when the launch button of retrieve group investment is selected, the group investment query supporting module providing a web page having an input box for receiving a group name and a plurality of display boxes for displaying ESN of pager, code and name of item on which transaction reservation is made and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell price at 1−nₜₕ count of sell transaction, minimum reserved sell bidding price at 1−nₜₕ count of sell transaction, and reserved sell volumes, and execution results of 1−nₜₕ count of sell transaction.

62. The stock exchange supporting system of claim 54, wherein the investment information register and management module comprises an investment fund management module, an investment consultancy information management module, a recommended items management module, and basket items buy/sell reservation information management module,
wherein the investment fund management module provides a web page and manages discretionary investment in response to information inputted through the web page, the web page having a plurality of input boxes, a plurality of display boxes, and a plurality of launch buttons, the input boxes receiving fund name, items to be transacted through the fund, count of transaction, and reference date to set the period of transaction, the display boxes displaying highest, lowest, and present stock prices during the period, and the launch buttons including graphic information and yield estimation, of which the launch button of graphic information is linked with a web page showing graphic information of daily/monthly stock price changes and overhanging supply during the period and the launch button of yield estimation is linked with a web page showing yield information during the period;
the investment consultancy information management module provides a web page having stock price information such as buy or sell recommendation, buy bidding price or sell bidding price and buy volumes and sell volumes and manages the stock price information shown on the web page;
the recommended items management module provides a web page including a plurality of item buttons, each of which is linked with a web page contains corresponding information related to each item so as to guide the clients with items which are worth investing; and
the basket items buy/sell reservation information management module registers and manages items to be basket-transacted by receiving code or title of the items, volumes and value amount.

63. The stock exchange supporting system of claim 62, the investment fund management module provides the yield information such as percentage of return on investment amount when the launch button of yield estimation is selected, wherein in case the title or code of the item is inputted into the input box included the web page linked with the launch button of yield estimation, yield information of each item such as investment amount on the item, yield on the item, share holding status, balance is presented on the web page.

64. The stock exchange supporting system of claim 62, wherein the recommended items management module provides a web page including a plurality of item buttons, each of which is linked with a corresponding web page to display corresponding information such as list of items highly undervalued, list of items ranked high in PER, list of items having high retained earnings, list of items ranked high in average value of numerical order number in each item of highly undervalued/high PER/high retained earnings, list of items recorded consecutive daily permissible high price, list of items having highly advanced rate in short term, list of items recorded price at low during a predetermined period, list of items recorded low advanced rate, list of items having high gain over equity, list of items recorded price at new high, and list of items recorded highly advanced rate between lowest price and highest price.

65. The stock exchange supporting system of claim 64, wherein there commended items management module provides a webpage displaying list of items highly undervalued by estimating average PBR (price book value ratio) which means average ratio of stock price over book value for recent years when the highly undervalued items button is selected.

66. The stock exchange supporting system of claim 64, wherein the recommended items management module provides a web page displaying list of items ranked high in PER by estimating percentage of average EPS for recent years over present stock price when the button of list of items ranked high PER is selected.

67. The stock exchange supporting system of claim 64, wherein the recommended items management module provides a web page displaying list of items ranked high in percentage of excessive retained earning value over total equity (present stock price×capital/face value) when the button of list of items ranked high in retained earnings is selected.

68. The stock exchange supporting system of claim 64, wherein the recommended items management module provides a web page displaying list of items ranked high in average value of numerical order number in each items of undervalued/PER/retained earnings when the button of undervalued/PER/retained earning is selected

69. The stock exchange supporting system of claim 64, wherein the recommended items management module provides a web page displaying list of items recorded the consecutive daily permissible high price more than two times when the item button of list of items recorded consecutive permissible high price is selected.

70. The stock exchange supporting system of claim 64, wherein the recommended items management module provides a web page displaying list of items recorded high advanced rate from the moving mean price line during predetermined period when the button of list of items having high advanced rate in short term is selected.

71. The stock exchange supporting system of claim 64, wherein the recommended items management module retrieves items recorded price at low during the predetermined period, provides buy information (buy point) of nₜₕ count, the buy point being price level advanced at a certain rate from the price at low, and then provides sell information (sell point) of nₜₕ count in which the sell point is price level advanced at a certain rate from the buy point, when the button of list of items recorded price at low is selected.

72. The stock exchange supporting system of claim 64, wherein the recommended items management module provides a web page displaying list of items recorded lowest advanced rate from price at low during predetermined period which is set by the client inputting a reference date (year, month, date) when the button of list of items recorded low advanced rate is selected.

73. The stock exchange supporting system of claim 64, wherein the recommended items management module provides a web page displaying list of items ranked high in percentage of net profit value per share over equity when the button of list of items having high gain over equity is selected and semi-annual revenue or average revenue per year is set.

74. The stock exchange supporting system of claim 64, wherein the recommended items management module provides a web page displaying list of items recorded price at new high during a predetermined period from a reference date to the present when the button of list of items recorded price at new high is selected and the reference date (year, month, and data) is inputted by the client.

75. The stock exchange supporting system of claim 64, wherein the recommended items management module provides a web page displaying list of items ranked high in advanced rate of item price from the lowest price level when the button of “list of items recorded high advanced rate from lowest price level to highest price level” is selected.

76. The stock exchange supporting system of claim 62, wherein the basket items buy/sell reservation information management module provides a web page including a plurality of item buttons, each of which is linked with a corresponding web page displaying corresponding information related to the each item, wherein the buttons includes “buy or sell basket items listed in stock exchange,” “buy or sell basket items registered in KOSDAQ (Korea Securities Dealers Automated Quotations)” “buy or sell basket items listed in stock exchange or registered in KOSDAQ,” “buy or sell basket of appointed items,” “buy or sell basket items classified by grades,” “past buy or basket sell transaction data of appointed items,” “execution results of past basket buy or sell transaction data of appointed items,” and “execution results of all buy or sell transactions”.

77. The stock exchange supporting system of claim 76, wherein the basket items buy/sell reservation information management module provides a web page including a plurality of input boxes for receiving appointed items to be basket-transacted, buy value amount, client's registered number, client's name, and password, estimates reserved buy value amount per each item by equally dividing the buy value amount by number of the appointed items, further estimates reserved buy volumes per each item by dividing the buy value amount per each item by the present stock price of the each item and registers the reserved buy value amount per each item and the reserved buy volumes as reservation information when one of the item buttons of “buy basket items listed in stock exchange,” “buy basket items registered in KOSDAQ,” “buy basket items listed in stock exchange or registered in KOSDAQ” is selected.

78. The stock exchange supporting system of claim 76, wherein the basket items buy/sell reservation information management module provides a web page including a plurality of input boxes for receiving appointed items to be basket transacted, sell value amount, client's registered number, client's name, and password when one of the item buttons of “sell basket items listed in stock exchange,” “sell basket items registered in KOSDAQ,” “sell basket items listed in stock exchange or registered in KOSDAQ” is selected, and registers reservation sell price of each item with the present stock price in case sum of present value amount of appointed items is higher than total sell value amount which is inputted into the input box provided in the web page.

79. The stock exchange supporting system of claim 78, wherein the basket items buy/sell reservation information management module further provides the web page with further input boxes for receiving count of past basket transaction, in case the count of past basket transaction is inputted the basket items buy/sell reservation information management module displays on the web page transaction time (year, month, day, time) of the past basket transaction at the count, list of items transacted at the past basket transaction of the count, buy bidding price of each item, buy volumes of each item, and stock holding status.

80. The stock exchange supporting system of claim 76, wherein the basket items buy/sell reservation information management module provides a web page including a plurality of input boxes for receiving appointed items to be basket-transacted, buy value amount, client's registered number, client's name, and password when the button of “buy basket of appointed items” is selected, estimates reserved buy value amount per each item by equally dividing buy value amount by number of the appointed items, further estimates reserved buy volumes per each item by dividing the reserved buy value amount per each item by present stock price of the each item and registers the reserved buy value amount per each item and the reserved buy volumes as reservation information.

81. The stock exchange supporting system of claim 76, wherein the basket items buy/sell reservation information management module provides a web page including a plurality of input boxes for receiving count of basket sell transaction, sell value amount, client's registered number, client's name, and password when the button of “sell basket of appointed items” is selected, in case sell value amount is inputted into an input box so as to generate a condition for executing basket sell transaction and sum of present value amount of appointed items is higher than the sell value amount, the basket items buy/sell reservation information management module regards the present value amount of the each appointed items as sell value amount of each item or estimates sell value amount of each item based on the present stock price, and makes a list of items to be sell basket transacted.

82. The stock exchange supporting system of claim 76, wherein the basket items buy/sell reservation information management module provides a web page including input boxes for receiving investment amount and grade on each item, a launch button for selecting market type (stock exchange/KOSDAQ/stock exchange or KOSDAQ), and a launch button for selecting buy or sell when the item button “buy/sell basket items classified by grades” is selected, whereby after the investment amount and grade on each items are inputted into the input boxes, the basket items buy/sell reservation information management module divides the investment amount in response to the grades inputted into the input box and registers the divided investment amount of each item as reservation information for buy or sell basket transaction.

83. The stock exchange supporting system of claim 76, wherein the basket items buy/sell reservation information management module provides a web page including input boxes for receiving client's registered number, client's name, password, count of past basket buy transaction when the item button “past basket buy transaction data” is selected, wherein in case the count of past basket buy transaction is inputted into the input box, a new web page displaying past basket buy transaction data table is presented on the client terminal, wherein the past basket buy transaction data table includes the following information: code of item, title of item, holding status, volumes, buy bidding price per share, present stock price per share, yield of each item against the present stock price, buy value amount of each item, present value amount of each item estimated by the present stock price, profit or loss value amount of each item against the present value amount of each item, yield average of all items, sum of buy value amount of all items, sum of profit/loss value amount of all items, and sum of present value amount of all items.

84. The stock exchange supporting system of claim 83, wherein the basket items buy/sell reservation information management module provides to the web page with further input boxes for receiving sum of buy value amount (investment amount), yield average and/or sum of profit/loss value amount each of which is used as a reference value to generate a condition for executing basket items buy transaction.

85. The stock exchange supporting system of claim 84, wherein the basket items buy/sell reservation information management module generates and registers a condition for executing basket buy transaction when the buy value amount (investment amount) is inputted into one of the input boxes and the sum of present value amount of all items listed in the basket of past basket transaction data table is lower than the inputted buy value amount.

86. The stock exchange supporting system of claim 84, wherein the basket items buy/sell reservation information management module generates and registers a condition for executing basket buy transaction when the yield average is inputted into one of the input boxes and the yield average in the past basket buy transaction data table is about same with the newly inputted yield average.

87. The stock exchange supporting system of claim 84, wherein the basket items buy/sell reservation information management module generates and registers a condition for executing basket items buy transaction when the sum of profit/loss value amount is inputted into one of the input boxes and the sum of profit/loss value amount in the past basket buy transaction data table is about same to the newly inputted profit/loss value amount.

88. The stock exchange supporting system of claim 76, wherein the basket items buy/sell reservation information management module provides a web page including input boxes for receiving client's registered number, client's name, password, count of past basket sell transaction when the item button “past basket sell transaction data” is selected, wherein in case the count of past basket sell transaction is inputted into the input box, a new web page displaying past basket sell transaction data table is presented on the client terminal, wherein the past basket sell transaction data includes the following items: code of item, title of item, holding status, volumes, sell price per share, present stock price per share, yield of each item over the present stock price, sell value amount of each item, present value amount of each item, profit/loss value amount of each item against the present value amount, yield average, sum of sell value amount of all items, sum of profit/loss value amount of all items, and sum of present value amount of all items listed in the past basket transaction data table.

89. The stock exchange supporting system of claim 88, wherein the basket items buy/sell reservation information management module provides to the web page with further input boxes for receiving sum of buy value amount (investment amount), yield average and/or sum of profit/loss value amount each of which is used as a reference value to generate a condition for executing basket items buy transaction.

90. The stock exchange supporting system of claim 89, wherein the basket items buy/sell reservation information management module generates and registers a condition for executing basket items buy transaction when the buy value is inputted into one of the input boxes and the sum of present value amount of all items listed in the past basket transaction data table is lower than the inputted buy value amount.

91. The stock exchange supporting system of claim 89, wherein the basket items buy/sell reservation information management module generates and registers a condition for executing basket items buy transaction when yield average is inputted into one of the input boxes and the yield average in the past basket buy transaction data table is about same to the newly inputted yield average.

92. The stock exchange supporting system of claim 89, wherein the basket items buy/sell reservation information management module generates and registers a condition for executing basket items buy transaction when sum of profit/loss value amount is inputted into one of the input boxes and the sum of profit/loss value amount in the past basket buy transaction data table is about same to the newly inputted sum of profit/loss value amount.

93. A method of supporting stock exchange using a data processing apparatus which is connected to a client terminal to receive client's ID information and stock transaction reservation information and a mainframe computer of stock market to receive real time stock transaction information through communication network respectively, comprising the steps of:
(a) checking a market condition by comparing the stock transaction reservation information registered in advance with the real time stock transaction information received from the mainframe computer of stock market and determining whether the market condition is adequate to execute stock transaction of an individual item or basket items in accordance with investment type and condition predetermined by the registered stock transaction reservation information;
(b) post-treating to send a transaction execution order to the mainframe computer of stock market to execute the stock transaction or to provide at least one client with present stock price information in response to the results of confirmation whether the client is registered discretionary investment or investment consultancy; and
(d) after the stock market being closed on that day when the stock transaction reservation is made, checking whether stock transaction is completely executed in accordance with the registered stock transaction reservation information, if not, re-registering remained part of the stock transaction reservation information which is remained being not transacted as new stock transaction reservation information on a next stock market opening day, whereby steps (b) and (d) are repeatedly performed till all stocks registered to be transacted in accordance with the stock transaction reservation information are completely transacted.

94. The method of supporting stock exchange of claim 93 further comprises a step of (c) registering investment information, wherein the step (c) includes steps of receiving from the client terminal the stock transaction reservation information including investment type and condition, and registering the reservation information by separating it into individuals or groups, wherein the stock transaction reservation information includes client's ID information and paging information (terminal addressor pager number, paging time), at least one item to be transacted or consulted, reserved bidding price (buy bidding price range and sell bidding price range), transaction type (individual or basket), count of transactions by each item, and condition for individual item transaction or basket items transaction.

95. The method of supporting stock exchange of claim 93, wherein the step (a) includes sub-step of:
(a10-1) checking a stock market opening, retrieving the stock transaction reservation information to confirm whether the stock transaction reservation information is registered on that day and determining the transaction type (individual item buy or sell) from the stock transaction reservation information,
(a11) in case the transaction type is individual item buy, comparing present stock prices of items registered in the stock transaction reservation information with the range of reserved buy bidding prices, and setting a condition to execute individual item buy transaction when the range of reserved buy bidding price (from maximum buy bidding price to minimum buy bidding price) is the same as or higher than the present stock prices, and
(a12) in case the transaction type is individual item sell, comparing present stock prices of items registered in the stock transaction reservation information with the range of reserved sell bidding prices, and setting a condition to execute individual item sell transaction when the range of reserved sell bidding price range (from minimum sell price to maximum sell price) is the same with or lower than the present stock prices.

96. The method of supporting stock exchange of claim 93, wherein the step (a) includes a sub-step of;
(a10-2) checking a stock market opening, retrieving the stock transaction reservation information to confirm whether the stock transaction reservation information is registered on that day and determining the transaction type (basket items buy or sell) from stock transaction reservation information,
(a13) in case the transaction type is basket items buy, generating at least one market condition to execute the basket items buy transaction by checking present stock prices of items registered in the stock transaction reservation information, comparing the generated market condition with the investment condition which is registered in the stock transaction reservation information, and setting the generated market condition to the investment condition to execute basket items buy transaction when the generated market condition is belong to the registered investment condition, and
(a14) in case the transaction type is basket items sell, generating at least one market condition to execute the basket items sell transaction by checking present stock prices of items registered in the stock transaction reservation information, comparing the generated market condition with the investment condition which is registered in the stock transaction reservation information, and setting the generated market condition to the investment condition to execute basket items sell transaction when the generated market condition is belong to the registered investment condition.

97. The method of supporting stock exchange of claim 93, wherein the step (b) comprises:
a step of (b1) executing automatic transaction, wherein in the step (b1), the transaction execution order is automatically sent to the mainframe computer of stock market with investment condition as registered when the client supporting type is discretionary investment; and
a step of (b2) providing stock price information, in the step (b2), a client paging signal is sent to at least one client and stock price information of items registered in the stock transaction reservation information is provided to the client when the client supporting type is investment consultancy.

98. The method of supporting stock exchange of claim 97, wherein the step (b1) includes:
a step of (b11) executing individual item buy transaction wherein in the step (b11), buy transaction order of items registered in the stock transaction reservation information is sent to the mainframe computer of the stock market with the present stock price and reserved buy volumes, and the stock transaction reservation information is updated in response to the execution results of the buy transaction order; and
a step of (b12) executing individual item sell transaction wherein in the step (b12), sell transaction order of items registered in the stock transaction reservation information is sent to the mainframe computer of the stock market with the present stock price and reserved sell volumes, and the stock transaction reservation information is updated in response to the execution results of the sell transaction order.

99. The method of supporting stock exchange of claim 97, wherein the step (b1) includes:
a step of (b13) executing basket items buy transaction wherein the step (b13) sending basket items buy transaction order of items which registered in each group with the present stock price by each item and reserved buy volumes to the mainframe computer of the stock market, and updating the stock transaction reservation information in response to execution results of the basket items buy transaction execution order; and
a step of (b14) executing basket items sell transaction wherein the step (b14) sending basket items sell transaction order of items registered in each group with the present stock price by each item and reserved sell volumes to the mainframe computer of the stock market, and updating the stock transaction reservation information in response to execution results of the basket items sell transaction execution order.

100. The method of supporting stock exchange of claim 98, wherein the step (b1) further includes:
a step of (b15) executing a sell transaction, wherein the step (b15) executing sell transaction of items that have been bought through the step (b11) or (b13) with reserved sell bidding price of next count transaction which is registered in the stock transaction reservation information after the step (b11) or (b13) is performed; and
a step of (b16) executing a buy transaction, wherein the step (b16) executing buy transaction of items that have been sold through the step of (b12) or (b14) with reserved buy bidding price of next count transaction which is registered in the stock transaction reservation information after the step (b12) or (b14) is performed.

101. The method of supporting stock exchange of claim 97, wherein the step (b) includes:
a step of (b3) sending radio paging information to at least one client on communication network at predetermined paging time by retrieving the client paging information in case the client supporting type is investment consultancy.

102. The method of supporting stock exchange of claim 101, wherein the step (b3) includes:
a step of (b31) connecting a web page which is provided by the mobile communication service provider;
a step of (b32) initializing input boxes installed in the web page and standing by for the client paging information;
a step of (b33) automatically writing the client paging information into the web page and performing paging operation; and
a step of (b34) confirming completion of paging operation, initializing the input boxes installed in the web page and sending confirmation signal of paging completion.

103. The method of supporting stock exchange of claim 102, wherein the step (b33) includes:
a step of (b331) inputting client pager number in an input box for receiving the client pager number by placing a cursor;
a step of (b332) inputting telephone number to be reached into an input box for receiving the telephone number;
a step of (b333) determining paging mode between numeric/character mode and voice mode by placing a cursor in a message box for receiving message;
a step of (b334) marking paging mode selection box with numeric/character mode, inputting message (code number of item, title of item, present stock price, buy or sell recommendation, buy bidding price or sell bidding price, reserved volumes or holding volumes) with numeric or character into the message box, and performing paging operation with inputted messages; , and repeating the steps from b331 to b334 in case all messages can not be inputted into the message box;
a step of (b335) marking paging mode selection box with voice, inputting message (code of item, title of item, present stock price, buy or sell recommendation, buy bidding price or sell bidding price, reserved volumes or holding volumes) with voice into the message box, and performing paging operation with inputted messages.

104. The method of supporting stock exchange of claim 101, wherein price information received from the mainframe computer of the stock market is sent to the client with the client paging information during the step (b3).

105. The method of supporting stock exchange of claim 103, wherein the client paging information can be classified into several groups and the messages can be sent to each group at intervals during the step (b3).

106. The method of supporting stock exchange of claim 94, wherein the step (c) includes:
a step of (c1) registering a discretionary investment reservation information wherein the step (c1) provides at least one web page which includes input boxes for receiving client identification information, password, client's registered number, code or title of item to be transacted, and volumes and value amount to be transacted, and supports registration of stock transaction reservation information, reservation of transaction execution, and updating the stock transaction reservation information in response to the execution results of stock transaction.

107. The method of supporting stock exchange of claim 106, wherein the web page provided by the step (c1) includes:
a plurality of launch buttons each of which is linked with a web page having corresponding information related to the each of launch buttons, wherein the launch buttons include register individual investment, register group investment, register investment fund, retrieve individual investment, retrieve group investment, retrieve investment fund, display list of clients by a group, display list of all clients, print list of items invested by an individual, print list of items invested by a group.

108. The method of supporting stock exchange of claim 107, wherein the step (c1) includes:
a step of (c11) supporting register of individual investment, in such case that the launch button of register individual investment is selected, the step (c11) provides a web page having a plurality of input boxes for receiving code and title of item, maximum reserved buy bidding price at 1−nₜₕ count of buy transaction, minimum reserved buy bidding price at 1−nₜₕ count of buy transaction, reserved buy volumes, maximum reserved sell price at 1−nₜₕcount of sell transaction, minimum reserved sell price at 1−nₜₕ count of sell transaction, and reserved sell volumes and display boxes for displaying buy value amount, sell value amount, present cash, balance.

109. The method of supporting stock exchange of claim 108, wherein the web page provided by the step (c11) further includes:
a launch button of graphic information linked with a web page containing graphic information of overhanging supply or daily/monthly stock price changes;
an input box for receiving a reference date to set period from past to present; and
display boxes for displaying highest price, lowest price, and present stock price during the period.

110. The method of supporting stock exchange of claim 107, wherein the step (c1) includes:
a step of (c12) supporting register group investment, in such case that when the launch button of register group investment is selected, the step (c12) provides a web page having a plurality of input boxes for receiving group name, ESN (electronic serial number) of pager, code and title of item, maximum reserved buy bidding price at 1−nₜₕ count of buy transaction, minimum reserved buy bidding price at 1−nₜₕ count of buy transaction, reserved buy volumes, maximum reserved sell price at 1−nₜₕ count of sell transaction, minimum reservation sell price at 1−nth count of sell transaction, and reserved sell volumes and display boxes for displaying sum of buy value amount, sum sell value amount, present cash, balance.

111. The method of supporting stock exchange of claim 110, wherein the web page provided by step (c12) further includes a plurality of display boxes for displaying sum of reserved buy volumes at first count of buy transaction, sum of reserved sell volumes at first count of sell transaction, sum of investment amount of which clients reserved to buy items at the first count of buy transaction, and present cash amount.

112. The method of supporting stock exchange of claim 107, wherein the step (c1) includes:
a step of (c13) supporting retrieve individual investment, in such case that the launch button of retrieve individual investment is selected, the step (c13) provides a web page having a plurality of input boxes for receiving client's registered number or name, and display boxes for displaying client's name or registered number, pager number, code and title of item on which transaction reservation is made by client and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell price at 1−nₜₕ count of sell transaction, minimum reserved sell price at 1−nₜₕ count of sell transaction, and reserved sell volumes, and execution results of 1−nₜₕ count of sell transaction.

113. The method of supporting stock exchange of claim 107, wherein the step (c1) includes:
a step of (c14) supporting retrieve group investment, wherein when the launch button of retrieve group investment is selected, the step (c14) provides a web page having an input box for receiving group name and a plurality of display boxes for displaying ESN of pager, code and title of item on which transaction reservation is made and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell price at 1−nₜₕ count of sell transaction, minimum reserved sell price at 1−nₜₕ count of sell transaction, and reserved sell volumes, and execution results of 1−nₜₕ count of sell transaction.

114. The method of supporting stock exchange of claim 107, wherein the step (c) includes:
a step of (c2) registering investment fund information;
a step of (c3) registering investment consultancy information;
a step of (c4) registering recommended items management information; and
a step of (c5) registering basket items buy/sell reservation information,
wherein the step (c2) provides a web page and manages discretionary investment information in response to information inputted through the web page including a plurality of input boxes, a plurality of display boxes, and a plurality of launch buttons,
wherein the input boxes are installed for receiving fund name, items to be transacted through the fund, count of transaction, and reference date to set a period of transaction, the plurality of display boxes is installed for displaying highest price during the period, lowest price during the period, present stock price, and the plurality of launch buttons includes graphic information and yield estimation,
wherein the launch button of graphic information is linked with a web page showing graphic information of daily/monthly stock price changes and overhanging supply during the period and the launch button of yield estimation is linked with a web page showing yield information during the period,
wherein the step (c3) provides a web page having stock price information such as buy or sell recommendation, buy bidding price or sell price and buy volumes and sell volumes and registers the stock price information shown on the web page as the investment consultancy information;
wherein the step (c4) provides a web page including a plurality of item buttons, each of which is linked with a web page contains corresponding information relating to each item to guide the clients with items which are worth investing,
wherein the step (c5) registers and manages items to be basket transacted by receiving codes or titles of the items, volumes and value amount.

115. The method of supporting stock exchange of claim 114, wherein the step (c2) includes:
a step of (c21) providing yield information such as percentage of return on investment amount when the launch button of yield estimation is selected; and
a step of (c22) providing detailed investment and transaction information such as investment amount of each item, yield of each item, stock holding status, balance when the title or code of the item is inputted into the input box included the web page linked with the launch button of yield estimation.

116. The method of supporting stock exchange of claim 114, wherein the step of (c4) registering recommended items management information provides a web page including a plurality of item buttons, each of which is linked with a web page containing corresponding information related to the each item, wherein the item buttons includes list of items highly undervalued, list of items ranked high in PER, list of items having high retained earnings, list of items ranked high in average value of numerical order number in each item of undervalued/PER/retained earnings, list of items recorded consecutive permissible high price, list of items having high advanced rate in short term, list of items recorded price at low during a predetermined period, list of items recorded low advanced rate, list of items having high gain over equity, list of items recorded price at new high, and list of items recorded high advanced rate between lowest price and highest price during a period.

117. The method of supporting stock exchange of claim 116, wherein the step of (c4) registering recommended items management information provides a web page displaying list of items highly undervalued by estimating PBR (price book value ratio) which means ratio of stock price over book value when the item button of list of items highly undervalued is selected.

118. The method of supporting stock exchange of claim 116, wherein the step of (c4) registering recommended items management information provides a web page displaying list of items ranked high in PER (price earnings ratio) by estimating percentage of average EPS (earning per share) for recent several years over present stock price when the item button of list of items ranked high in PER is selected.

119. The method of supporting stock exchange of claim 116, wherein the step of (c4) registering recommended items management information provides a web page displaying list of items ranked high in percentage of retained earnings over total equity (present stock price×capital/par value) when the item button of retained earnings is selected.

120. The method of supporting stock exchange of claim 117, wherein the step of (c4) registering recommended items management information provides a web page displaying list of items ranked high in average value of numerical order number in each items of highly undervalued, high PER and high retained earnings when the item button undervalued/PER/retained earnings is selected

121. The method of supporting stock exchange of claim 117, wherein the step of (c4) registering recommended items management information provides a web page displaying list of items recorded the consecutive daily permissible high price more than two times when the item button of list of items recorded consecutive permissible high price is selected.

122. The method of supporting stock exchange of claim 117, wherein the step of (c4) registering recommended items management information provides a web page displaying list of items recorded high advanced rate from the moving mean price line for predetermined time period when the item button of list of items having high advanced rate in short term is selected.

123. The method of supporting stock exchange of claim 116, wherein the step of (c4) registering recommended items management information retrieves items recorded price at low for the predetermined time period, provides buy information (buy point) in which the buy point is a price level advanced at a certain rate from the price at low, and then provides sell information (sell point) in which the sell point is price level advanced at a certain rate from the buy point when the item button of list of items recorded price at low is selected.

124. The method of supporting stock exchange of claim 116, wherein the step of (c4) registering recommended items management information provides a web page displaying list of items recorded lowest advanced rate from price at low for predetermined period which is set by the client by inputting a reference date (year, month, date) when the item button of list of items recorded low advanced rate is selected.

125. The method of supporting stock exchange of claim 116, wherein the step of (c4) registering recommended items management information provides a web page displaying list of items ranked high in percentage of net profit value per item over equity when the item button of list of items having high gain over equity is selected.

126. The method of supporting stock exchange of claim 116, wherein the step of (c4) registering recommended items management information provides a web page displaying list of items recorded price at new high during a period from a reference date to the present when the item button of list of items recorded price at new high is selected and the reference date (year, month, and day) is inputted by the client.

127. The method of supporting stock exchange of claim 116, wherein the step of (c4) registering recommended items management information provides a web page displaying list of items ranked high in advanced rate of item price from the lowest price level when the item button list of items recorded high advanced rate from lowest price level to highest price level is selected.

128. The method of supporting stock exchange of claim 114, wherein the step of (c5) registering basket items buy/sell reservation information provides a web page including a plurality of item buttons, each of which is linked with a corresponding web page to display corresponding information related to the each item, wherein the item buttons includes “buy or sell basket items listed in stock exchange”, “buy or sell basket items registered in KOSDAQ (Korea Securities Dealers Automated Quotations)”, “buy or sell basket items listed in stock exchange or registered in KOSDAQ”, “buy or sell basket of appointed items”, “buy or sell basket items classified by grades”, “past basket items buy or sell transaction data of appointed items”, “execution results of past basket items buy or sell transaction data of appointed items”, and “execution results of all buy or sell transactions”.

129. The method of supporting stock exchange of claim 128, wherein the step of (c5) registering basket items buy/sell reservation information includes:
a step of (c511) providing a web page including a plurality of input boxes for receiving appointed items to be basket transacted, buy value amount, client's registered number, client's name, and password; and
a step of (c512) estimating reserved buy value amount per each item by equally dividing the buy value amount by number of the appointed items, further estimating reserved buy volumes per each item by dividing the buy value amount per each item by price per share of the each item and registering the reserved buy value amount per each item and the reserved buy volumes as reservation information when one of the item buttons of “buy basket items listed in stock exchange,” “buy basket items registered in KOSDAQ,” “buy basket items listed in stock exchange or registered in KOSDAQ” is selected.

130. The method of supporting stock exchange of claim 128, wherein the step of (c5) registering basket items buy/sell reservation information includes:
a step of (c513) providing a web page including a plurality of input boxes for receiving appointed items to be basket transacted, sell value amount, client's registered number, client's name, and password when one of the item buttons of “sell basket items listed in stock exchange,” “sell basket items registered in KOSDAQ,” “sell basket items listed in stock exchange or registered in KOSDAQ” is selected; and
a step of (c514) registering reserved sell price of each item with the present stock price in case sum of present value amount of appointed items is higher than sell value amount inputted into the input box provided in the web page.

131. The method of supporting stock exchange of claim 130, wherein the web page further includes input boxes for receiving count of past basket items transaction and stock holding status table showing transaction time (year, month, day, time) of the past basket items transaction at the count which is inputted into the input box for receiving count of past basket items transaction, list of items transacted at the count of past basket items transaction, transacted price of each item, transacted volumes of each item, transacted value amount, present value amount.

132. The method of supporting stock exchange of claim 128, wherein the step of (c5) registering basket items buy/sell reservation information includes a step of (c515) providing a web page including a plurality of input boxes for receiving count of buy transaction, buy value amount, client's registered number, client's name, and password after the item buttons of “buy basket of appointed items” is selected, and a step of (c516) estimating reserved buy value amount per each item by equally dividing the buy value amount by number of the appointed items, and further estimating reserved buy volumes per each item by dividing the buy value amount per each item by present stock price per share of the each item and registering the reserved buy value amount per each item and the reserved buy volumes as reservation information.

133. The method of supporting stock exchange of claim 128, wherein the step of (c5) registering basket items buy/sell reservation information includes:
a step of (c517) providing a web page including a plurality of input boxes for receiving count of sell transaction, sell value amount, client's registered number, client's name, and password after the item buttons of “sell basket of appointed items” is selected; and
a step of (c518) setting the present value amount of the appointed items as sell value amount of each item or making a list of items to be sell basket transacted when sell value amount is inputted into the input boxes of the web page and sum of present value amount of appointed items is higher than the sell value amount.

134. The method of supporting stock exchange of claim 128, wherein the step of (c5) registering basket items buy/sell reservation information includes:
a step of (c519) providing a web page including input boxes for receiving investment amount and grade on each item, a launch button for selecting market type (stock exchange/KOSDAQ/stock exchange or KOSDAQ), and a launch button for selecting buy or sell when the item button “buy/sell basket items classified by grades” is selected;, and
a step of (c520) dividing investment amount in response to a grade inputted into the input box and registering the divided investment amount of each item as reservation information for buy or sell basket items classified by grades after the investment amount and grade on each items are inputted into the input boxes.

135. The method of supporting stock exchange of claim 128, wherein the step of (c5) registering basket items buy/sell reservation information includes:
a step of (c521) providing a web page including input boxes for receiving client's registered number, client's name, password, count of past basket items buy transaction when the item button “past basket items buy transaction data” is selected; and
a step of (c522) providing a past basket items buy transaction data table including code, title of item, holding status of the each item, volumes, buy bidding price per item, present stock price per item, yield, buy value amount of each item, present value amount of each item, profit or loss value amount of each item, average yield, sum of buy value amount of items listed in the past basket items buy transaction data table, sum of profit/loss value amount of the items, and sum of present value amount of items.

136. The method of supporting stock exchange of claim 135, wherein the web page further includes input boxes for receiving sum of total buy value amount (investment amount), yield average or sum of profit/loss value amount each of which is used as a reference value to generate a condition for executing basket items buy transaction, wherein the step of (c5) registering basket items buy/sell reservation information further includes a step of (C523) selectively registering a condition for executing basket buy transaction in response to the total buy value amount, the yield average and the sum of profit/loss value amount each of which is inputted into the input boxes.

137. The method of supporting stock exchange of claim 136, wherein the step of (523) registering a condition for executing basket items buy transaction sets a status which the sum of present value amount in the past basket items buy transaction data table is lower than the total value amount inputted into the input box of the web page to the condition for executing basket items buy transaction.

138. The method of supporting stock exchange of claim 136, wherein the step of (523) registering a condition for executing basket items buy transaction sets a status which the yield average in the past basket items buy transaction data table, the yield average being estimated based on present stock prices, is about the same as the yield average inputted into the input box of the web page to the condition for executing basket items buy transaction.

139. The method of supporting stock exchange of claim 136, wherein the step of (523) registering a condition for executing basket items buy transaction sets a status which the sum of profit/loss value amount in the past basket items buy transaction data table, the sum of profit/loss value amount being estimated based on present stock prices, is about the same as the sum of profit/loss value amount inputted into the input box of the web page to the condition for executing basket items buy transaction.

140. The method of supporting stock exchange of claim 128, wherein the step of (c5) registering basket items buy/sell reservation information includes:
a step of (c525) providing a web page including input boxes for receiving client's registered number, client's name, password, count of past basket items sell transaction when the item button “past basket items sell transaction data” is selected; and
a step of (c526) providing a past basket items sell transaction data table including codes and titles of items, holding status of each item, volumes of each item, sell price per share of each item, present stock price per share of each item, yield over the present stock price, sell value amount of each item, profit/loss value amount of each item over the present value amount, average yield, sum of sell value amount of the items listed in the past basket items sell transaction data table, sum of profit/loss value amount of the items, and sum of present value amount of the items.

141. The method of supporting stock exchange of claim 140, wherein the web page further provides a plurality of input boxes for receiving total buy value amount, yield average, and profit/loss value amount which is used as a reference values to generate a condition for executing basket items buy transaction of appointed items, the step of (c5) registering basket items buy/sell reservation information further includes a step of (C527) selectively registering a condition for executing basket items buy transaction in response to total buy value amount, yield average and profit/loss value amount each of which is inputted into the boxes.

142. The method of supporting stock exchange of claim 141, wherein the step of (527) selectively registering a condition for executing basket items buy transaction sets a status which sum of present value amount of items listed in the past basket items sell transaction data table is lower than the total buy value amount inputted into the input box of the web page to the condition for executing basket items buy transaction.

143. The method of supporting stock exchange of claim 141, wherein the step of (527) registering a condition for executing basket items buy transaction sets a status which the yield average in the past basket items buy transaction data table, the yield average being estimated based on present stock prices, is about the same as the yield average inputted into the input box of the web page to the condition for executing basket buy transaction.

144. The method of supporting stock exchange of claim 141, wherein the step of (527) registering a condition for executing basket items buy transaction sets a status which the sum of profit/loss value amount in the past basket items buy transaction data table, the sum of profit/loss value amount being estimated based on present stock prices, is about the same as the sum of profit/loss value amount inputted into the input box of the web page to the condition for executing basket items buy transaction.

145. A storage medium storing a stock exchange supporting program for implementing a method of supporting stock exchange using a data processing apparatus which is connected to a client terminal to receive client's ID information and stock transaction reservation information and a mainframe computer of stock market to receive real time stock transaction information through communication network respectively, comprising the steps of:
(a) checking a market condition by comparing the stock transaction reservation information registered in advance with the real time stock transaction information received from the mainframe computer of stock market and determining whether the market condition is adequate to execute stock transaction of an individual item or basket items in accordance with investment type and condition predetermined by the registered stock transaction reservation information;
(b) post-treating to send a transaction execution order to the mainframe computer of stock market to execute the stock transaction or to provide at least one client with present stock price information in response to the results of confirmation whether the client is registered discretionary investment or investment consultancy; and
(d) after the stock market being closed on that day when the stock transaction reservation is made, checking whether stock transaction is completely executed in accordance with the registered stock transaction reservation information, if not, re-registering remained part of the stock transaction reservation information which is remained being not transacted as new stock transaction reservation information on a next stock market opening day, whereby steps (b) and (d) are repeatedly performed till all stocks registered to be transacted in accordance with the stock transaction reservation information are completely transacted.

146. A storage medium in accordance with claim 145, wherein the method further comprises a step of (c) registering investment information, wherein the step (c) includes steps of receiving from the client terminal the stock transaction reservation information including investment type and condition, and registering the reservation information by separating it into individuals or groups, wherein the stock transaction reservation information includes client's ID information and paging information (terminal addressor pager number, paging time), at least one item to be transacted or consulted, reserved bidding price (buy bidding price range and sell bidding price range), transaction type (individual or basket), count of transactions by each item, and condition for individual item transaction or basket items transaction.

147. A storage medium in accordance with claim 145, wherein the step (a) includes sub-step of:
(a10-1) checking a stock market opening, retrieving the stock transaction reservation information to confirm whether the stock transaction reservation information is registered on that day and determining the transaction type (individual item buy or sell) from the stock transaction reservation information,
(a11) in case the transaction type is individual item buy, comparing present stock prices of items registered in the stock transaction reservation information with the range of reserved buy bidding prices, and setting a condition to execute individual item buy transaction when the range of reserved buy bidding price (from maximum buy bidding price to minimum buy bidding price) is the same as or higher than the present stock prices, and
(a12) in case the transaction type is individual item sell, comparing present stock prices of items registered in the stock transaction reservation information with the range of reserved sell bidding prices, and setting a condition to execute individual item sell transaction when the range of reserved sell bidding price range (from minimum sell price to maximum sell price) is the same with or lower than the present stock prices.

148. A storage medium in accordance with claim 145, wherein the step (a) includes a sub-step of:
(a10-2) checking a stock market opening, retrieving the stock transaction reservation information to confirm whether the stock transaction reservation information is registered on that day and determining the transaction type (basket items buy or sell) from stock transaction reservation information,
(a13) in case the transaction type is basket items buy, generating at least one market condition to execute the basket items buy transaction by checking present stock prices of items registered in the stock transaction reservation information, comparing the generated market condition with the investment condition which is registered in the stock transaction reservation information, and setting the generated market condition to the investment condition to execute basket items buy transaction when the generated market condition is belong to the registered investment condition, and
(a14) in case the transaction type is basket items sell, generating at least one market condition to execute the basket items sell transaction by checking present stock prices of items registered in the stock transaction reservation information, comparing the generated market condition with the investment condition which is registered in the stock transaction reservation information, and setting the generated market condition to the investment condition to execute basket items sell transaction when the generated market condition is belong to the registered investment condition.

149. A storage medium in accordance with claim 145, wherein the step (b) comprises:
a step of (b1) executing automatic transaction, wherein in the step (b1), the transaction execution order is automatically sent to the mainframe computer of stock market with investment condition as registered when the client supporting type is discretionary investment; and
a step of (b2) providing stock price information, in the step (b2), a client paging signal is sent to at least one client and stock price information of items registered in the stock transaction reservation information is provided to the client when the client supporting type is investment consultancy.

150. A storage medium in accordance with claim 149, wherein the step (b1) includes:
a step of (b11) executing individual item buy transaction wherein in the step (b111), buy transaction order of items registered in the stock transaction reservation information is sent to the mainframe computer of the stock market with the present stock price and reserved buy volumes, and the stock transaction reservation information is updated in response to the execution results of the buy transaction order; and
a step of (b12) executing individual item sell transaction wherein in the step (b12), sell transaction order of items registered in the stock transaction reservation information is sent to the mainframe computer of the stock market with the present stock price and reserved sell volumes, and the stock transaction reservation information is updated in response to the execution results of the sell transaction order.

151. A storage medium in accordance with claim 149, wherein the step (b1) includes:
a step of (b13) executing basket items buy transaction wherein the step (b13) sending basket items buy transaction order of items which registered in each group with the present stock price by each item and reserved buy volumes to the mainframe computer of the stock market, and updating the stock transaction reservation information in response to execution results of the basket items buy transaction execution order; and
a step of (b14) executing basket items sell transaction wherein the step (b14) sending basket items sell transaction order of items registered in each group with the present stock price by each item and reserved sell volumes to the mainframe computer of the stock market, and updating the stock transaction reservation information in response to execution results of the basket items sell transaction execution order.

152. A storage medium in accordance with claim 150, wherein the step (b1) further includes:
a step of (b15) executing a sell transaction, wherein the step (b15) executing sell transaction of items that have been bought through the step (b11) or (b13) with reserved sell bidding price of next count transaction which is registered in the stock transaction reservation information after the step (b11) or (b13) is performed; and
a step of (b16) executing a buy transaction, wherein the step (b16) executing buy transaction of items that have been sold through the step of (b12) or (b14) with reserved buy bidding price of next count transaction which is registered in the stock transaction reservation information after the step (b12) or (b14) is performed.

153. A storage medium in accordance with claim 149, wherein the step (b) includes:
a step of (b3) sending radio paging information to at least one client on communication network at predetermined paging time by retrieving the client paging information in case the client supporting type is investment consultancy.

154. A storage medium in accordance with claim 153, wherein the step (b3) includes:
a step of (b31) connecting a web page which is provided by the mobile communication service provider;
a step of (b32) initializing input boxes installed in the web page and standing by for the client paging information;
a step of (b33) automatically writing the client paging information into the web page and performing paging operation; and
a step of (b34) confirming completion of paging operation, initializing the input boxes installed in the web page and sending confirmation signal of paging completion.

155. A storage medium in accordance with claim 154, wherein the step (b33) includes:
a step of (b331) inputting client pager number in an input box for receiving the client pager number by placing a cursor;
a step of (b332) inputting telephone number to be reached into an input box for receiving the telephone number;
a step of (b333) determining paging mode between numeric/character mode and voice mode by placing a cursor in a message box for receiving message;
a step of (b334) marking paging mode selection box with numeric/character mode, inputting message (code number of item, title of item, present stock price, buy or sell recommendation, buy bidding price or sell bidding price, reserved volumes or holding volumes) with numeric or character into the message box, and performing paging operation with inputted messages; , and repeating the steps from b331 to b334 in case all messages can not be inputted into the message box;
a step of (b335) marking paging mode selection box with voice, inputting message (code of item, title of item, present stock price, buy or sell recommendation, buy bidding price or sell bidding price, reserved volumes or holding volumes) with voice into the message box, and performing paging operation with inputted messages.

156. A storage medium in accordance with claim 153, wherein price information received from the mainframe computer of the stock market is sent to the client with the client paging information during the step (b3).

157. A storage medium in accordance with claim 155, wherein the client paging information can be classified into several groups and the messages can be sent to each group at intervals during the step (b3).

158. A storage medium in accordance with claim 146, wherein the step (c) includes:
a step of (c1) registering a discretionary investment reservation information wherein the step (c1) provides at least one web page which includes input boxes for receiving client identification information, password, client's registered number, code or title of item to be transacted, and volumes and value amount to be transacted, and supports registration of stock transaction reservation information, reservation of transaction execution, and updating the stock transaction reservation information in response to the execution results of stock transaction.

159. A storage medium in accordance with claim 158, wherein the web page provided by the step (c1) includes:
a plurality of launch buttons each of which is linked with a web page having corresponding information related to the each of launch buttons, wherein the launch buttons include register individual investment, register group investment, register investment fund, retrieve individual investment, retrieve group investment, retrieve investment fund, display list of clients by a group, display list of all clients, print list of items invested by an individual, print list of items invested by a group.

160. A storage medium in accordance with claim 159, wherein the step (c1) includes:
a step of (c11) supporting register of individual investment, in such case that the launch button of register individual investment is selected, the step (c11) provides a web page having a plurality of input boxes for receiving code and title of item, maximum reserved buy bidding price at 1−nₜₕ count of buy transaction, minimum reserved buy bidding price at 1−nₜₕ count of buy transaction, reserved buy volumes, maximum reserved sell price at 1−nₜₕ count of sell transaction, minimum reserved sell price at 1−nₜₕ count of sell transaction, and reserved sell volumes and display boxes for displaying buy value amount, sell value amount, present cash, balance.

161. A storage medium in accordance with claim 160, wherein the web page provided by the step (c1) further includes:
a launch button of graphic information linked with a web page containing graphic information of overhanging supply or daily/monthly stock price changes;
an input box for receiving a reference date to set period from past to present; and
display boxes for displaying highest price, lowest price, and present stock price during the period.

162. A storage medium in accordance with claim 159, wherein the step (c1) includes:
a step of (c12) supporting register group investment, in such case that when the launch button of register group investment is selected, the step (c12) provides a web page having a plurality of input boxes for receiving group name, ESN (electronic serial number) of pager, code and title of item, maximum reserved buy bidding price at 1−nₜₕ count of buy transaction, minimum reserved buy bidding price at 1−nₜₕ count of buy transaction, reserved buy volumes, maximum reserved sell price at 1−nₜₕ count of sell transaction, minimum reservation sell price at 1−nth count of sell transaction, and reserved sell volumes and display boxes for displaying sum of buy value amount, sum sell value amount, present cash, balance.

163. A storage medium in accordance with claim 162, wherein the web page provided by step (c12) further includes a plurality of display boxes for displaying sum of reserved buy volumes at first count of buy transaction, sum of reserved sell volumes at first count of sell transaction, sum of investment amount of which clients reserved to buy items at the first count of buy transaction, and present cash amount.

164. A storage medium in accordance with claim 159, wherein the step (c1) includes:
a step of (c13) supporting retrieve individual investment, in such case that the launch button of retrieve individual investment is selected, the step (c13) provides a web page having a plurality of input boxes for receiving client's registered number or name, and display boxes for displaying client's name or registered number, pager number, code and title of item on which transaction reservation is made by client and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell price at 1−nₜₕ count of sell transaction, minimum reserved sell price at 1−nₜₕ count of sell transaction, and reserved sell volumes, and execution results of 1−nₜₕ count of sell transaction.

165. A storage medium in accordance with claim 159, wherein the step (c1) includes:
a step of (c14) supporting retrieve group investment, wherein when the launch button of retrieve group investment is selected, the step (c14) provides a web page having an input box for receiving group name and a plurality of display boxes for displaying ESN of pager, code and title of item on which transaction reservation is made and transacted, maximum reserved buy bidding price at 1−nₜₕ count of buy transaction, minimum reserved buy bidding price at 1−nₜₕ count of buy transaction, reserved buy volumes, execution results of the 1−nₜₕ count of buy transaction, maximum reserved sell price at 1−nₜₕ count of sell transaction, minimum reserved sell price at 1−nₜₕ count of sell transaction, and reserved sell volumes, and execution results of 1−nₜₕ count of sell transaction.

166. A storage medium in accordance with claim 159, wherein the step (c) includes:
a step of (c2) registering investment fund information;
a step of (c3) registering investment consultancy information;
a step of (c4) registering recommended items management information; and
a step of (c5) registering basket items buy/sell reservation information,
wherein the step (c2) provides a web page and manages discretionary investment information in response to information inputted through the web page including a plurality of input boxes, a plurality of display boxes, and a plurality of launch buttons,
wherein the input boxes are installed for receiving fund name, items to be transacted through the fund, count of transaction, and reference date to set a period of transaction, the plurality of display boxes is installed for displaying highest price during the period, lowest price during the period, present stock price, and the plurality of launch buttons includes graphic information and yield estimation,
wherein the launch button of graphic information is linked with a web page showing graphic information of daily/monthly stock price changes and overhanging supply during the period and the launch button of yield estimation is linked with a web page showing yield information during the period,
wherein the step (c3) provides a web page having stock price information such as buy or sell recommendation, buy bidding price or sell price and buy volumes and sell volumes and registers the stock price information shown on the web page as the investment consultancy information;
wherein the step (c4) provides a web page including a plurality of item buttons, each of which is linked with a web page contains corresponding information relating to each item to guide the clients with items which are worth investing,
wherein the step (c5) registers and manages items to be basket transacted by receiving codes or titles of the items, volumes and value amount.

167. A storage medium in accordance with claim 166, wherein the step (c2) includes:
a step of (c21) providing yield information such as percentage of return on investment amount when the launch button of yield estimation is selected; and
a step of (c22) providing detailed investment and transaction information such as investment amount of each item, yield of each item, stock holding status, balance when the title or code of the item is inputted into the input box included the web page linked with the launch button of yield estimation.

168. A storage medium in accordance with claim 166, wherein the step of (c4) registering recommended items management information provides a web page including a plurality of item buttons, each of which is linked with a web page containing corresponding information related to the each item, wherein the item buttons includes list of items highly undervalued, list of items ranked high in PER, list of items having high retained earnings, list of items ranked high in average value of numerical order number in each item of undervalued/PER/retained earnings, list of items recorded consecutive permissible high price, list of items having high advanced rate in short term, list of items recorded price at low during a predetermined period, list of items recorded low advanced rate, list of items having high gain over equity, list of items recorded price at new high, and list of items recorded high advanced rate between lowest price and highest price during a period.

169. A storage medium in accordance with claim 168, wherein the step of (c4) registering recommended items management information provides a web page displaying list of items highly undervalued by estimating PBR (price book value ratio) which means ratio of stock price over book value when the item button of list of items highly undervalued is selected.

170. A storage medium in accordance with claim 168, wherein the step of (c4) registering recommended items management information provides a web page displaying list of items ranked high in PER (price earnings ratio) by estimating percentage of average EPS (earning per share) for recent several years over present stock price when the item button of list of items ranked high in PER is selected.

171. A storage medium in accordance with claim 168, wherein the step of (c4) registering recommended items management information provides a web page displaying list of items ranked high in percentage of retained earnings over total equity (present stock price×capital/par value) when the item button of retained earnings is selected.

172. A storage medium in accordance with claim 168, wherein the step of (c4) registering recommended items management information provides a web page displaying list of items ranked high in average value of numerical order number in each items of highly undervalued, high PER and high retained earnings when the item button undervalued/PER/retained earnings is selected

173. A storage medium in accordance with claim 168, wherein the step of (c4) registering recommended items management information provides a web page displaying list of items recorded the consecutive daily permissible high price more than two times when the item button of list of items recorded consecutive permissible high price is selected.

174. A storage medium in accordance with claim 168, wherein the step of (c4) registering recommended items management information provides a web page displaying list of items recorded high advanced rate from the moving mean price line for predetermined time period when the item button of list of items having high advanced rate in short term is selected.

175. A storage medium in accordance with claim 168, wherein the step of (c4) registering recommended items management information retrieves items recorded price at low for the predetermined time period, provides buy information (buy point) in which the buy point is a price level advanced at a certain rate from the price at low, and then provides sell information (sell point) in which the sell point is price level advanced at a certain rate from the buy point when the item button of list of items recorded price at low is selected.

176. A storage medium in accordance with claim 168, wherein the step of (c4) registering recommended items management information provides a web page displaying list of items recorded lowest advanced rate from price at low for predetermined period which is set by the client by inputting a reference date (year, month, date) when the item button of list of items recorded low advanced rate is selected.

177. A storage medium in accordance with claim 168, wherein the step of (c4) registering recommended items management information provides a web page displaying list of items ranked high in percentage of net profit value per item over equity when the item button of list of items having high gain over equity is selected.

178. A storage medium in accordance with claim 168, wherein the step of (c4) registering recommended items management information provides a web page displaying list of items recorded price at new high during a period from a reference date to the present when the item button of list of items recorded price at new high is selected and the reference date (year, month, and day) is inputted by the client.

179. A storage medium in accordance with claim 168, wherein the step of (c4) registering recommended items management information provides a web page displaying list of items ranked high in advanced rate of item price from the lowest price level when the item button list of items recorded high advanced rate from lowest price level to highest price level is selected.

180. A storage medium in accordance with claim 166, wherein the step of (c5) registering basket items buy/sell reservation information provides a web page including a plurality of item buttons, each of which is linked with a corresponding web page to display corresponding information related to the each item, wherein the item buttons includes “buy or sell basket items listed in stock exchange”, “buy or sell basket items registered in KOSDAQ (Korea Securities Dealers Automated Quotations)”, “buy or sell basket items listed in stock exchange or registered in KOSDAQ”, “buy or sell basket of appointed items”, “buy or sell basket items classified by grades”, “past basket items buy or sell transaction data of appointed items”, “execution results of past basket items buy or sell transaction data of appointed items”, and “execution results of all buy or sell transactions”.

181. A storage medium in accordance with claim 180, wherein the step of (c5) registering basket items buy/sell reservation information includes:
a step of (c511) providing a web page including a plurality of input boxes for receiving appointed items to be basket transacted, buy value amount, client's registered number, client's name, and password; and
a step of (c512) estimating reserved buy value amount per each item by equally dividing the buy value amount by number of the appointed items, further estimating reserved buy volumes per each item by dividing the buy value amount per each item by price per share of the each item and registering the reserved buy value amount per each item and the reserved buy volumes as reservation information when one of the item buttons of “buy basket items listed in stock exchange,” “buy basket items registered in KOSDAQ,” “buy basket items listed in stock exchange or registered in KOSDAQ” is selected.

182. A storage medium in accordance with claim 180, wherein the step of (c5) registering basket items buy/sell reservation information includes:
a step of (c513) providing a web page including a plurality of input boxes for receiving appointed items to be basket transacted, sell value amount, client's registered number, client's name, and password when one of the item buttons of “sell basket items listed in stock exchange,” “sell basket items registered in KOSDAQ,” “sell basket items listed in stock exchange or registered in KOSDAQ” is selected; and
a step of (c514) registering reserved sell price of each item with the present stock price in case sum of present value amount of appointed items is higher than sell value amount inputted into the input box provided in the web page.

183. A storage medium in accordance with claim 182, wherein the web page further includes input boxes for receiving count of past basket items transaction and stock holding status table showing transaction time (year, month, day, time) of the past basket items transaction at the count which is inputted into the input box for receiving count of past basket items transaction, list of items transacted at the count of past basket items transaction, transacted price of each item, transacted volumes of each item, transacted value amount, present value amount.

184. A storage medium in accordance with claim 180, wherein the step of (c5) registering basket items buy/sell reservation information includes a step of (c515) providing a web page including a plurality of input boxes for receiving count of buy transaction, buy value amount, client's registered number, client's name, and password after the item buttons of “buy basket of appointed items” is selected, and a step of (c516) estimating reserved buy value amount per each item by equally dividing the buy value amount by number of the appointed items, and further estimating reserved buy volumes per each item by dividing the buy value amount per each item by present stock price per share of the each item and registering the reserved buy value amount per each item and the reserved buy volumes as reservation information.

185. A storage medium in accordance with claim 180, wherein the step of (c5) registering basket items buy/sell reservation information includes:
a step of (c517) providing a web page including a plurality of input boxes for receiving count of sell transaction, sell value amount, client's registered number, client's name, and password after the item buttons of “sell basket of appointed items” is selected; and
a step of (c518) setting the present value amount of the appointed items as sell value amount of each item or making a list of items to be sell basket transacted when sell value amount is inputted into the input boxes of the web page and sum of present value amount of appointed items is higher than the sell value amount.

186. A storage medium in accordance with claim 180, wherein the step of (c5) registering basket items buy/sell reservation information includes:
a step of (c519) providing a web page including input boxes for receiving investment amount and grade on each item, a launch button for selecting market type (stock exchange/KOSDAQ/stock exchange or KOSDAQ), and a launch button for selecting buy or sell when the item button “buy/sell basket items classified by grades” is selected;, and
a step of (c520) dividing investment amount in response to a grade inputted into the input box and registering the divided investment amount of each item as reservation information for buy or sell basket items classified by grades after the investment amount and grade on each items are inputted into the input boxes.

187. A storage medium in accordance with claim 180, wherein the step of (c5) registering basket items buy/sell reservation information includes:
a step of (c521) providing a web page including input boxes for receiving client's registered number, client's name, password, count of past basket items buy transaction when the item button “past basket items buy transaction data” is selected; and
a step of (c522) providing a past basket items buy transaction data table including code, title of item, holding status of the each item, volumes, buy bidding price per item, present stock price per item, yield, buy value amount of each item, present value amount of each item, profit or loss value amount of each item, average yield, sum of buy value amount of items listed in the past basket items buy transaction data table, sum of profit/loss value amount of the items, and sum of present value amount of items.

188. A storage medium in accordance with claim 187, wherein the web page further includes input boxes for receiving sum of total buy value amount (investment amount), yield average or sum of profit/loss value amount each of which is used as a reference value to generate a condition for executing basket items buy transaction, wherein the step of (c5) registering basket items buy/sell reservation information further includes a step of (C523) selectively registering a condition for executing basket buy transaction in response to the total buy value amount, the yield average and the sum of profit/loss value amount each of which is inputted into the input boxes.

189. A storage medium in accordance with claim 188, wherein the step of (523) registering a condition for executing basket items buy transaction sets a status which the sum of present value amount in the past basket items buy transaction data table is lower than the total value amount inputted into the input box of the web page to the condition for executing basket items buy transaction.

190. A storage medium in accordance with claim 188, wherein the step of (523) registering a condition for executing basket items buy transaction sets a status which the yield average in the past basket items buy transaction data table, the yield average being estimated based on present stock prices, is about the same as the yield average inputted into the input box of the web page to the condition for executing basket items buy transaction.

191. A storage medium in accordance with claim 188, wherein the step of (523) registering a condition for executing basket items buy transaction sets a status which the sum of profit/loss value amount in the past basket items buy transaction data table, the sum of profit/loss value amount being estimated based on present stock prices, is about the same as the sum of profit/loss value amount inputted into the input box of the web page to the condition for executing basket items buy transaction.

192. A storage medium in accordance with claim 180, wherein the step of (c5) registering basket items buy/sell reservation information includes:
a step of (c525) providing a web page including input boxes for receiving client's registered number, client's name, password, count of past basket items sell transaction when the item button “past basket items sell transaction data” is selected; and
a step of (c526) providing a past basket items sell transaction data table including codes and titles of items, holding status of each item, volumes of each item, sell price per share of each item, present stock price per share of each item, yield over the present stock price, sell value amount of each item, profit/loss value amount of each item over the present value amount, average yield, sum of sell value amount of the items listed in the past basket items sell transaction data table, sum of profit/loss value amount of the items, and sum of present value amount of the items.

193. A storage medium in accordance with claim 192, wherein the web page further provides a plurality of input boxes for receiving total buy value amount, yield average, and profit/loss value amount which is used as a reference values to generate a condition for executing basket items buy transaction of appointed items, the step of (c5) registering basket items buy/sell reservation information further includes a step of (C527) selectively registering a condition for executing basket items buy transaction in response to total buy value amount, yield average and profit/loss value amount each of which is inputted into the boxes.

194. A storage medium in accordance with claim 193, wherein the step of (527) selectively registering a condition for executing basket items buy transaction sets a status which sum of present value amount of items listed in the past basket items sell transaction data table is lower than the total buy value amount inputted into the input box of the web page to the condition for executing basket items buy transaction.

195. A storage medium in accordance with claim 193, wherein the step of (527) registering a condition for executing basket items buy transaction sets a status which the yield average in the past basket items buy transaction data table, the yield average being estimated based on present stock prices, is about the same as the yield average inputted into the input box of the web page to the condition for executing basket buy transaction.

196. A storage medium in accordance with claim 193, wherein the step of (527) registering a condition for executing basket items buy transaction sets a status which the sum of profit/loss value amount in the past basket items buy transaction data table, the sum of profit/loss value amount being estimated based on present stock prices, is about the same as the sum of profit/loss value amount inputted into the input box of the web page to the condition for executing basket items buy transaction.
